(19) United States
(12) Patent Application Publication
(10) Pub. No.: US 2023/0317940 A1
(43) Pub. Date: Oct. 5, 2023

(54) Secondary Battery, Vehicle, and Manufacturing Method Of Secondary Battery

(71) Applicant: Semiconductor Energy Laboratory Co., Ltd., Kanagawa-ken (JP)

(72) Inventors: Jo Saito, Atsugi, Kanagawa (JP); Yohei MOMMA, Isehara, Kanagawa (JP); Teruaki OCHIAI, Atsugi, Kanagawa (JP); Yusuke YOSHITANI, Isehara, Kanagawa (JP); Mayumi MIKAMI, Atsugi, Kanagawa (JP)

(73) Assignee: Semiconductor Energy Laboratory Co., Ltd., Kanagawa-ken (JP)

(21) Appl. No.: 18/019,563

(22) PCT Filed: Jul. 26, 2021
(86) PCT No.: PCT/IB2021/056700

§ 371 Date: Feb. 3, 2023

(30) Foreign Application Priority Data
Aug. 7, 2020 (JP) 2020-134791
Aug. 7, 2020 (JP) 2020-135213
Nov. 27, 2020 (JP) 2020-196872
Jun. 4, 2021 (JP) 2021-094298

(51) Int. Cl. H01M 4/525; H01M 10/0525; H01M 4/04; H01M 10/0587

(52) U.S. Cl. CPC H01M 4/525; H01M 10/0525; H01M 4/0471; H01M 4/0416; H01M 10/0587; H01M 2220/20; H01M 2004/028

(57) ABSTRACT

A secondary battery and a positive electrode active material each having high energy density per weight and per volume are provided. The secondary battery includes a positive electrode, the positive electrode includes lithium cobalt oxide, and the lithium cobalt oxide has a projection containing at least one or two or more selected from Hf, V, Nb, Ce, and Sm. The projection may further contain Mg, F, Ni, or Al as an additive element. The secondary battery is manufactured through a step of forming a mixed solution by mixing the lithium cobalt oxide and a metal alkoxide containing one or two or more selected from Hf, V, Nb, Ce, and Sm. With such a positive electrode active material, a secondary battery with a high charge voltage can be provided.

### TECHNICAL FIELD

The present invention relates to a secondary battery, a vehicle including a secondary battery, a method for manufacturing a secondary battery, and the like.

### BACKGROUND ART

Secondary batteries have been actively researched and developed because they can have high capacity and can be downsized. Among secondary batteries, a secondary battery in which carrier ions are lithium ions is referred to as a lithium-ion secondary battery. Improvement of the performance of a positive electrode active material is essential for increasing energy density per weight and per volume of a lithium-ion secondary battery.

As a material used for a positive electrode active material, lithium cobalt oxide is known. With the aim of improving the performance of a secondary battery, addition of an element other than a main component to lithium cobalt oxide has been researched and developed. Patent Document 1 discloses a positive electrode active material obtained by adding magnesium and fluorine to lithium cobalt oxide as elements other than a main component, and a manufacturing method thereof.

Improvement of a positive electrode active material has been studied to increase the cycle performance and the capacity of a lithium-ion secondary battery (e.g., Patent Document 2 and Non-Patent Document 1).

### REFERENCES

### Patent Documents

[Patent Document 1] Japanese Published Patent Application No. 2018-195581
[Patent Document 2] Japanese Published Patent Application No. 2015-163356

### Non-Patent Document

[Non-Patent Document 1] Suppression of Cobalt Dissolution from the LiCoO₂ Cathodes with Various Metal-Oxide Coatings, Yong Jeong Kim et., al., Journal of The Electrochemical Society, 150(12) A1723-A1725 (2003)

### SUMMARY OF THE INVENTION

### Problems to be Solved by the Invention

In Patent Document 1, the crystal structure of a positive electrode active material is evaluated with use of an XRD pattern. However, Patent Document 1 describes that an objective crystal structure was not observed from the XRD pattern of a positive electrode active material charged at 4.7 V or higher, and the upper limit of charge voltage in a cycle test is 4.6 V.

In consideration of Patent Document 1 described above, an object of the present invention is to provide a positive electrode active material that can withstand a high charge voltage or a secondary battery including the positive electrode active material. Moreover, an object of the present invention is to provide a vehicle including a secondary battery.

Note that the description of the above objects does not preclude the existence of other objects. For example, an object relating to safety may exist. In one embodiment of the present invention, there is no need to achieve all the objects. Other objects can be derived from the description of the specification, the drawings, and the claims of the present invention.

### Means for Solving the Problems

One embodiment of the present invention is a secondary battery including a positive electrode; the positive electrode includes lithium cobalt oxide; and the lithium cobalt oxide has a projection containing at least one or two or more selected from Hf, V, Nb, Zr, Ce, and Sm.

One embodiment of the present invention is a secondary battery including a positive electrode; the positive electrode includes lithium cobalt oxide; the lithium cobalt oxide has a projection containing at least one or two or more selected from Hf, V, Nb, Zr, Ce, and Sm; and the projection further contains Mg.

One embodiment of the present invention is a secondary battery including a positive electrode; the positive electrode includes lithium cobalt oxide; the lithium cobalt oxide has a projection containing at least one or two or more selected from Hf, V, Nb, Zr, Ce, and Sm; and the projection further contains Mg and F.

One embodiment of the present invention is a secondary battery including a positive electrode; the positive electrode includes lithium cobalt oxide; the lithium cobalt oxide has a projection containing at least one or two or more selected from Hf, V, Nb, Zr, Ce, and Sm; and the projection further contains Mg, F, and Ni.

One embodiment of the present invention is a secondary battery including a positive electrode; the positive electrode includes lithium cobalt oxide; the lithium cobalt oxide has a projection containing at least one or two or more selected from Hf, V, Nb, Zr, Ce, and Sm; the projection further contains Mg and F; and Al exists at an interface between the projection and an inner portion of the lithium cobalt oxide.

In any one of the embodiments of the present invention, the one or two or more selected from Hf, V, Nb, Zr, Ce, and Sm are preferably unevenly distributed in the projection.

A vehicle preferably includes the secondary battery of one embodiment of the present invention.

One embodiment of the present invention is a method for manufacturing a secondary battery, including a step of forming a mixed solution by mixing lithium cobalt oxide and a metal alkoxide containing one or two or more selected from Hf, V, Nb, Zr, Ce, and Sm; a step of forming a mixture by stirring the mixed solution; and a heating step of heating the mixture.

One embodiment of the present invention is a method for manufacturing a secondary battery, including; a step of forming a first mixture by mixing lithium cobalt oxide and a magnesium source; a first heating step of heating the first mixture; a step of forming a mixed solution by mixing the heated first mixture and a metal alkoxide containing one or two or more selected from Hf, V, Nb, Zr, Ce, and Sm; a step of forming a second mixture by stirring the mixed solution; and a second heating step of heating the second mixture.

One embodiment of the present invention is a method for manufacturing a secondary battery, including; a step of forming a first mixture by mixing lithium cobalt oxide, a magnesium source, and a fluorine source; a first heating step of heating the first mixture; a step of forming a mixed solution by mixing the heated first mixture and a metal alkoxide containing one or two or more selected from Hf, V, Nb, Zr, Ce, and Sm; a step of forming a second mixture by stirring the mixed solution; and a second heating step of heating the second mixture.

In any one of the embodiments of the present invention, the second heating step is preferably performed in a shorter time than the first heating step.

In any one of the embodiments of the present invention, the second heating step is preferably performed at a lower temperature than the first heating step.

### Effect of the Invention

According to one embodiment of the present invention, a positive electrode active material having high energy density per weight and per volume or a secondary battery including the positive electrode active material can be provided. According to one embodiment of the present invention, a vehicle including a secondary battery can be provided.

### BRIEF DESCRIPTION OF THE DRAWINGS

FIG. 1A and FIG. 1B are diagrams showing cross sections of positive electrode active materials.

FIG. 2A and FIG. 2B are diagrams showing cross sections of positive electrode active materials.

FIG. 3 is a diagram illustrating crystal structures of a positive electrode active material.

FIG. 4 is a diagram showing XRD patterns calculated from crystal structures.

FIG. 5 is a diagram illustrating crystal structures of a positive electrode active material that is a comparative example.

FIG. 6 is a diagram showing XRD patterns calculated from crystal structures.

FIG. 7A to FIG. 7C are diagrams showing cross sections of positive electrodes.

FIG. 8A and FIG. 8B are diagrams showing external appearances of a laminated secondary battery.

FIG. 9A to FIG. 9C are diagrams showing a manufacturing process of a laminated secondary battery.

FIG. 10A and FIG. 10B are diagrams showing a manufacturing process of a positive electrode.

FIG. 11A and FIG. 11B are diagrams showing an external appearance and a cross section of a coin-type secondary battery.

FIG. 12A to FIG. 12D are diagrams showing an external appearance, a cross section, and the like of a secondary battery.

FIG. 13A to FIG. 13C are diagrams showing an external appearance, a cross section, and the like of a secondary battery.

FIG. 14A to FIG. 14C are diagrams showing an external appearance, a cross section, and the like of a secondary battery.

FIG. 15A to FIG. 15C are diagrams showing an external appearance, a system, and the like of a secondary battery.

FIG. 16A to FIG. 16D are diagrams showing vehicles and the like including secondary batteries.

FIG. 17A and FIG. 17B are diagrams showing a house provided with a secondary battery, and the like.

FIG. 18A to FIG. 18D are diagrams showing electronic devices and the like including secondary batteries.

FIG. 19A and FIG. 19B are SEM images of Sample 1.

FIG. 20A and FIG. 20B are SEM images of Sample 2.

FIG. 21A and FIG. 21B are SEM images of Sample 3.

FIG. 22A and FIG. 22B1 to FIG. 22B6 show EDX plane analysis results of Sample 3.

FIG. 23 shows EDX line analysis results of Sample 3.

FIG. 24A to FIG. 24C show EDX point analysis results of Sample 3.

FIG. 25A and FIG. 25B are graphs showing cycle performance of half cells including Sample 1 to Sample 3.

FIG. 26A and FIG. 26B are graphs showing cycle performance of the half cells including Sample 1 to Sample 3.

FIG. 27A and FIG. 27B are graphs showing cycle performance of the half cells including Sample 1 to Sample 3.

FIG. 28A and FIG. 28B are graphs showing cycle performance of the half cells including Sample 1 to Sample 3.

FIG. 29A and FIG. 29B are graphs showing cycle performance of half cells including Sample 4a to Sample 4c.

FIG. 30A and FIG. 30B are graphs showing cycle performance of the half cells including Sample 4a to Sample 4c.

FIG. 31A and FIG. 31B are graphs showing cycle performance of the half cells including Sample 4a to Sample 4c.

FIG. 32A and FIG. 32B are graphs showing cycle performance of the half cells including Sample 4a to Sample 4c.

FIG. 33A and FIG. 33B are SEM images of Sample 5.

FIG. 34A and FIG. 34B are SEM images of Sample 6.

FIG. 35A, FIG. 35B1, FIG. 35B2, FIG. 35B3, and FIG. 35B4 are SEM images and the like of Sample 5.

FIG. 36A, FIG. 36B1, FIG. 36B2, and FIG. 36B3 are SEM images and the like of Sample 6.

FIG. 37A and FIG. 37B are graphs showing cycle performance of half cells including Sample 5 and Sample 6.

FIG. 38A and FIG. 38B are graphs showing cycle performance of the half cells including Sample 5 and Sample 6.

FIG. 39A and FIG. 39B show EDX plane analysis results of Sample 5.

FIG. 40A and FIG. 40B show EDX plane analysis results of Sample 6.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

### Embodiment 1

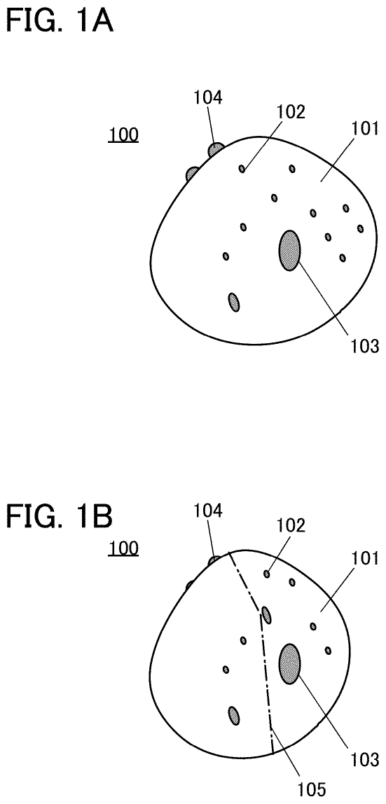

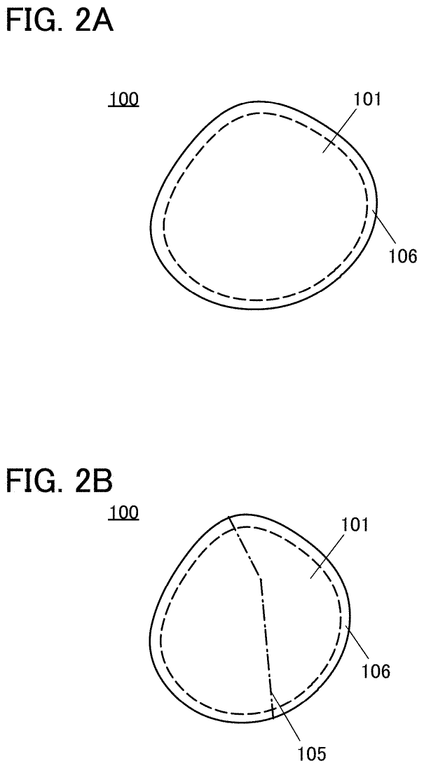

In this embodiment, a positive electrode active material of one embodiment of the present invention is described with reference to FIG. 1 and FIG. 2.

FIG. 1A illustrates a positive electrode active material 100. The positive electrode active material 100 is sometimes referred to as a positive electrode active material particle owing to its shape, but has a variety of shapes other than a particle form. The positive electrode active material 100 may be a primary particle including a plurality of crystallites or may be a secondary particle formed of aggregated primary particles.

The positive electrode active material 100 includes a first particle 101, and the particle diameter of the first particle 101 is greater than or equal to 1 μm and less than or equal to 50 μm, preferably greater than or equal to 5 μm and less than or equal to 20 μm.

The particle diameter of a particle can be measured by laser diffraction particle size distribution measurement, for example, and can be represented as D50. D50 is a particle diameter when the cumulative volume of a particle size distribution curve accounts for 50% in a measurement result of the particle size distribution, i.e., a median diameter. Measurement of the particle diameter of a particle is not limited to laser diffraction particle size distribution measurement. For example, when the particle diameter is less than or equal to the lower measurement limit of laser diffraction particle size distribution measurement, the cross-sectional diameter of a cross section of a particle may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

The particle diameter of the first particle 101 is preferably obtained by measuring the cross-sectional diameter, or may be a median diameter (D50).

Note that in the case of a ternary composite oxide such as a Ni—Mn—Co oxide, the particle diameter can be considered on the assumption that the first particle 101 is a secondary particle. The secondary particle is a particle that is formed of aggregated primary particles and is isolated from another secondary particle. That is, the secondary particle is an aggregate and particles forming the aggregate are referred to as primary particles.

FIG. 1A illustrates, as an example, the positive electrode active material 100 having projections on its surface. The projection can also be regarded as a particle that is fixed or attached to the surface of the first particle 101 and thus may be referred to as a second particle. A fixed state refers to a state where the projection is not detached from the surface of the first particle 101 even when ultrasonic dispersion is performed. The number, shape, and size of the projection are variable, and FIG. 1A illustrates a projection 102, a projection 103, and a projection 104. The projection is a region where an additive element is unevenly distributed.

Uneven distribution means that the concentration of a certain element is higher in one region than in another region. That is, in some cases, “an additive element is unevenly distributed” means a state where an additive element unevenly exists or does not uniformly exist, and means a state where one region has a higher concentration of the additive element than another region. Uneven distribution may be denoted by segregation or precipitation. As a result of precipitation of an element, a projection containing the element may be formed on the surface of the first particle 101, in which case the element may be unevenly distributed in the projection.

The projection 102 to the projection 104 are positioned on the surface of the first particle 101 and are sometimes observed as semicircular projections like the projection 104 in one cross section of the first particle 101. In one cross section, the length of the bottom of the projection is greater than or equal to 20 nm and less than or equal to 1 μm and the height of the projection is greater than or equal to 10 nm and less than or equal to 200 nm. In a STEM image, the first particle 101 and the projection 102 to the projection 104 can be distinguished on the basis of a difference in contrast. The STEM image is an image obtained with a scanning transmission electron microscope (STEM), and this image can be obtained by detecting electrons passing through an observation sample.

FIG. 1B is the positive electrode active material 100 in which a grain boundary 105 positioned between crystallites is illustrated. The structure in FIG. 1B is similar to that in FIG. 1A except that the grain boundary 105 is included. The grain boundary 105 is formed along with the crystal growth of the crystallite and thus is not linear in many cases, but may be linear. In the case where the positive electrode active material 100 is a secondary particle, the grain boundary 105 may be regarded as an interface between primary particles. The interface between primary particles is also not linear in many cases, but may be linear.

FIG. 2A corresponds to one cross section of FIG. 1A. A surface portion 106 of the positive electrode active material 100 can be observed in FIG. 2A. The surface portion 106 is positioned in the vicinity of the surface of the positive electrode active material 100. The surface portion 106 is a region that is 50 nm, preferably 35 nm, further preferably 20 nm, and most preferably 10 nm in depth from the surface toward the inner portion of the positive electrode active material 100 in one cross section.

FIG. 2B corresponds to one cross section of FIG. 1B. The surface portion 106 of the positive electrode active material 100 including the grain boundary 105 can be observed in FIG. 2B. The other structures are similar to those in FIG. 2A. The grain boundary 105 and/or the surface portion 106 are regions where an additive element is unevenly distributed.

Uneven distribution means that the concentration of a certain element is higher in one region than in another region. That is, in some cases, “an additive element is unevenly distributed” means a state where an additive element unevenly exists or does not uniformly exist, and means a state where one region has a higher concentration of the additive element than another region. Uneven distribution may be denoted by segregation or precipitation.

For the positive electrode active material 100, a material into and from which carrier ions can be inserted and extracted can be mainly used. As carrier ions, alkali metals (e.g., sodium or potassium) or alkaline earth metals (e.g., calcium, strontium, barium, beryllium, or magnesium) can be used.

Examples of the material into and from which lithium ions can be inserted and extracted include lithium composite oxides with an olivine crystal structure, a layered rock-salt crystal structure, and a spinel crystal structure. The lithium composite oxide with an olivine crystal structure is represented by LiAMPO₄ (here, M=any of Fe, Mn, Ni, and Co), for example. Owing to excellent thermal stability, Fe and Mn are expected as next-generation positive electrode materials. The lithium composite oxide with a layered rock-salt crystal structure is represented by LiMO₂ (here, M=any of Fe, Mn, Ni, and Co), for example. The state where M is Co is represented by LiCoO₂, and is sometimes denoted by LCO or lithium cobalt oxide. In the case where LiCoO₂, LCO, or lithium cobalt oxide is denoted, Mn is substantially not contained. “Mn is substantially not contained” means that the weight of manganese is less than or equal to 600 ppm, preferably less than or equal to 100 ppm in the case where lithium cobalt oxide is analyzed by glow discharge mass spectrometry (GD-MS), for example.

The lithium composite oxide with a layered rock-salt crystal structure may contain two or more of Fe, Mn, Ni, and Co. Examples of the lithium composite oxide containing Ni, Mn, and Co include a NiCoMn-based material (NCM, also referred to as lithium nickel-cobalt-manganese oxide) represented by LiNiₓCo_{y}Mn_{z}O₂(x>0, y>0, and 0.8<x+y+z<1.2). Specifically, 0.1x<y<8x and 0.1x<z<8x are preferably satisfied in the above. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

In addition, oxides such as V₂O₅ and Nb₂O₅ have been researched as materials of positive electrode active materials. Examples of the lithium composite oxide with a spinel crystal structure include a lithium-manganese spinel (LiMn₂O₄).

The lithium composite oxide may contain at least one or two or more elements selected from nickel, chromium, aluminum, iron, magnesium, molybdenum, zinc, zirconium, indium, gallium, copper, titanium, niobium, silicon, fluorine, phosphorus, and the like. The element is preferably an element other than a material of a positive electrode active material (a main component) and is denoted by an additive element (an additive element X).

The positive electrode active material of the present invention is a lithium composite oxide containing an additive element (an additive element Y) which is different from the additive element X described above. It is preferable that the additive element Y be a Group 4 element or a Group 5 element and contain Hf, V, or Nb or Hf and Zr. Moreover, it is preferable that the additive element Y be a lanthanoid element and contain Ce or Sm.

In the positive electrode active material, the additive element X and the additive element Y (collectively referred to as the additive elements) exist at concentrations lower than that of the above-described material of the positive electrode active material (the above-described main component). Therefore, they are sometimes referred to as impurity elements.

In the positive electrode active material, the additive element is preferably unevenly distributed not in the inner portion but in the vicinity of the surface. The vicinity of the surface includes the projection formed on the surface of the lithium composite oxide and the surface portion of the lithium composite oxide.

As already described above, uneven distribution means that the concentration of a certain element is higher in one region than in another region. That is, in some cases, “an additive element is unevenly distributed” means a state where an additive element unevenly exists or does not uniformly exist, and means a state where one region has a higher concentration of the additive element than another region. Uneven distribution may be denoted by segregation or precipitation. As a result of precipitation of an element, a projection containing the additive element may be formed on the surface of the first particle 101, in which case the additive element may be unevenly distributed in the projection.

The Nb concentration in the positive electrode active material obtained by EDX analysis is preferably greater than or equal to 1.0 atomic % (hereinafter, referred to as at %) and less than or equal to 6.0 at %, further preferably greater than or equal to 1.5 at % and less than or equal to 4.7 at %.

The Co concentration on the surface of the positive electrode active material obtained by EDX analysis is preferably greater than or equal to the lower detection limit and less than or equal to 4.0 at %, further preferably greater than or equal to the lower detection limit and less than or equal to 3.3 at %.

The Sm concentration in the vicinity of the surface of the positive electrode active material obtained by EDX analysis is preferably greater than or equal to the lower detection limit and less than or equal to 36.0 at %, further preferably greater than or equal to the lower detection limit and less than or equal to 35.1 at %.

Some additive elements do not contribute to capacity as the positive electrode active material. Such additive elements are considered preferable to be unevenly distributed in the vicinity of the surface of the positive electrode active material.

In addition, when the additive element exists at a higher concentration in the vicinity of the surface than in the inner portion of the positive electrode active material, the positive electrode active material is less likely to deteriorate even at a high charge voltage. The additive element is preferably unevenly distributed in the vicinity of the surface that is likely to be affected by a structural change due to insertion and extraction of carrier ions, in which case the positive electrode active material is less likely to deteriorate.

In each of the lithium composite oxides illustrated in FIG. 1A and FIG. 1B, the additive element exists at a higher concentration in the projection 102 to the projection 104 than in the inner portion. That is, each of the lithium composite oxides illustrated in FIG. 1A and FIG. 1B is a positive electrode active material having a projection on the surface and containing the additive element (Hf, V, or Nb or Hf and Zr) in the projection or a positive electrode active material containing the additive element (Ce or Sm) in the projection. A region where the additive element (Hf, V, or Nb or Hf and Zr) is unevenly distributed or a region where the additive element (Ce or Sm) is unevenly distributed may be a projection. Such a lithium composite oxide is less likely to deteriorate even at a high charge voltage, so that the charge voltage of a secondary battery can be increased.

The grain boundary 105 exists in FIG. 1B and the additive element (Hf, V, or Nb or Hf and Zr) or the additive element (Ce or Sm) may be unevenly distributed in the grain boundary 105. A region where the additive element (Hf, V, or Nb or Hf and Zr) is unevenly distributed or a region where the additive element (Ce or Sm) is unevenly distributed may be a grain boundary. Such a lithium composite oxide is less likely to deteriorate even at a high charge voltage, so that the charge voltage of the secondary battery can be increased.

It is considered that when a projection is further formed on the positive electrode active material, cobalt or the like that is eluted into an electrolyte solution is reduced. A reduction in the contact area with the electrolyte solution suppresses decomposition of the electrolyte solution, and reduction of the positive electrode active material is also suppressed. As a result, the positive electrode active material is less likely to deteriorate even at a high charge voltage, and the charge voltage of the secondary battery can be increased. For this reason, the positive electrode active material preferably has a plurality of projections.

FIG. 2A and FIG. 2B illustrate lithium composite oxides each having no projection. Even in the lithium composite oxide having no projection, the additive element is unevenly distributed in the surface portion 106 at a higher concentration than in the inner portion of the positive electrode active material 100. That is, each of the lithium composite oxides illustrated in FIG. 2A and FIG. 2B is a positive electrode active material containing the additive element (Hf, V, or Nb or Hf and Zr) or the additive element (Ce or Sm) in the surface portion 106. Such a lithium composite oxide is considered to be less likely to deteriorate even at a high charge voltage, so that the charge voltage of the secondary battery can be increased.

The grain boundary 105 exists in FIG. 2B and the additive element (Hf, V, or Nb or Hf and Zr) or the additive element (Ce or Sm) may be contained in the grain boundary 105. A region where the additive element (Hf, V, or Nb or Hf and Zr) is unevenly distributed or a region where the additive element (Ce or Sm) is unevenly distributed may be a grain boundary. Such a lithium composite oxide is considered to be less likely to deteriorate even at a high charge voltage, so that the charge voltage of the secondary battery can be increased.

In addition to the additive element Y, at least one or more of Mg and F may exist as the additive element X in the projection 102 to the projection 104 and/or the surface portion 106. Owing to one or more of Mg and F, the positive electrode active material is less likely to deteriorate even at a high charge voltage, and the charge voltage of the secondary battery can be increased.

In addition to the additive element Y, at least one or more of Ni and Al may exist as the additive element X in the projection 102 to the projection 104 and/or the surface portion 106. Owing to one or more of Ni and Al, the positive electrode active material is less likely to deteriorate even at a high charge voltage, and the charge voltage of the secondary battery can be increased.

In addition to the additive element Y, at least Zr may exist as the additive element X in the projection 102 to the projection 104 and/or the surface portion 106. Owing to Zr, the positive electrode active material is less likely to deteriorate even at a high charge voltage, and the charge voltage of the secondary battery can be increased.

In addition to the additive element Y, one or two or more selected from Mg, F, Al, and Ni may exist as the additive element X in the projection 102 to the projection 104 and/or the surface portion 106. Owing to one or two or more selected from Mg, F, Al, and Ni, the positive electrode active material is less likely to deteriorate even at a high charge voltage, and the charge voltage of the secondary battery can be increased.

In addition to the additive element Y, one or two or more selected from Mg, F, Al, Ni, and Zr contained in the lithium cobalt oxide may exist as the additive element X in the projection 102 to the projection 104 and/or the surface portion 106. Owing to one or two or more selected from Mg, F, Al, Ni, and Zr, the positive electrode active material is less likely to deteriorate even at a high charge voltage, and the charge voltage of the secondary battery can be increased.

### <Crystal Structure>

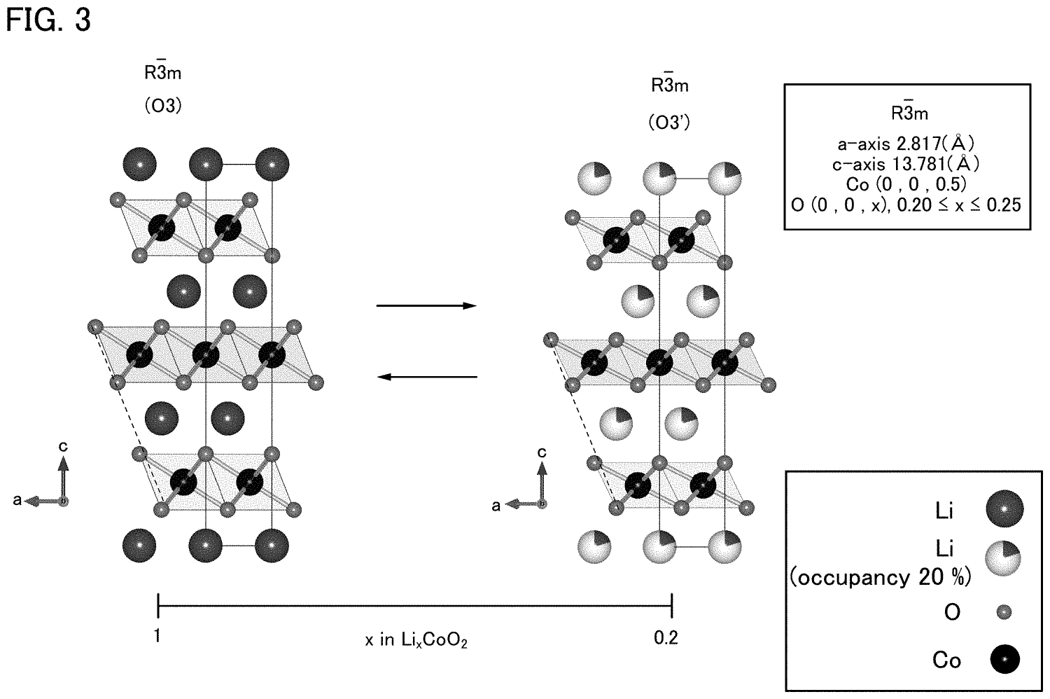

Crystal structures of positive electrode active materials of embodiments of the present invention are described with reference to FIG. 3 to FIG. 6. In FIG. 3 to FIG. 6, lithium cobalt oxide is used as each of the positive electrode active materials.

### <Conventional Positive Electrode Active Material>

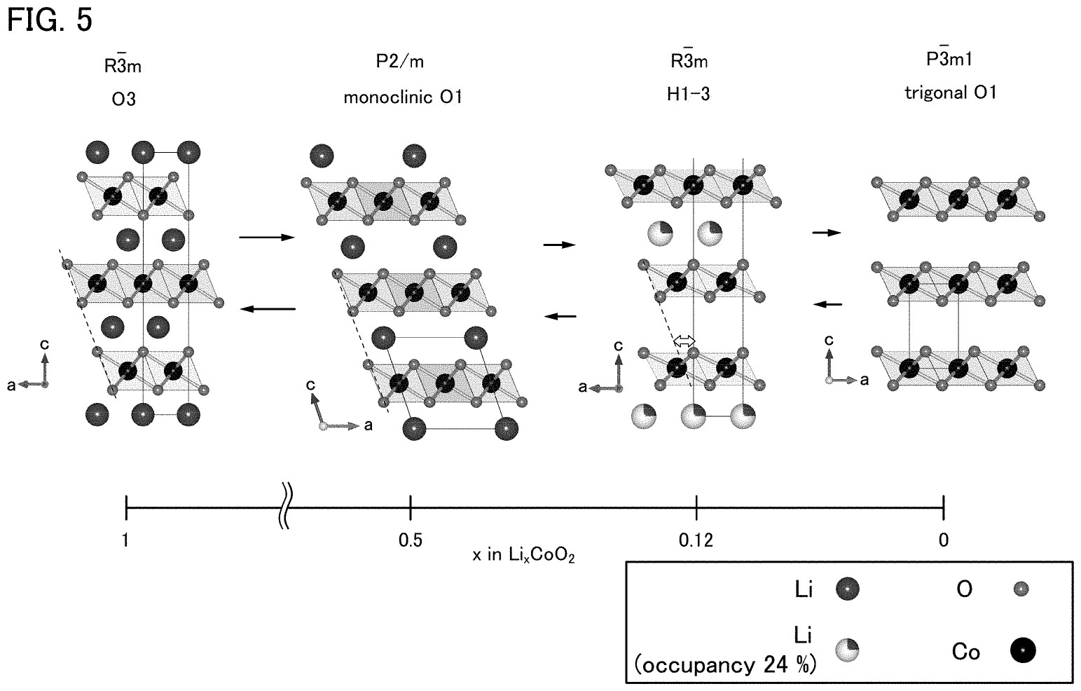

First, lithium cobalt oxide to which Mg is not added (referred to as conventional lithium cobalt oxide) is shown in FIG. 5. It is known that the crystal structure of conventional lithium cobalt oxide changes depending on a charge depth, i.e., the lithium occupancy in the lithium cobalt oxide. The lithium occupancy in the lithium cobalt oxide can be represented by a value of x in LixCoO₂.

As shown in FIG. 5, in conventional lithium cobalt oxide with x in LixCoO₂ of 1 (in a discharged state), there is a region having a crystal structure of a space group R-3m, lithium occupies octahedral sites, and three CoO₂ layers exist in a unit cell. Thus, this crystal structure is referred to as an O3 type crystal structure in some cases. Note that the CoO₂ layer has a structure in which octahedral geometry with oxygen hexacoordinated to cobalt continues on a plane in the edge-sharing state.

Furthermore, when x in LixCoO₂ is 0, conventional lithium cobalt oxide has the crystal structure of a space group P-3 ml, and one CoO₂ layer exists in a unit cell. Thus, this crystal structure is referred to as an 01 type crystal structure or a trigonal 01 type crystal structure in some cases.

Conventional lithium cobalt oxide with, for example, x in LixCoO₂ of approximately 0.12 has the crystal structure of the space group R-3m. This structure can also be regarded as a structure in which CoO₂ structures such as P-3 ml (O1) and LiCoO₂ structures such as R-3m (O3) are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. Moreover, the number of cobalt atoms per unit cell in the actual H1-3 type crystal structure is twice as large as that of cobalt atoms per unit cell in other structures. However, in this specification including FIG. 5, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. In this manner, the H1-3 type crystal structure is represented by a unit cell including one cobalt and two oxygen.

Meanwhile, an O3′ type crystal structure of one embodiment of the present invention described later is represented by a unit cell including one cobalt and one oxygen. This means that the symmetry of cobalt and oxygen differs between the O3′ type crystal structure and the H1-3 type crystal structure, and the amount of change from the O3 structure is smaller in the O3′ type crystal structure than in the H1-3 type crystal structure.

When charging at a high voltage of 4.6 V or higher based on the redox potential of a lithium metal or charging that makes X in LixCoO be 0.24 or less and discharging are repeated, the crystal structure of conventional lithium cobalt oxide changes (i.e., an unbalanced phase change occurs) repeatedly between the H1-3 type crystal structure and the R-3m (O3) structure in a discharged state.

As indicated by the dotted lines and the arrows in the H1-3 type crystal structure in FIG. 5, the CoO₂ layer in the H1-3 type crystal structure largely shifts from that in the R-3m (O3) structure, which means that there is a large difference in the positions of the CoO₂ layers between these two crystal structures. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as the structure of P-3 ml (O1) with x in LixCoO₂ of 0, is unstable.

As described above, the repeated charging and discharging that make x in LixCoO₂ be 0.24 or less gradually break the crystal structure of conventional lithium cobalt oxide. The break of the crystal structure degrades the cycle performance. The break of the crystal structure reduces sites where lithium can stably exist and makes it difficult to insert and extract lithium.

### <Positive Electrode Active Material of One Embodiment of the Present Invention>

The case is described where lithium cobalt oxide is used as the positive electrode active material 100 of one embodiment of the present invention and the lithium cobalt oxide contains an additive element. FIG. 3 illustrates crystal structures of the case where x in LixCoO₂ is 1 and the case where x in LixCoO₂ is approximately 0.2. The additive element is preferably Mg, for example. Added Mg is considered to be replaced in a lithium site, but Mg is not illustrated in FIG. 3.

The crystal structure with x in LixCoO₂ of 1 (in a discharged state) in FIG. 3 is R-3m (O3), which is the same as that in FIG. 5. By contrast, the positive electrode active material 100 of one embodiment of the present invention has a different crystal structure from the H1-3 type crystal structure when it is sufficiently charged (when x in LixCoO₂ is approximately 0.2, for example). This structure belongs to the space group R-3m and is a structure in which an ion of cobalt or the like occupies a site coordinated to six oxygen atoms. Furthermore, the symmetry of CoO₂ layers of this structure is the same as that in the O3 type crystal structure. This structure is thus referred to as the O3′ type crystal structure in this specification and the like.

Considering the value of x in LixCoO₂, a chance of the existence of lithium in all lithium sites is shown as one in five (this is referred to as Li occupancy of 20%) in the O3′ type crystal structure in FIG. 3. However, the positive electrode active material 100 of one embodiment of the present invention is not limited to this, and lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

As indicated by the dotted lines in the O3′ type crystal structure in FIG. 3, there is a very small difference in the positions of the CoO₂ layers of the positive electrode active material 100 of one embodiment of the present invention. In other words, it is found that a change in the crystal structure caused when x in X₂ of LixCoO is approximately 0.2 is smaller than that in conventional lithium cobalt oxide.

For the positive electrode active material 100 of one embodiment of the present invention, for example, lithium cobalt oxide to which Mg is added can be used, and the difference in the positions of the CoO₂ layers can be small in repeated charging and discharging that make x in LixCoO₂ be approximately 0.2. The positive electrode active material of one embodiment of the present invention has a small crystal-structure change and a small volume difference per the same number of cobalt atoms between a sufficiently discharged state and a state with x in LixCoO₂ of approximately 0.2. It can be said that the crystal structure of the positive electrode active material 100 of one embodiment of the present invention is highly stable.

More specifically, at a voltage of higher than or equal to 4.65 V and lower than or equal to 4.7 V with reference to the potential of a lithium metal, the positive electrode active material 100 of one embodiment of the present invention includes a region that can have the O3′ crystal structure. In addition, the positive electrode active material 100 of one embodiment of the present invention can have the O3′ crystal structure in some cases even at a lower charge voltage, e.g., a charge voltage of higher than or equal to 4.5 V and lower than 4.6 V, with reference to the potential of a lithium metal.

The space group of a crystal structure is identified by XRD, electron diffraction, neutron diffraction, or the like. Thus, in this specification and the like, belonging to a space group or being a space group can be rephrased as being identified as a space group.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811, typically, c=13.781 (Å).

The above-described positive electrode active material of one embodiment of the present invention can have excellent cycle performance. In addition, the positive electrode active material of one embodiment of the present invention can have a stable crystal structure. Thus, in the positive electrode active material of one embodiment of the present invention, sometimes a short circuit is less likely to occur. This is preferable because the safety is further improved.

### <<XRD>>

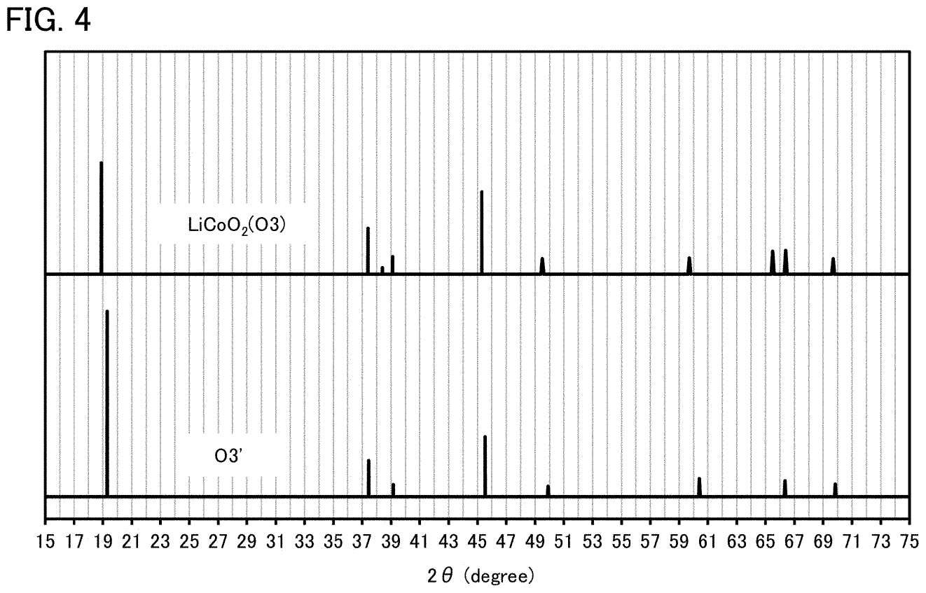

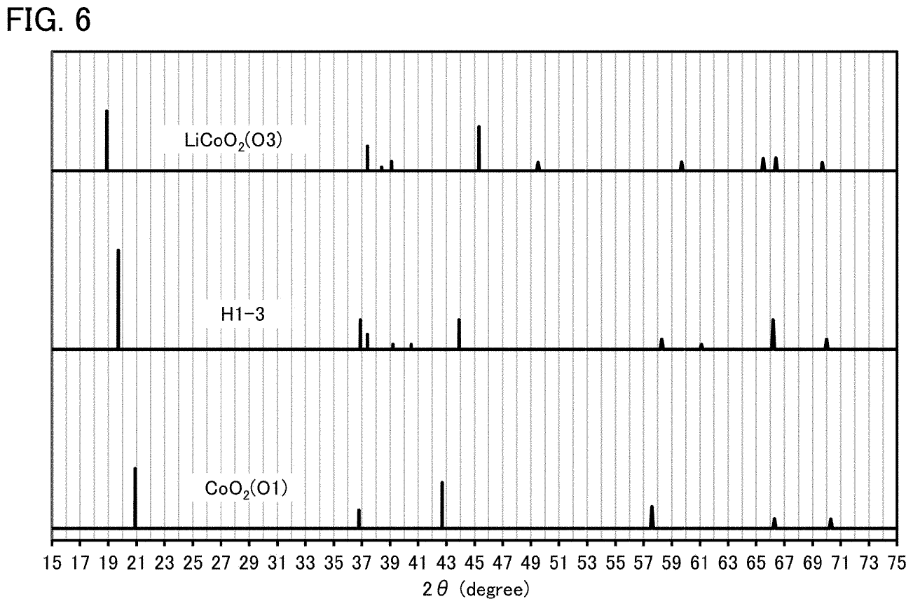

FIG. 4 and FIG. 6 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with x in LixCoO₂ of 1 and the crystal structure of CoO₂ (O1) with x in LixCoO₂ of 0 are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The O3′ type crystal structure was, on the basis of the O3′ type crystal structure illustrated in FIG. 3, fitted with TOPAS ver. 3 (crystal structure analysis software manufactured by Bruker Corporation), and the XRD pattern was made in a similar manner to other structures.

As shown in FIG. 4, the O3′ type crystal structure has diffraction peaks at 2θ of 19.30±0.20° (greater than or equal to 19.10° and less than or equal to 19.50°) and 2θ of 45.55±0.100 (greater than or equal to 45.450 and less than or equal to 45.65°). More specifically, diffraction peaks appear at 2θ of 19.30±0.10° (greater than or equal to 19.200 and less than or equal to 19.40°) and 2θ of 45.55±0.05° (greater than or equal to 45.500 and less than or equal to 45.60). However, as shown in FIG. 6, the H1-3 type crystal structure and CoO₂ (P-3 ml, O1) do not have diffraction peaks at these positions. Thus, the diffraction peaks at 2θ of 19.30±0.20° and 2θ of 45.55±0.100 in the state where x in LixCoO₂ is 0.2 or less can be the features of the positive electrode active material 100 of one embodiment of the present invention.

It can also be said that the positions of the diffraction peaks in the crystal structure with x of X₂ in LixCoO of 1 are close to those of the diffraction peaks in the crystal structure with x in LixCoO₂ of 0.2 or less. More specifically, it can be said that a difference in the positions of two or more, preferably three or more of the diffraction peaks between the crystal structures, at 2θ, is less than or equal to 0.7°, further preferably less than or equal to 0.5°.

Note that the positive electrode active material 100 of one embodiment of the present invention with x in LixCoO₂ of 0.2 or less does not need to have the O3′ type crystal structure entirely. The positive electrode active material 100 of one embodiment of the present invention may include another crystal structure or may be partly amorphous. Note that when the Rietveld analysis is performed, the O3′ type crystal structure preferably accounts for more than or equal to 50%, further preferably more than or equal to 60%, and still further preferably more than or equal to 66%. The positive electrode active material in which the O3′ type crystal structure accounts for more than or equal to 50%, further preferably more than or equal to 60%, still further preferably more than or equal to 66% can have sufficiently good cycle performance. The O3′ type crystal structure preferably exists in the surface portion or the projection of the positive electrode active material.

Furthermore, when the Rietveld analysis is performed after 100 or more charge and discharge cycle tests, the O3′ type crystal structure preferably accounts for greater than or equal to 35%, further preferably greater than or equal to 40%, still further preferably greater than or equal to 43%.

Sharpness of a diffraction peak in an XRD pattern indicates the degree of crystallinity. It is thus preferable that the diffraction peaks after charging be sharp or in other words, have a small half width. Even diffraction peaks that are derived from the same crystal phase have different half widths depending on the XRD measurement conditions and/or the 2θ value. In the case of the above-described measurement conditions, the diffraction peak observed at 2θ of greater than or equal to 43° and less than or equal to 46° preferably has a half width of less than or equal to 0.2°, further preferably less than or equal to 0.15°, still further preferably less than or equal to 0.12°. Note that not all diffraction peaks need to fulfill the requirement. A crystal phase can be regarded as having high crystallinity when some diffraction peaks fulfill the requirement. Accordingly, high crystallinity efficiently contributes to stability of the crystal structure after charging.

Such a positive electrode active material of one embodiment of the present invention can have excellent cycle performance. In addition, the positive electrode active material of one embodiment of the present invention with x in LixCoO₂ of 0.2 or less can have a stable crystal structure. Thus, in the positive electrode active material of one embodiment of the present invention, a short circuit is unlikely to occur while the state with x in LixCoO₂ of 0.2 or less is maintained, in some cases. This is preferable because the safety is further improved.

This embodiment can be implemented in appropriate combination with any of the other embodiments.

### Embodiment 2

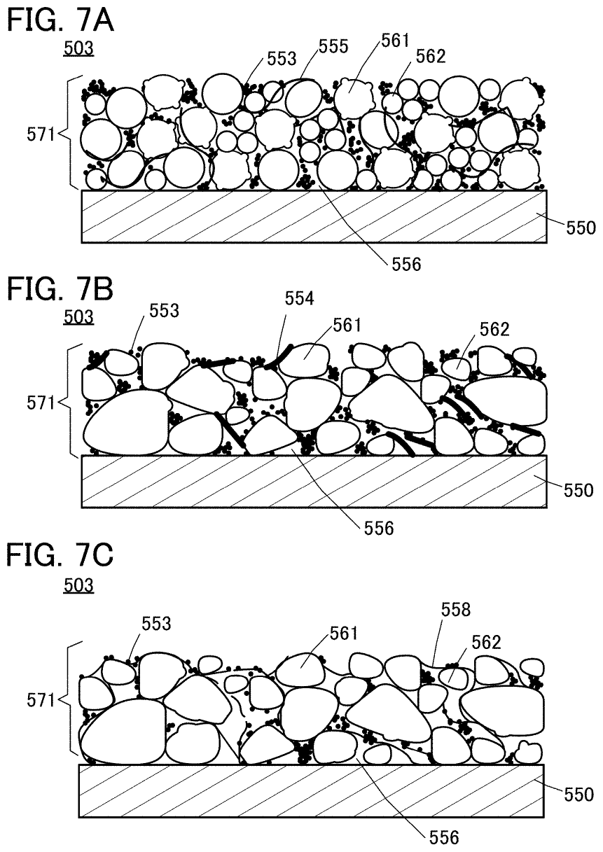

In this embodiment, a positive electrode will be described with reference to FIG. 7.

### [Positive Electrode]

FIG. 7A shows an example of a cross-sectional view of a positive electrode 503. The positive electrode includes a positive electrode active material layer 571 over a positive electrode current collector 550. The positive electrode active material layer 571 includes a positive electrode active material 561, a positive electrode active material 562, a binder (binding agent) 555, a conductive additive 553, and an electrolyte 556. The positive electrode active material 561 has a larger particle diameter than the positive electrode active material 562. In addition, the positive electrode active material described in Embodiment 1 above can be used as one or two selected from the positive electrode active material 561 and the positive electrode active material 562. In FIG. 7A, the projection described in Embodiment 1 above is illustrated in the positive electrode active material 561. The conductive additive 553 is a particulate conductive additive.

In FIG. 7A, the regions not filled with the positive electrode active material 561, the positive electrode active material 562, the conductive additive 553, or the like are voids, some of which contain the electrolyte 556. The positive electrode active material 561 or the like has a gap to facilitate impregnation with the electrolyte 556, and this gap is a cavity.

Although FIG. 7A shows the particulate positive electrode active material 561 with a projection on the surface, the positive electrode active material 561 is not necessarily particulate. As shown in FIG. 7B, the cross-sectional shape of the positive electrode active material 561 may be an ellipse, a rectangle, a trapezoid, a pyramid, a quadrilateral with rounded corners, or an asymmetrical shape. Note that by pressing in the manufacturing process of the positive electrode, the particulate positive electrode active material sometimes changes in shape to have the shape as shown in FIG. 7B.

FIG. 7B does not illustrate the binder 555 and illustrates a conductive additive 554. The positive electrode 503 illustrated in FIG. 7B includes at least two conductive additives. The conductive additive 554 differs from the conductive additive 553 in at least a shape, and the conductive additive 554 is a sheet-like conductive additive. The sheet-like conductive additive illustrated in one cross section is sometimes linear, but has a shape with three-dimensional expansion. The use of the sheet-like conductive additive can increase the dispersibility of the particulate conductive additive.

In FIG. 7B, the regions not filled with the positive electrode active material 561, the positive electrode active material 562, the conductive additive 553, the conductive additive 554, or the like are voids, some of which contain the electrolyte 556. The positive electrode active material 561 or the like has a gap to facilitate impregnation with the electrolyte 556, and this gap is a cavity.

FIG. 7C does not illustrate the binder 555 and shows an example of a positive electrode using a conductive additive 558 instead of the conductive additive 554 in FIG. 7B. The conductive additive 558 differs from the conductive additive 553 and the conductive additive 554 in at least a shape, and the conductive additive 558 is a fibrous conductive additive. The use of the fibrous conductive additive can increase the dispersibility of the particulate conductive additive.

In FIG. 7C, the regions not filled with the positive electrode active material 561, the positive electrode active material 562, the conductive additive 553, the conductive additive 558, or the like are voids, some of which contain the electrolyte 556. The positive electrode active material 561 or the like has a gap to facilitate impregnation with the electrolyte 556, and this gap is a cavity.

In FIG. 7A to FIG. 7C, the volume of the positive electrode active material 561 or the like sometimes changes in charging and discharging; however, the fluorine-containing electrolyte 556 such as a fluorinated carbonate ester between the plurality of positive electrode active materials 561 maintains smoothness and suppresses a crack even when the volume changes in charging and discharging, so that an effect of increasing the cycle performance is obtained. It is important to have an organic compound containing fluorine between a plurality of active materials included in the positive electrode.

Specific examples of materials and the like used in FIG. 7A to FIG. 7C are described.

### [Positive Electrode Active Material]

The positive electrode active material layer 571 includes the positive electrode active material 561 or the positive electrode active material 562 and is filled with at least the positive electrode active material 561. In the positive electrode active material layer 571, the filling density of the positive electrode active material 561 is preferably high. Therefore, the above-described positive electrode active material 562 having a different particle size is added in some cases. The different particle size means a different median diameter (D50).

For example, the positive electrode active material 562 has a smaller particle size, i.e., a smaller median diameter (D50) than the positive electrode active material 561. The median diameter (D50) of the positive electrode active material 562 is preferably ⅙ to 1/10 of the median diameter (D50) of the positive electrode active material 561. Mixing the positive electrode active materials with different particle sizes leads to an increase in the filling density of the positive electrode active material in the positive electrode active material layer 571.

Although the above description is made using the median diameter (D50), a particle diameter obtained by measuring a cross-sectional diameter may be used.

In accordance with the size of the projection of the positive electrode active material 561 with a large particle size, a gap between the positive electrode active materials can be reduced during filling. Therefore, the filling density can be increased without the positive electrode active material 562. When the positive electrode active material 562 is not included, the number of manufacturing steps can be reduced and furthermore, the cost can be reduced.

Although not illustrated in FIG. 7A to FIG. 7C, the positive electrode active material 562 may also have a projection.

In the positive electrode active material 561 and/or the positive electrode active material 562, the additive element exists in the vicinity of the surface. That is, in the positive electrode active material 561 and/or the positive electrode active material 562, the concentration of the additive element in the vicinity of the surface is preferably higher than the concentration of the additive element in the inner portion. The additive element is unevenly distributed in the surface and thus does not exist or scarcely exists in the bulk of the positive electrode active material 561 and/or the positive electrode active material 562. It is considered that even if the additive element does not contribute to the capacitance value, the structure in which the additive element does not exist or scarcely exists in the bulk prevents a reduction in the capacitance value of the positive electrode active material 561 and/or the positive electrode active material 562. In addition, the structure deterioration is prevented when the additive element exists at least in the vicinity of the surface, and the positive electrode active material is less likely to deteriorate even at a high charge voltage.

### [Binder]

The binder 555 is provided to prevent separation of the positive electrode active material 561 or the like or the conductive additive 553 or the like from the positive electrode current collector 550. The binder 555 has a function of fixing the positive electrode active material 561 or the like and the conductive additive 553 or the like to each other. Thus, there are the binder 555 positioned to be in contact with the positive electrode current collector 550, the binder 555 positioned between the positive electrode active material 561 or the like and the conductive additive 553 or the like, and the binder 555 positioned to be intertwined with the conductive additive 553 or the like.

The binder 555 contains a resin that is a high molecular material. When a lot of binder is contained, the proportion of the positive electrode active material 561 or the like in the positive electrode active material layer 571 sometimes decreases. Such a decrease in the proportion of the positive electrode active material 561 or the like leads to lowered discharge capacity of a secondary battery; thus, the mixed quantity of the binder 555 is minimized. The positive electrode active material 561 or the like of the present invention, which has a projection on its surface, is likely to be bonded to the binder 555, so that the mixed quantity of the binder 555 can be reduced.

The above-described conductive additive 553 can be replaced with the conductive additive 554 or the conductive additive 558 depending on the structure of the positive electrode 503. The above-described positive electrode active material 561 can be replaced with the positive electrode active material 562 depending on the structure of the positive electrode 503.

### [Conductive Additive]

The conductive additive 553, the conductive additive 554, and the conductive additive 558 are each formed using a material having a lower resistance than the positive electrode active material 561 or the like. The positive electrode active material 561 is a composite oxide and thus may have a high resistance. In this case, it is difficult to gather currents from the positive electrode active material 561 or the like to the positive electrode current collector 550. Therefore, the conductive additive 553, the conductive additive 554, and the conductive additive 558 have a function of giving aid to a current path between the positive electrode active material 561 or the like and the positive electrode current collector 550, a current path between a plurality of positive electrode active materials 561 or the like, a current path between a plurality of positive electrode active materials and the positive electrode current collector 550, and the like. In order to make use of such a function, some of the conductive additive 553, the conductive additive 554, and the conductive additive 558 are placed so as to be in contact with the positive electrode current collector 550 and are placed in a gap between the positive electrode active materials 561 or the like.

A conductive additive is also referred to as a conductivity-imparting agent or a conductive material owing to its role, and a carbon material or a metal material is used. Examples of the carbon material used as the conductive additive 553 include carbon black (e.g., furnace black, acetylene black, and graphite). Since the carbon black has a smaller particle diameter than the positive electrode active material 561 of the present invention which has a projection on its surface, the carbon black is likely to be positioned in the vicinity of the projection. As a sheet-like carbon material used as the conductive additive 554, multilayer graphene is given. As a fibrous carbon material used as the conductive additive 558, carbon nanotube (CNT) or VGCF (registered trademark) is given.

The particulate conductive additive 553 can enter a gap between a plurality of positive electrode active materials and easily aggregates. Thus, the particulate conductive additive 553 can give aid to a conductive path between positive electrode active materials provided close to each other (adjacent positive electrode active materials). The sheet-like conductive additive 554 or the fibrous conductive additive 558 includes a bent region but has a shape with a side longer than the positive electrode active material 561. The sheet-like conductive additive 554 or the fibrous conductive additive 558 can thus give aid to not only a conductive path between adjacent positive electrode active materials but also a conductive path between positive electrode active materials located apart from each other.

A particulate conductive additive and a sheet-like conductive additive are preferably mixed like the conductive additive 553 and the conductive additive 554. Alternatively, a particulate conductive additive and a fibrous conductive additive are preferably mixed like the conductive additive 553 and the conductive additive 558. Alternatively, a sheet-like conductive additive and a fibrous conductive additive may be mixed like the conductive additive 554 and the conductive additive 558.

In the case of mixing graphene as a sheet-like conductive additive and carbon black as a particulate conductive additive, the weight of the carbon black is 1.5 times to 20 times, preferably 2 times to 9.5 times the weight of graphene in slurry.

When the mixing ratio between graphene and carbon black is in the above range, carbon black is excellent in dispersion stability and carbon black does not aggregate and is easily dispersed at the time of preparing the slurry. When the mixing ratio between graphene and carbon black is in the above range, the electrode density can be higher than when only carbon black is used as a conductive additive. As the electrode density is higher, the capacity per volume can be higher. Specifically, the density of the positive electrode active material layer, excepting the current collector, measured by dividing the weight of the positive electrode active material layer (the positive electrode, the conductive additive, and the binder) by the volume can be higher than 3.5 g/cm3. Moreover, when the positive electrode active material of the present invention is the positive electrode active material 561 and the mixing ratio between graphene and carbon black is in the above range, the secondary battery has higher capacity. It is preferable that graphene and carbon black be mixed as conductive additives and the positive electrode active material have a projection on its surface, in which case a synergy effect can be expected.

When a positive electrode including only graphene as a conductive additive is compared with a positive electrode including a mixture of graphene and carbon black, the positive electrode in which the mixing ratio between graphene and carbon black is in the above range enables fast charging. A secondary battery including the positive electrode active material of the present invention can have high capacity. Since the secondary battery enables fast charging, a synergy effect can be expected in a vehicle.

An example of a secondary battery included in a vehicle is a laminated secondary battery. A so-called assembled battery structure in which the number of laminated secondary batteries is increased for higher capacity is employed in an attempt to extend the vehicle's mileage. Accordingly, the laminated batteries increase the weight of the vehicle, which increases the energy necessary to move the vehicle. When a high-density secondary battery can be used as in the present invention, there is no need to increase the number of laminated secondary batteries, so that the mileage can be extended with almost no increase in the total weight of the vehicle.

Furthermore, a secondary battery with high capacity included in a vehicle requires more power for charging, so that charging can be ended in a short time. A secondary battery included in a vehicle preferably has high capacity, in which case what is called a regenerative charging, in which electric power temporarily generated when the vehicle is braked is used for charging, can be performed at high speed.

One embodiment of the present invention is effective also in a portable information terminal. This is because according to one embodiment of the present invention, a secondary battery can be downsized and can have high capacity. Furthermore, according to one embodiment of the present invention, the portable information terminal can be charged at high speed.

### [Electrolyte]

The electrolyte 556 is a liquid electrolyte, a solid electrolyte, or a semi-solid-state electrolyte. The liquid electrolyte is referred to as an electrolyte solution in some cases. As the electrolyte solution, an ionic liquid may be used besides an organic solvent. The ionic liquid exhibits incombustibility, which can improve the safety of the secondary battery.

The inside of the positive electrode active material layer 571 is filled with the electrolyte 556, and in the case where the electrolyte 556 is an electrolyte solution, the positive electrode active material layer 571 is impregnated with the electrolyte solution from gaps of the positive electrode active materials 561. It can be denoted that the positive electrode active material 561 is immersed in the electrolyte solution. When there is no gap between the positive electrode active materials 561, impregnation with the electrolyte 556 is difficult in some cases.

The volume of the positive electrode active material 561 sometimes changes in charging and discharging of the secondary battery; however, fluorine such as a fluorinated carbonate ester is preferably contained as the electrolyte 556 in a gap between the positive electrode active materials 561. Smoothness of the positive electrode active materials 561 may be maintained even when the volume changes in charging and discharging.

The volume change in charging and discharging sometimes generates a crack in the positive electrode active material 561; however, when fluorine such as a fluorinated carbonate ester is contained as the electrolyte 556, generation of the crack may be inhibited. When generation of the crack is inhibited, the cycle performance of the secondary battery is improved.

With the use of the electrolyte 556 having a wide operating temperature range, a secondary battery that can be used at temperatures higher or lower than room temperature can be provided.

### [Current Collector]

For the positive electrode current collector 550, metal foil containing aluminum, titanium, copper, nickel, or the like can be used. Slurry containing the positive electrode active material layer 571 is applied onto the metal foil and is dried to complete the positive electrode 503. The metal foil may be covered with a carbon material. A structure covered with a carbon material is referred to as a carbon coat structure in some cases.

The slurry applied on the positive electrode current collector 550 contains at least the positive electrode active material 561, the binder 555, and a solvent, and it is preferable that the conductive additive 553 or the like be further mixed in this slurry. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

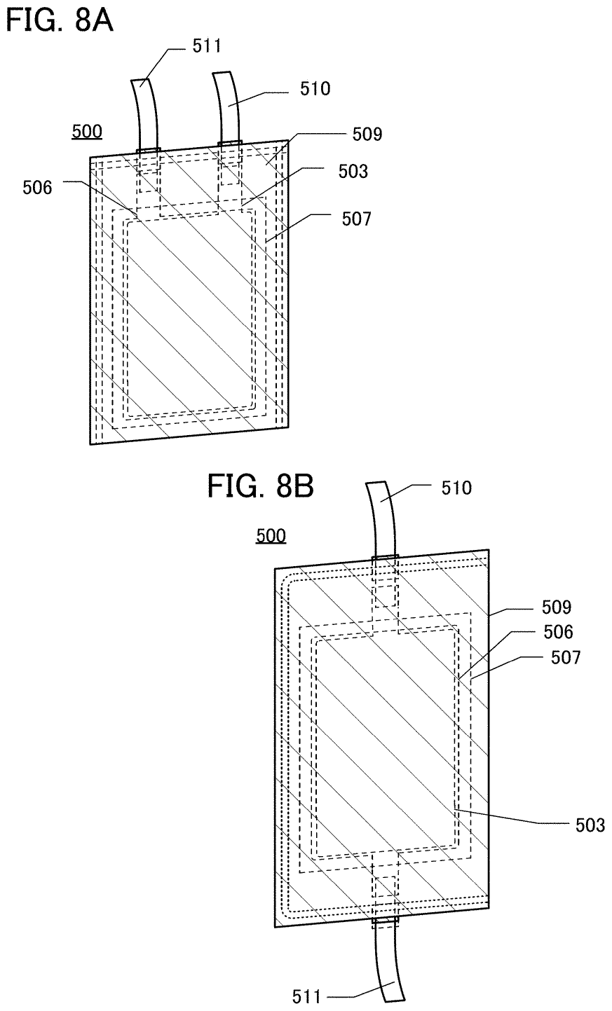

The secondary battery can be manufactured using any one of the positive electrodes in FIG. 7A to FIG. 7C. A stack in which a separator is laid over the positive electrode and a negative electrode is laid over the separator is put in a container (e.g., an exterior body or a metal can) or the like, and the container is filled with the electrolyte. A laminated secondary battery is described with reference to FIG. 8.

### [Laminated Secondary Battery]

FIG. 8A and FIG. 8B each show an example of an external view of a laminated secondary battery 500. The laminated secondary battery 500 includes the positive electrode 503, a negative electrode 506, a separator 507, an exterior body 509, a positive electrode lead electrode 510, and a negative electrode lead electrode 511. FIG. 8A shows an example in which the positive electrode lead electrode 510 and the negative electrode lead electrode 511 are provided on the same side of the exterior body 509. FIG. 8B shows an example in which the positive electrode lead electrode 510 and the negative electrode lead electrode 511 are provided on opposite sides of the exterior body 509. Regions in the exterior body 509 where the lead electrodes are placed are also referred to as tab regions. The areas and the shapes of the tab regions are not limited to those illustrated in FIG. 8A and FIG. 8B.

### [Negative Electrode]

The negative electrode 506 includes a negative electrode active material layer and a negative electrode current collector. The negative electrode active material layer may include a conductive additive and a binding agent.

### [Negative Electrode Active Material]

As the negative electrode active material, for example, an alloy-based material or a carbon-based material can be used. The negative electrode active material used for the secondary battery of one embodiment of the present invention particularly preferably contains fluorine as a halogen. Fluorine has high electronegativity, and the negative electrode active material containing fluorine in its surface portion may have an effect of facilitating extraction of the solvating solvent at the surface of the negative electrode active material.

As the negative electrode active material, an element that enables charge and discharge reactions by alloying and dealloying reactions with lithium that is a carrier ion can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO (which is silicon monoxide and is expressed as SiO_{X} in some cases; x is preferably greater than or equal to 0.2 and less than or equal to 1.5), Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

Silicon nanoparticles can be used as the negative electrode active material containing silicon. The median diameter (D50) of a silicon nanoparticle is greater than or equal to 5 nm and less than 1 μm, preferably greater than or equal to 10 nm and less than or equal to 300 nm, further preferably greater than or equal to 10 nm and less than or equal to 100 nm. The silicon nanoparticles may have crystallinity. The silicon nanoparticles may include a region with crystallinity and an amorphous region.

Although the above description is made using the median diameter (D50), a particle diameter obtained by measuring a cross-sectional diameter may be used.

The negative electrode active material containing silicon may be in the form of a silicon monoxide particle including one or more silicon crystal grains. The silicon monoxide may be amorphous. The silicon monoxide particle may be coated with carbon. This particle can be mixed with graphite to be used as the negative electrode active material.

As a carbon-based material, graphite, graphitizing carbon (soft carbon), non-graphitizing carbon (hard carbon), carbon nanotube, graphene, carbon black, or the like can be used. Such a carbon-based material preferably contains fluorine. A carbon-based material containing fluorine can also be referred to as a particulate or fibrous fluorocarbon material. In the case where the carbon-based material is subjected to measurement by X-ray photoelectron spectroscopy, the concentration of fluorine is preferably higher than or equal to 1 at % with respect to the total concentration of fluorine, oxygen, lithium, and carbon.

The volume of the negative electrode active material sometimes changes in charging and discharging; however, a fluorine-containing organic compound such as a fluorinated carbonate ester between the negative electrode active materials maintains smoothness and suppresses a crack even when the volume changes in charging and discharging, so that an effect of increasing the cycle performance is obtained. It is important to have an organic compound containing fluorine between a plurality of negative electrode active materials.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery can have a high operating voltage. In addition, graphite is preferred because of its advantages such as a relatively high capacity per unit volume, relatively small volume expansion, low cost, and a level of safety higher than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), and iron oxide (FeO), may be used as the negative electrode active material. A conversion reaction also occurs in oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

[Conductive Additive Modified with Fluorine]

The conductive additive contained in the negative electrode 506 is preferably modified with fluorine. For example, as the conductive agent, a material obtained by modification of the above-described conductive additive with fluorine can be used.

The conductive additive can be modified with fluorine through treatment or heat treatment using a fluorine-containing gas or plasma treatment in a fluorine-containing gas atmosphere, for example. As the fluorine-containing gas, for example, a fluorine gas or a lower hydrofluorocarbon gas such as fluoromethane (CF₄) can be used.

The conductive additive may be modified with fluorine through immersion in a solution containing hydrofluoric acid, tetrafluoroboric acid, hexafluorophosphoric acid, or the like or a solution containing a fluorine-containing ether compound, for example.

Modification of the conductive additive with fluorine is expected to stabilize the structure of the conductive additive and suppress a side reaction in charging and discharging process of a secondary battery. The suppression of the side reaction can improve charge and discharge efficiency. In addition, a decrease in capacity caused by repetitive charging and discharging can be suppressed. Thus, when a conductive additive that is modified with fluorine is used, a secondary battery with excellent battery characteristics can be achieved.

In some cases, stabilization of the structure of the conductive agent stabilizes conductive characteristics, leading to high output characteristics.

### [Negative Electrode Current Collector]

For the negative electrode current collector, a material similar to that of the positive electrode current collector can be used. Note that a material that is not alloyed with carrier ions such as lithium is preferably used for the negative electrode current collector.

### [Separator]

The separator 507 is positioned between the positive electrode 503 and the negative electrode 506. As the separator 507, for example, a fiber containing cellulose such as paper; nonwoven fabric; a glass fiber; ceramics; or a synthetic fiber using nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator 507 may have a multilayer structure. For example, an organic material film such as polypropylene or polyethylene can be coated with a ceramic-based material, a fluorine-based material, a polyamide-based material, a mixture thereof, or the like. As the ceramic-based material, for example, aluminum oxide particles or silicon oxide particles can be used. As the fluorine-based material, for example, PVDF or polytetrafluoroethylene can be used. As the polyamide-based material, for example, nylon or aramid (meta-based aramid or para-based aramid) can be used.

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

Any of electrolytes that are the same as the electrolytes described with reference to FIG. 7A to FIG. 7C can be selected.

### [Method for Manufacturing Laminated Secondary Battery]

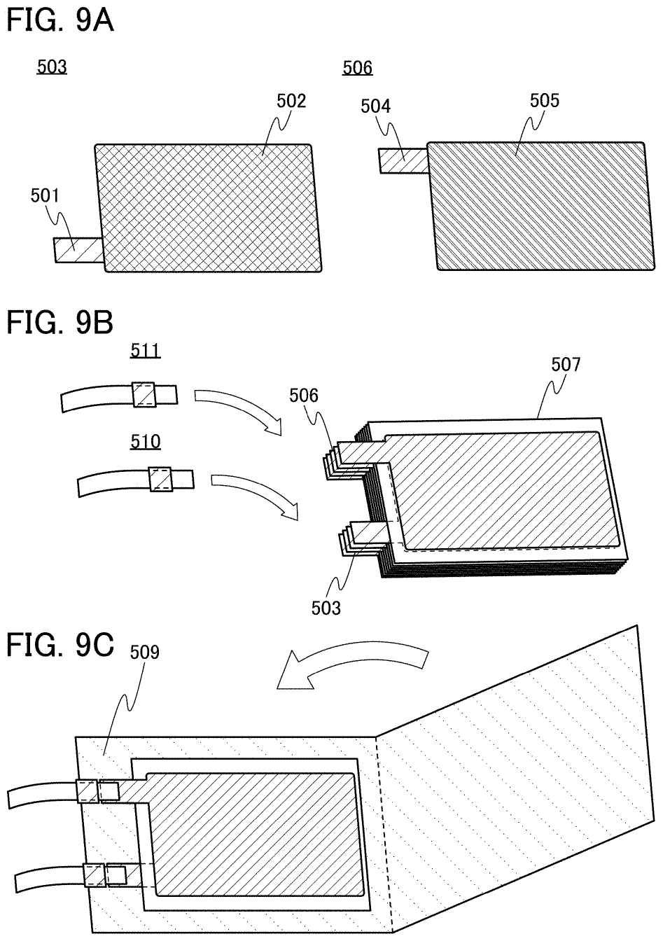

An example of a method for manufacturing the laminated secondary battery illustrated in FIG. 8A will be described with reference to FIG. 9A to FIG. 9C.

First, the positive electrode 503 and the negative electrode 506 are prepared. The positive electrode 503 includes a tab 501 and a positive electrode active material layer 502. The negative electrode 506 includes a tab 504 and a negative electrode active material layer 505.

The negative electrode 506, the separator 507, and the positive electrode 503 are stacked in this order. FIG. 9B illustrates a stack including the negative electrode 506, the separator 507, and the positive electrode 503. The separator 507 has a larger size and longer one side than the negative electrode 506 and the positive electrode 503. This is prevention of a short circuit between the positive electrode 503 and the negative electrode 506. FIG. 9B shows an example in which five negative electrodes and four positive electrodes are used. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the stack including the negative electrodes 506, the separators 507, and the positive electrodes 503 is placed over the exterior body 509.

Subsequently, the exterior body 509 is folded along a portion shown by a dashed line, as illustrated in FIG. 9C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte can be put later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, an electrolyte (not illustrated) is introduced into the exterior body 509 from the inlet of the exterior body 509. The electrolyte is preferably introduced in a reduced pressure atmosphere or in an inert atmosphere. Lastly, the inlet is sealed by bonding. In this manner, the laminated secondary battery 500 can be manufactured.

The positive electrode active material 100 of the present invention is used in the positive electrode 503, whereby the secondary battery can have high capacity, high charge and discharge capacity, and excellent cycle performance.

This embodiment can be implemented in appropriate combination with any of the other embodiments.

### Embodiment 3

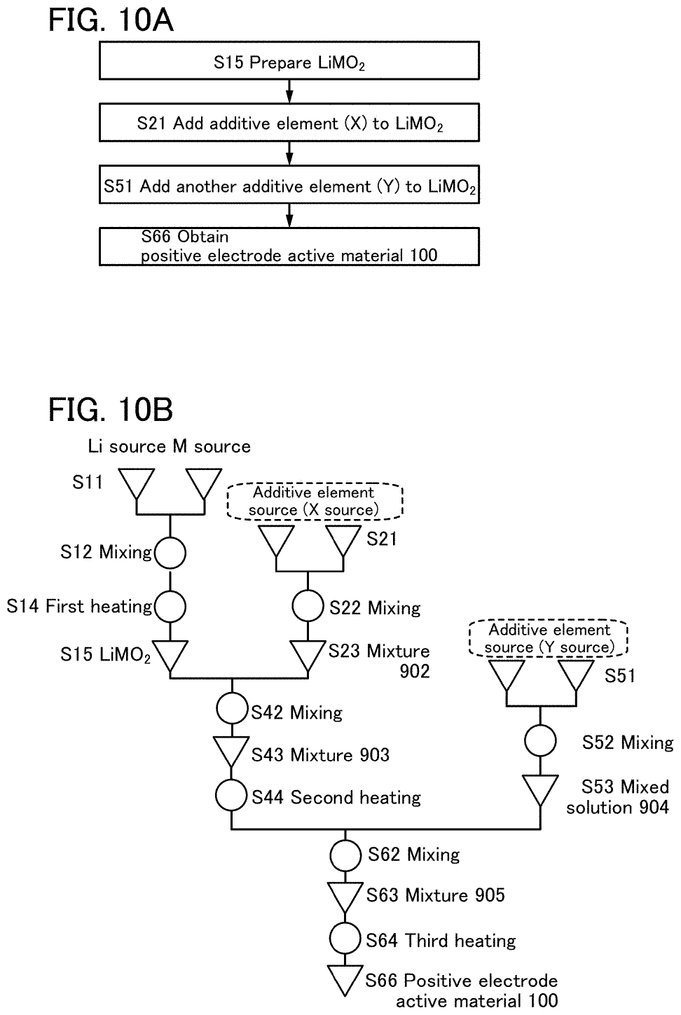

In this embodiment, a method for forming a positive electrode active material of one embodiment of the present invention is described with reference to FIG. 10.

As shown in FIG. 10A, for the positive electrode active material of one embodiment of the present invention, a lithium composite oxide containing a transition metal M (LiMO₂) is prepared (Step S15). Then, at least two additive elements are added to LiMO₂ and the addition step is performed at least twice. In FIG. 10A, an additive element (X) is added to LiMO₂ (Step S21) and another additive element (Y) is added to LiMO₂ (Step S51). As the additive element (Y), a Group 4 element, a Group 5 element, or a lanthanoid element is used. As the Group 4 element, the Group 5 element, or the lanthanoid element, one or more or two or more selected from Hf, V, Nb, Ce, Sm, Hf, and Zr are contained. Through these steps, the positive electrode active material 100 is obtained as shown in FIG. 10A (Step S66).

Between the steps shown in FIG. 10A, one or two or more steps selected from a step of preparing a material source (referred to as a starting material or a precursor in some cases), a step of mixing materials, a step of obtaining a mixture, a heating step, and a classification step are included. The steps are described in detail with reference to FIG. 10B.

### <Step S11>

In FIG. 10B, at least a lithium source (Li source) and a transition metal source (M source) are prepared. The lithium source (Li source) and the transition metal source (M source) are to be main components of the positive electrode active material, and the Li source and the M source are also referred to as starting materials or precursors.

Note that as the transition metal, a metal that can form, together with lithium, a composite oxide having the layered rock-salt structure belonging to the space group R-3m is preferably used. A composite oxide containing lithium is referred to as a lithium composite oxide in some cases. As the transition metal, one or two or more selected from manganese, cobalt, nickel, and the like can be used. Aluminum or the like may be further added as a starting material.

As the Li source of Step S11, one or two or more selected from lithium carbonate, lithium fluoride, and the like can be used.

As the M source of Step S11, one or two or more selected from an oxide of the transition metal, a hydroxide of the transition metal, and the like can be used. As a cobalt source, one or two or more selected from cobalt oxide, cobalt hydroxide, and the like can be used. As a manganese source, one or two or more selected from manganese oxide, manganese hydroxide, and the like can be used. As a nickel source, one or two or more selected from nickel oxide, nickel hydroxide, and the like can be used.

In the case of using aluminum as a starting material, one or two or more selected from aluminum oxide, aluminum hydroxide, an alkoxide containing aluminum, and the like can be used as an aluminum source.

### <Step S12>

Step S12 in FIG. 10B includes a step of mixing the above-described Li source, M source, and the like. The mixing can be performed by one or two or more selected from a dry method and a wet method. Depending on the mixing conditions, the mixture may be ground.

When the mixing step is performed by a wet method, a solvent is prepared. As the solvent, acetone; alcohol such as ethanol or isopropanol; ether such as diethyl ether; dioxane; acetonitrile; N-methyl-2-pyrrolidone (NMP); or the like can be used. A dehydrated solvent or a super-dehydrated solvent can be used as the solvent, and dehydrated acetone or super-dehydrated acetone can be used, for example. The dehydrated acetone refers to, for example, acetone whose moisture content is less than or equal to 50 ppm, preferably less than or equal to 20 ppm. Furthermore, acetone whose moisture content is less than or equal to 10 ppm is referred to as super-dehydrated acetone. An aprotic solvent that hardly reacts with a lithium compound that is the mixture is further preferably used as the solvent. During the mixing step by a wet method, the mixture is ground in many cases.

As an equipment for the mixing, a ball mill, a bead mill, or the like can be used. When a ball mill is used, zirconia balls are preferably used. The rotation speed in Step S12 is preferably higher than or equal to 300 rpm and lower than or equal to 500 rpm.

This step may only include the mixing but preferably includes grinding for pulverizing the starting material or the like with the above-described equipment or the like in order to obtain a pulverized mixture.

Furthermore, the mixture may be made to pass through a sieve. The entire mixture obtained in Step S12 is preferably uniform with a median diameter (D50) of greater than or equal to 0.1 μm, for example, greater than or equal to 0.1 μm and less than or equal to 100 μm, further preferably greater than or equal to 1 μm and less than or equal to 50 μm, still further preferably greater than or equal to 1 μm and less than or equal to 15 μm.

Although the above description is made using the median diameter (D50), a particle diameter obtained by measuring a cross-sectional diameter may be used.

### <Step S14>

Step S14 in FIG. 10B includes a step of heating the mixture (referred to as the mixed material in some cases) obtained in Step S12. With the use of an ordinal number, this step is sometimes referred to as first heating to distinguish this step from a heating step performed later. Alternatively, this step is sometimes referred to as baking. The first heating can be performed with a sequential heating apparatus or a batch-type heating apparatus.

The first heat treatment is preferably performed in an atmosphere with little moisture, such as dry air (e.g., a dew point is lower than or equal to −50° C., further preferably lower than or equal to −100° C.). In order to obtain a dry atmosphere, dry oxygen or the like is preferably made to flow. The flow rate of the dry oxygen or the like is preferably greater than or equal to 5 L/min and less than or equal to 35 L/min.

The temperature range of the first heating is preferably higher than or equal to 800° C. and lower than 1100° C., further preferably higher than or equal to 900° C. and lower than 1100° C., still further preferably higher than or equal to 950° C. and lower than 1100° C.

When the temperature of the first heating is lower than 800° C., which is the lower limit, decomposition and melting of the Li source and the M source might be insufficient. When the temperature of the first heating is higher than or equal to 1100° C., which is the upper limit, a defect might be caused due to evaporation or sublimation of lithium, for example. In the case where cobalt is used as a transition metal, a defect in which cobalt has divalence might be caused at 1100° C. or higher. Therefore, in consideration of use of cobalt, the temperature of the first heating is preferably higher than or equal to 900° C. and lower than or equal to 1000° C., further preferably higher than or equal to 950° C. and lower than or equal to 1000° C.

The time of the first heating is preferably longer than or equal to 1 hour and shorter than or equal to 100 hours, further preferably longer than or equal to 2 hours and shorter than or equal to 20 hours. A temperature raising rate can be higher than or equal to 150° C./h and lower than or equal to 250° C./h. The temperature is decreased by either forcible cooling or natural cooling as long as the temperature of the mixture is cooled to room temperature (e.g., 25° C.), for example.

As long as there is no problem considering the following Step S42 and subsequent steps, the process can go to Step S42 even when the temperature is higher than room temperature in Step S14. That is, the cooling to room temperature is not essential in Step S14.

In the first heating, a container containing the mixture of Step S12 is preferably covered with a lid. By covering the container with a lid, the reaction atmosphere can be controlled. Furthermore, the container may be covered with a lid while the reaction atmosphere in a heat treatment furnace is controlled. Methods for controlling the reaction atmosphere in the heat treatment furnace include purging for preventing entry and exit of a gas of the reaction atmosphere into/from the heat treatment furnace and flowing for allowing entry and exit of a gas of the reaction atmosphere into/from the heat treatment furnace. Examples of the heat treatment furnace include a muffle furnace.

### <Step S15>

Step S15 in FIG. 10A includes a step of collecting the material obtained by the above first heating to obtain a lithium composite oxide containing the transition metal M(LiMO₂). In this manner, LiMO₂ can be prepared. Note that the median diameter (D50) of LiMO₂ is preferably greater than or equal to 1 μm and less than or equal to 100 μm, further preferably greater than or equal to 1 μm and less than or equal to 50 μm, still further preferably greater than or equal to 1 μm and less than or equal to 15 μm.

Although the above description is made using the median diameter (D50), a particle diameter obtained by measuring a cross-sectional diameter may be used.

Alternatively, in Step S15, LiMO₂ synthesized in advance may be used. In that case, Step S11 to Step S14 can be omitted.

In the case where M in LiMO₂ synthesized in advance is cobalt, lithium cobalt oxide manufactured by NIPPON CHEMICAL INDUSTRIAL CO., LTD. can be used.

### <Step S21>

Step S21 includes a step of preparing an additive element source (X source) for the lithium composite oxide (LiMO₂). As the additive element X, one or more selected from nickel, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In this embodiment, a fluorine source and a magnesium source are used as X sources. At the same time as the X sources, a lithium source may be prepared.

Addition of the additive element X may be divided into two or more steps. In the case of dividing addition into two or more steps, an additive element X1, an additive element X2, and the like may be distinguished from each other with the use of ordinal numbers and their starting materials may be distinguished from each other with the use of the same ordinal numbers like an X1 source, an X2 source, and the like.

The fluorine source may be a chlorine source or the like, and a halogen source containing a fluorine source and a chlorine source may be used. In addition, a lithium source may be prepared. The fluorine source, the magnesium source, and the like are starting materials.

As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃) sodium aluminum hexafluoride (Na₃AlF₆), or the like can be used. The fluorine source is not limited to a solid, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. A plurality of fluorine sources may be mixed to be used. Among them, lithium fluoride, which has a relatively low melting point of 848° C., is preferable because it is easily melted in a heating step described later. Note that a fluorine source containing Li can also be referred to as a Li source.

As the chlorine source, for example, lithium chloride or magnesium chloride can be used.

As the magnesium source, for example, magnesium fluoride, magnesium oxide, magnesium hydroxide, or magnesium carbonate can be used.

As the lithium source, for example, lithium fluoride or lithium carbonate can be used. That is, lithium fluoride can be used as both the lithium source and the fluorine source. In addition, magnesium fluoride can be used as both the fluorine source and the magnesium source.

The case is considered where lithium fluoride LiF is prepared as the fluorine source, and magnesium fluoride MgF₂ is prepared as the fluorine source and the magnesium source. When lithium fluoride LiF and magnesium fluoride MgF₂ are mixed at approximately LiF:MgF₂=65:35 (molar ratio), the effect of lowering the melting point of the mixture in which the fluorine source and magnesium are mixed becomes the highest. On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=0.33 and the neighborhood thereof). Note that in this specification and the like, the neighborhood means a value greater than 0.9 times and smaller than 1.1 times a certain value.

In the case where LiMO₂ is lithium cobalt oxide, magnesium is more likely to be replaced in a lithium site than in a cobalt site in consideration of an ionic radius. In addition, the lithium cobalt oxide and the magnesium oxide are more stable in a separated state than in a state of forming a solid solution, and do not positively form a solid solution. However, by performing appropriate heating in Step S44 or the like, the magnesium oxide can form a solid solution with the lithium cobalt oxide in a surface portion, a projection, a grain boundary, or a defect portion such as a crack or a void of the lithium cobalt oxide. When lithium is extracted from the lithium cobalt oxide due to charging and discharging, the interlayer distance between CoO₂ layers is reduced or the CoO₂ layers are shifted in some cases; however, when magnesium is replaced in the lithium site, the interlayer distance between the CoO₂ layers can be maintained even in the case where lithium is extracted, which can suppress a change in the crystal structure. Since the crystal structure is broken from the surface portion, the projection, the grain boundary, or the defect portion such as the crack or the void of the lithium cobalt oxide, magnesium is preferably unevenly distributed in the surface portion or the projection. Such lithium cobalt oxide is a positive electrode active material whose crystal structure is unlikely to be broken even when charging and discharging are repeated at high voltage.

In the case where LiMO₂ is lithium cobalt oxide, fluorine can function as a flux for melting magnesium. In addition, fluorine might be replaced in the oxygen position of the lithium cobalt oxide. Thus, fluorine may exist in the entire lithium cobalt oxide. The lithium cobalt oxide containing such fluorine has low Li extraction energy and Li is inserted and extracted smoothly. In addition, HF resistance can also be expected.

### <Step S22>

Step S22 in FIG. 10B includes a step of mixing the above-described starting materials. The mixing can be performed by one or two or more selected from a dry method and a wet method. Depending on the mixing conditions, the mixture may be ground.

Note that in Step S22, a wet method that enables mixing with a strong force is suitable. During the mixing step by a wet method, the mixture is ground in many cases.

When the mixing step is performed by a wet method, a solvent is prepared. As the solvent, the solvent described in Step S12 can be used.

As an equipment for the mixing, one or two or more selected from a ball mill, a bead mill, and the like can be used. When a ball mill is used, zirconia balls are preferably used as an equipment for grinding. The rotation speed in Step S22 is preferably higher than or equal to 300 rpm and lower than or equal to 500 rpm.

This step may only include the mixing but preferably includes grinding for pulverizing the starting material with the above-described equipment or the like in order to obtain a pulverized mixture.

Furthermore, the mixture may be made to pass through a sieve. The entire mixture is preferably uniform with a median diameter (D50) of greater than or equal to 0.01 μm and less than or equal to 10 μm, further preferably greater than or equal to 0.1 μm and less than or equal to 1 μm.

Although the above description is made using the median diameter (D50), a particle diameter obtained by measuring a cross-sectional diameter may be used.

### <Step S23>

Step S23 in FIG. 10B includes a step of collecting the materials subjected to the mixing or the like as described above to obtain a mixture 902.

The mixture 902 preferably has the median diameter (D50) described above. When mixed with LiMO₂ of Step S15, the mixture 902 having such a median diameter is easily attached to the surface of LiMO₂ uniformly. When the mixture 902 is attached to the surface of LiMO₂ of Step S15 uniformly, the mixture 902 is easily distributed to the surface portion of LiMO₂ after heating in Step S44 or the like.

Although the above description is made using the median diameter (D50), a particle diameter obtained by measuring a cross-sectional diameter may be used.

### <Step S42>

Step S42 in FIG. 10B includes a step of mixing LiMO₂ of Step S15 and the mixture 902. The mixing can be performed by one or two or more selected from a dry method and a wet method. A dry method is less likely to break a particle than a wet method and thus is suitable in Step S42.

When the grinding and mixing step is performed by a wet method, a solvent is prepared. As the solvent, the solvent described in Step S12 can be used.

This step may include only the mixing but may include grinding with a ball mill, a bead mill, or the like in order to pulverize a mixture. When a ball mill is used, zirconia balls are preferably used, for example.

This step may include only the mixing but preferably includes grinding for pulverizing the starting material with the above-described equipment or the like in order to obtain a lithium composite oxide with a small particle diameter.

Furthermore, the mixture may be made to pass through a sieve. The entire mixture is preferably uniform with a median diameter (D50) of greater than or equal to 10 μm and less than or equal to 15 μm.

Although the above description is made using the median diameter (D50), a particle diameter obtained by measuring a cross-sectional diameter may be used.

The condition of the mixing in Step S42 is preferably milder than the condition of the mixing in one or more selected from Step S12 and Step S22 not to damage the particles of LiMO₂. For example, a condition with a lower rotation frequency or shorter time is a mild condition. The rotation speed in Step S42 is preferably higher than or equal to 100 rpm and lower than or equal to 300 rpm.

In Step S42, the atomic ratio of the transition metal M in LiMO₂ to magnesium Mg contained in the mixture 902 is preferably M:Mg=100:y (0.1≤y≤6), further preferably M:Mg=100:y (0.3≤y≤3).

In the mixing in Step S42, aluminum and/or nickel may be further mixed. An aluminum source and a nickel source are sometimes referred to as an X2 source.

The case where the lithium composite oxide is lithium cobalt oxide is considered. Al of the X2 source is trivalent, has a high bonding strength with oxygen, and suppresses release of oxygen, and furthermore, lithium around Al hardly moves in charging and discharging. Thus, entry of Al into a cobalt site can suppress a change in the crystal structure. When Al enters a cobalt site in a surface portion, the vicinity of Al functions like a column, which suppresses a change in the crystal structure. The positive electrode active material can have the crystal structure that is unlikely to be broken even when charging and discharging are repeated at high voltage.

The case where the lithium composite oxide is lithium cobalt oxide is considered. Ni of the X2 source can be replaced in both a cobalt site and a lithium site. In the case where Ni is replaced in a cobalt site, oxidation-reduction potential is lowered, leading to an increase in capacity. In the case where Ni is replaced in a lithium site, a change in the crystal structure can be suppressed because variation in a lattice constant is reduced, for example. The positive electrode active material can have the crystal structure that is unlikely to be broken even when charging and discharging are repeated at high voltage.

Al and Ni preferably exist in the surface portion of the positive electrode active material. It is further preferable that Ni and Mg exist at similar positions and Al exist on the inner side than Al. In consideration of preferable positions of Al and Ni, at least Al is preferably added in a separate step from Mg.

As the Ni source, one or two or more selected from nickel oxide, nickel hydroxide, an alkoxide of nickel, and the like can be used.

As the Al source, one or two or more selected from aluminum oxide, aluminum hydroxide, an alkoxide of aluminum, and the like can be used.

### <Step S43>

Step S43 in FIG. 10A includes a step of collecting the materials mixed in above to obtain a mixture 903.

Note that as the procedure for obtaining the mixture 903, the procedure for adding the mixture 902 of LiF and MgF₂ to LiMO₂ is described; however, the procedure is not limited thereto. The mixture 903 can be obtained by adding a Mg source, a F source, and the like to the Li source and the M source in Step S11. Alternatively, the mixing in Step S42 may be performed with a Mg source and a F source added to LiMO₂ of Step S14 without performing the mixing or the like in Step S22. In these cases, some steps can be omitted, leading to simplicity and high productivity.

Alternatively, lithium cobalt oxide to which magnesium and fluorine are added in advance may be used as the mixture 903. When lithium cobalt oxide to which magnesium and fluorine are added is used, the process can be simpler because steps up to Step S42 can be omitted.

In accordance with Step S21 or the like, a magnesium source and a fluorine source may be further added to the lithium cobalt oxide to which magnesium and fluorine are added in advance to obtain the mixture 903.

As described above, a variety of methods for obtaining the mixture 903 can be considered.

### <Step S44>

Step S44 in FIG. 10A includes a step of heating the mixture 903 obtained in Step S43. With the use of an ordinal number, this step is sometimes referred to as second heating to distinguish this step from the first heating. Alternatively, this step is sometimes referred to as annealing. The second heating is performed with a sequential heating apparatus or a batch-type heating apparatus, for example.

In Step S44, a crucible can be used, but a flat and stable container (also simply referred to as a container) called a sagger or a setter, which has a larger capacity than the crucible, is preferably used taking into account large-scale synthesis. Large-scale synthesis is preferable because various conditions can be easily set for the additive elements of the mixture 903 and the like. Note that the container is preferably made from one or two or more materials selected from alumina, mullite, magnesia, and zirconia.

The atmosphere of the second heating is preferably an oxygen-containing atmosphere or so-called dry air. The dry air is a gas that remains after water vapor is removed from the air. Specifically, the dry air refers to compressed air whose dew point is lower than −10° C. That is, the atmosphere of the second heating is preferably an oxygen-containing atmosphere with little moisture (the dew point is lower than or equal to −50° C., preferably lower than or equal to −80° C., for example).

The atmosphere of the second heat treatment is controlled by a method called purging for preventing entry and exit of a gas of the reaction atmosphere into/from the heat treatment furnace and a method called flowing for allowing entry and exit of a gas of the reaction atmosphere into/from the heat treatment furnace.

During the second heating, a compound lighter than oxygen, e.g., LiF, might be volatilized or sublimated by the heating. In that case, one or two or more atomic concentrations selected from the Li concentration and the F concentration in the mixture 903 might decrease. Thus, at the time of heating the mixture 903, at least the fluorine concentration or the partial pressure of a fluoride in the atmosphere in the container is preferably controlled to be within an appropriate range. An exemplary method for preventing volatilization or sublimation of LiF is covering the container or the like containing the mixture 903 with a lid.

The second heating further preferably has the adhesion preventing effect to prevent particles of the mixture 903 from adhering to one another. Examples of the heating having the adhesion preventing effect are heating while the mixture 903 is being stirred and heating while a container containing the mixture 903 is being vibrated.

The temperature range of the second heating needs to be greater than the temperature at which a reaction between LiMO₂ and the mixture 902 proceeds. The temperature at which the reaction proceeds is the temperature at which interdiffusion between elements included in LiMO₂ and the mixture 902 occurs. Thus, the temperature of the second heating is, for example, higher than or equal to 500° C. and lower than or equal to 950° C.

It is considered that the lower limit of the temperature of the second heating is preferably a temperature higher than or equal to the temperature at which at least part of the mixture 903 is melted because the reaction proceeds more easily. Accordingly, the temperature of the second heating is preferably higher than or equal to the eutectic point of additive elements included in the mixture 902. In the case where the mixture 902 includes LiF and MgF₂ as additive elements, the eutectic point of LiF and MgF₂ is around 742° C., and the temperature of the second heating is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Therefore, it is considered that the lower limit of the temperature of the second heating is further preferably higher than or equal to 830° C.

A higher heating temperature facilitates the reaction and thereby shortens the heating time. The heating time is preferably shorter to increase the productivity.

The upper limit of the temperature of the second heating needs to be lower than or equal to a decomposition temperature of LiMO₂ (1130° C. in the case of LiCoO₂). At around the decomposition temperature, a slight amount of LiMO₂ might be decomposed. Thus, the upper limit of the temperature of the second heating is preferably lower than or equal to 1130° C., further preferably lower than or equal to 1000° C., still further preferably lower than or equal to 950° C., yet still further preferably lower than or equal to 900° C. The temperature of the second heating is preferably a temperature at which LiMO₂ of Step S14 is not broken, and the temperature of the second heating is lower than the temperature of the first heating.

In view of the above, the temperature range of the second heating is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the temperature range is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the temperature range is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the above-described manufacturing method, LiF as the fluorine source functions as flux, for example. Owing to this function, the temperature of the second heating can be lower than or equal to the decomposition temperature of LiMO₂, e.g., a temperature higher than or equal to 742° C. and lower than or equal to 950° C., which allows distribution of one or two or more of additive elements selected from magnesium, fluorine, and the like in the vicinity of the surface and formation of the positive electrode active material having favorable performance.

The second heating is preferably performed for an appropriate time. The appropriate time of the second heating is changed depending on conditions, such as the temperature of the second heating and the particle size and composition of LiMO₂ of Step S14. In the case where the particle is small, the second heating is preferably performed at a lower temperature or for a shorter time than the case where the particle is large, in some cases.

When the median diameter (D50) of the particles in Step S14 is 12 μm, for example, the temperature of the second heating is preferably higher than or equal to 600° C. and lower than or equal to 950° C., for example. The time of the second heating is preferably longer than or equal to 3 hours, further preferably longer than or equal to 10 hours, still further preferably longer than or equal to 60 hours, for example.

On the other hand, when the median diameter (D50) of the particles in Step S14 is 5 μm, the temperature of the second heating is preferably higher than or equal to 600° C. and lower than or equal to 950° C., for example. The time of the second heating is preferably longer than or equal to 1 hour and shorter than or equal to 10 hours, further preferably approximately 2 hours, for example.

Although the above description is made using the median diameter (D50), a particle diameter obtained by measuring a cross-sectional diameter may be used.

The temperature decreasing time after the second heating is, for example, preferably longer than or equal to 10 hours and shorter than or equal to 50 hours.

As the second heating, heating with a rotary kiln can be performed. Heating with a rotary kiln can be performed while stirring is performed in either case of a sequential rotary kiln or a batch-type rotary kiln, and thus is preferable as the heating having the adhesion preventing effect. In particular, a sequential rotary kiln is preferable because of its high productivity. A batch-type rotary kiln is preferable because atmosphere control is easy.

As the second heating, heating with a roller hearth kiln can be performed. During the heating with a roller hearth kiln, it is preferable that the container containing the mixture 903 or the like be vibrated. A roller hearth kiln is preferable because it is a sequential rotary kiln and has high productivity.

After the second heating, the additive element X may be unevenly distributed in the surface portion of the positive electrode active material. That is, the additive element X can be located in the surface portion of the positive electrode active material.

After the second heating, the additive element X may be unevenly distributed in the projection of the positive electrode active material. That is, the additive element X can be located in the projection of the positive electrode active material.

Among the additive elements X, aluminum may be unevenly distributed at the boundary between the projection and the surface portion.

Among the additive elements X, fluorine is not distributed unevenly but exists in the entire positive electrode active material in some cases.

### <Step S51>

Step S51 in FIG. 10B includes a step of preparing an additive element source (Y source). In this embodiment, the Y source is a Group 4 element or a Group 5 element, specifically, one or two or more selected from Hf, V, and Nb. Alternatively, the additive element may be a lanthanoid element, specifically, one or two or more selected from Ce and Sm. Note that Zr may be added at the same time as one or two or more selected from Hf, V, and Nb.

The X source may be added in Step S51.

As the Y source, a metal alkoxide is preferably used. For example, a metal alkoxide containing Hf, V, Nb, Ce, or Sm is prepared. In the case of adding Zr, a metal alkoxide containing Zr is also prepared. In this case, an X source that can be prepared as a metal alkoxide is preferably added at the same time. For example, a starting material such as aluminum, nickel, and/or the like can be prepared as a metal alkoxide.

### <Steps S52 and S53>

Step S52 in FIG. 10B includes a mixing step of dissolving the metal alkoxide in alcohol and a mixed solution 904 is obtained in Step S53.

The necessary amount of metal alkoxide depends on the particle diameter of the mixture 903. For example, when triisopropoxy cerium(III) is used and the particle diameter (D50) of the lithium cobalt oxide is approximately 20 μm, triisopropoxy cerium(III) is preferably added so that the concentration of Ce in triisopropoxy cerium(III) is 0.001 times or more and 0.02 times or less as high as that of cobalt with the number of cobalt atoms in the lithium cobalt oxide regarded as 1.

### <Step S62>

Step S62 in FIG. 10B includes a mixing step of stirring, in an atmosphere containing water vapor, a mixed solution containing the mixed solution 904 and particles of the mixture 903 subjected to the second heating. Note that the second heating can also serve as third heating shown in the subsequent Step S63.

The stirring can be performed with a magnetic stirrer, for example. The stirring time is not limited as long as water and a metal alkoxide in the atmosphere cause hydrolysis and polycondensation reaction. For example, the stirring can be performed at 25° C. and a humidity of 90% RH (Relative Humidity) for 4 hours. Alternatively, the stirring may be performed in an atmosphere where the humidity and temperature are not adjusted, for example, an air atmosphere in a fume hood. In such a case, the stirring time is preferably set longer and is 12 hours or longer at room temperature, for example.

Water vapor in the atmosphere is gradually taken and the alcohol is gradually volatized to cause a reaction between water and a metal alkoxide, which enables a sol-gel reaction to proceed gently. Alternatively, a reaction between a metal alkoxide and water at room temperature enables a sol-gel reaction to proceed more gently as compared with the case where heating is performed at a temperature higher than the boiling point of the alcohol serving as a solvent, for example.

Water may be added positively. In the case where the reaction is desired to proceed gently, the reaction time may be controlled by gradual addition of water diluted with the alcohol, a reduction of the amount of the alcohol, addition of stabilizer, or the like.

The sol-gel reaction is preferably made to proceed gently, in which case a covering film containing at least the additive element Y is easily formed. Note that the covering film obtained is not necessarily uniform and is sometimes scattered.

### <Step S63>

Step S63 in FIG. 10B includes a step of obtaining a mixture 905. First, precipitate is collected from the mixed solution after the process in Step S62. As the collection method, filtration, centrifugation, evaporation to dryness, and the like can be used. The precipitate can be washed with alcohol that is the same as the solvent in which a metal alkoxide is dissolved. Note that in the case of employing evaporation to dryness, the solvent and the precipitate are not necessarily separated in this step; for example, the precipitate is collected in a drying step.

A collected residue is dried, whereby the mixture 905 can be obtained. In the drying step, vacuum or ventilation drying can be performed at 80° C. for longer than or equal to 1 hour and shorter than or equal to 4 hours, for example.

Note that the mixture 903 may be covered with a covering film containing the additive element Y that is deposited by a sputtering method or an evaporation method instead of the sol-gel method.

### <Step S64>

Step S64 in FIG. 10B includes a step of heating the obtained mixture. Step S63 is heating subsequent to Step S44 and is referred to as third heating with the use of an ordinal number. For the third heating, the conditions described for the first heating or the second heating can be used.

In the case of suppressing diffusion of the Y source into the inner portion of the positive electrode active material, the third heating is preferably performed in a shorter time than the second heating. Furthermore, the third heating is preferably performed at a lower temperature than the second heating.

After the third heating, the additive element X may be unevenly distributed in the surface portion of the positive electrode active material. That is, the additive element X can be located in the surface portion of the positive electrode active material.

After the third heating, the additive element X may be unevenly distributed in the projection of the positive electrode active material. That is, the additive element X can be located in the projection of the positive electrode active material.

Among the additive elements X, aluminum may be unevenly distributed at the boundary between the projection and the surface portion.

Among the additive elements X, fluorine is not distributed unevenly but exists in the entire positive electrode active material in some cases.

After the third heating, the additive element Y may be unevenly distributed in the surface portion of the positive electrode active material. That is, the additive element Y can be located in the surface portion of the positive electrode active material.

After the third heating, the additive element Y may be unevenly distributed in the projection of the positive electrode active material. That is, the additive element Y can be located in the projection of the positive electrode active material.

### <Step S66>

Step S66 in FIG. 10B includes a step of collecting particles. Then, the particles are preferably made to pass through a sieve. In such a manner, the positive electrode active material 100 of one embodiment of the present invention can be formed.

Although the heating steps are described above as the first heating to the third heating, the number may be N (N>3). The condition (temperature or time) is preferably varied between the heating steps. In one or two or more selected from the first heating to the third heating, a step including heating and cooling may be performed M (M>2) times. The step including heating and cooling may include a step of collecting a mixture.

Note that in the lithium composite oxide, the contained element such as the transition metal M and/or the additive element is unevenly distributed in the projection and/or the surface portion. Moreover, the transition metal M, the additive element, and/or the like have a concentration gradient. For example, at the boundary between the projection and/or the surface portion and the inner portion, the transition metal M and/or the additive element have a concentration gradient.

The positive electrode active material of the present invention has an O3′ type crystal structure in some cases, and the crystal structure is unlikely to be broken even when charging and discharging are repeated at high voltage. The O3′ type crystal structure is formed when magnesium exists between the CoO₂ layers, i.e., in lithium sites in lithium cobalt oxide, for example. When magnesium exists between the CoO₂ layers, a stable crystal structure is likely to be formed. To make magnesium exist between the CoO₂ layers, it is preferable that a Mg source and the like be prepared not in Step S11 but in Step S21, the mixture 902 be formed in Step S23, the mixture 902 be mixed with LiMO₂ of Step S14, and the heating in Step S44 or Step S64 be performed.

Cation mixing occurs when the heat treatment temperature in Step S44 and/or Step S64 is excessively high, so that magnesium is highly likely to enter the cobalt sites. Magnesium existing in the cobalt sites does not have an effect of maintaining the crystal structure in charging and discharging at high voltage. Furthermore, when the heat treatment temperature is excessively high, adverse effects such as reduction of cobalt to have divalence and transpiration or sublimation of lithium are concerned, for example. Thus, at least the second heating in Step S44 and the third heating in Step S64 are performed under the conditions described above.

This embodiment can be implemented in appropriate combination with any of the other embodiments.

### Embodiment 4

This embodiment will describe examples of shapes of several types of secondary batteries including a positive electrode or a negative electrode formed by the manufacturing method described in the foregoing embodiment.

### [Coin-Type Secondary Battery]

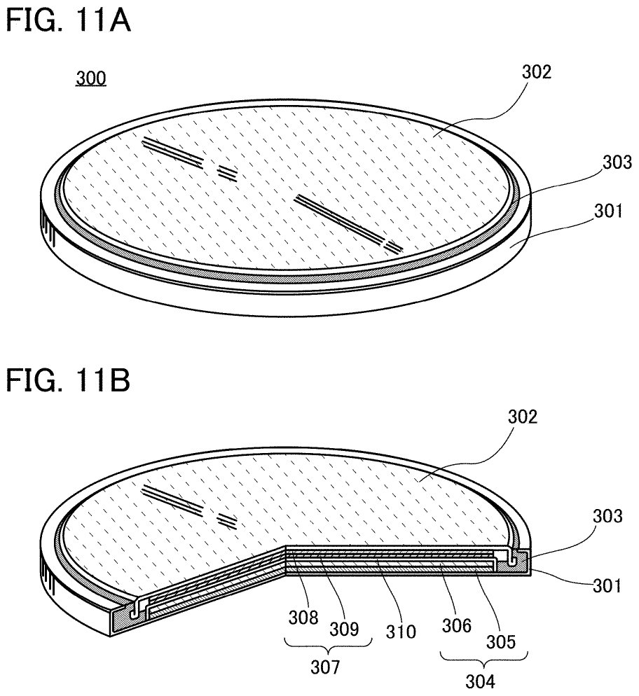

An example of a coin-type secondary battery is described. FIG. 11A is an external view of a coin-type (single-layer flat type) secondary battery, and FIG. 11B is a cross-sectional view thereof.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 11B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery using the positive electrode active material of one embodiment of the present invention for the positive electrode 304 can be the coin-type secondary battery 300 having high charge and discharge capacity and excellent cycle performance. Note that the separator 310 is not necessarily provided in the coin-type secondary.

### [Cylindrical Secondary Battery]

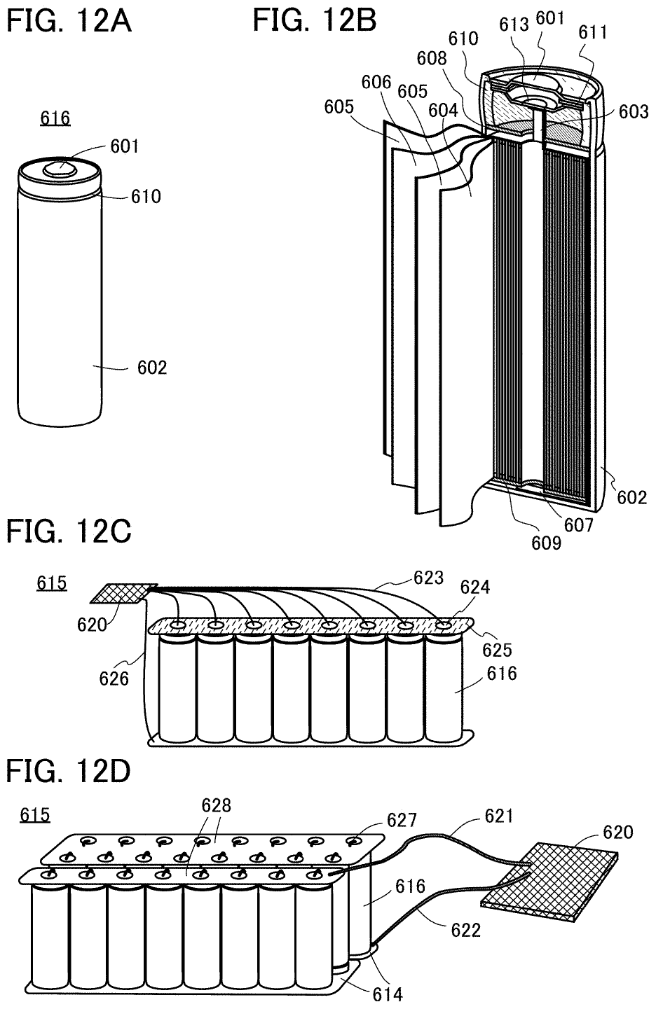

An example of a cylindrical secondary battery is described with reference to FIG. 12A. As illustrated in FIG. 12A, a cylindrical secondary battery 616 includes a positive electrode cap (battery cap) 601 on the top surface and a battery can (outer can) 602 on the side surface and bottom surface. The battery can (outer can) 602 is formed using a metal material and has an excellent barrier property against water permeation and an excellent gas barrier property. The positive electrode cap 601 and the battery can (outer can) 602 are insulated from each other by a gasket (insulating gasket) 610.

FIG. 12B schematically illustrates a cross section of a cylindrical secondary battery. The cylindrical secondary battery illustrated in FIG. 12B includes the positive electrode cap (battery cap) 601 on the top surface and the battery can (outer can) 602 on the side surface and the bottom surface. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other, for example. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The positive electrode active material of the present invention is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 12C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like and a protection circuit for preventing overcharging or overdischarging can be used.

FIG. 12D shows an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 12D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

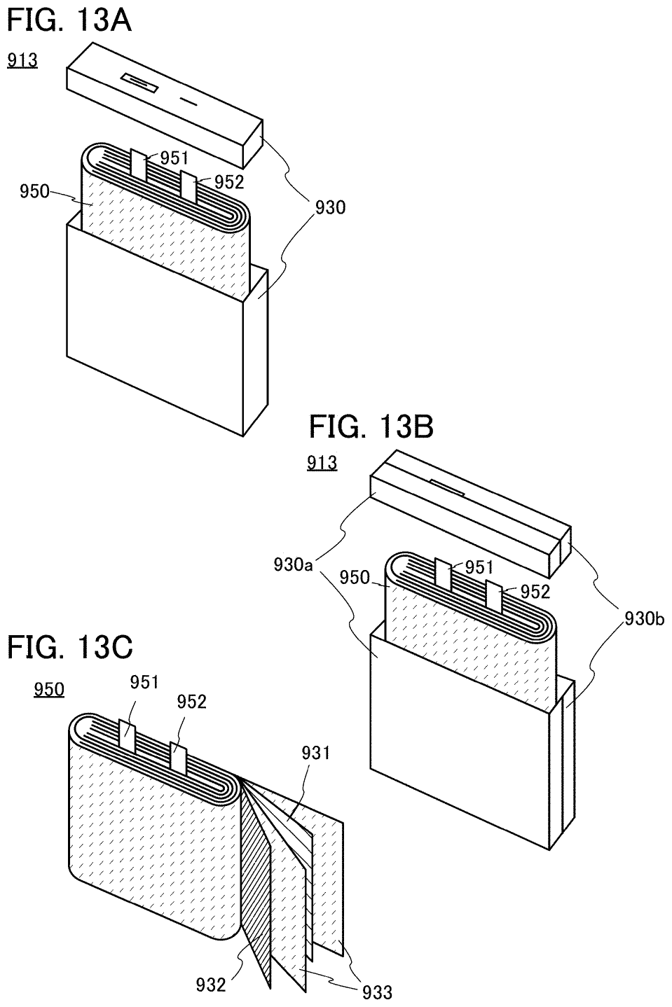

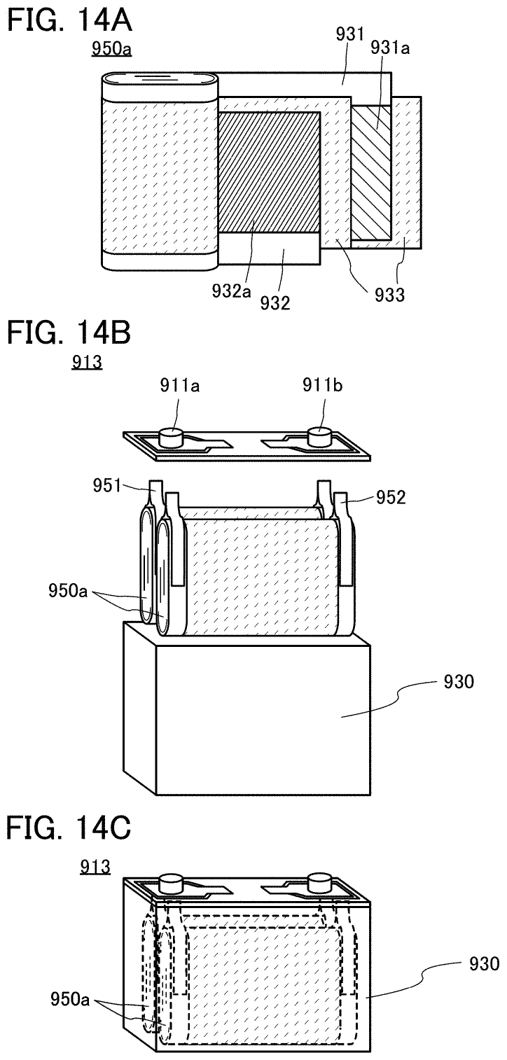

Structure examples of secondary batteries are described with reference to FIG. 13 and FIG. 14.

A secondary battery 913 illustrated in FIG. 13A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 13A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 13B, the housing 930 in FIG. 13A may be formed using a plurality of materials. For example, in the secondary battery 913 illustrated in FIG. 13B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 13C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 14, the secondary battery 913 may include a wound body 950a. The wound body 950a illustrated in FIG. 14A includes the negative electrode 931, the positive electrode 932, and the separators 933. The negative electrode 931 includes a negative electrode active material layer 931a. The positive electrode 932 includes a positive electrode active material layer 932a.

The positive electrode active material of the present invention is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 14A and FIG. 14B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 14C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 14B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 13A to FIG. 13C can be referred to for the other components of the secondary battery 913 illustrated in FIG. 14A and FIG. 14B.

### Embodiment 5

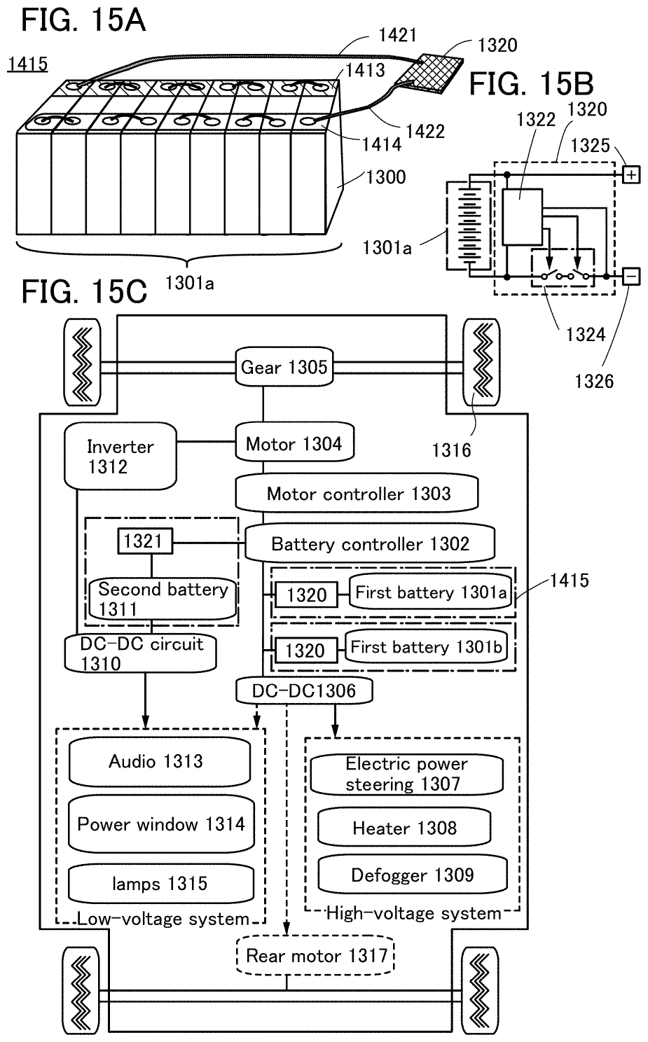

In this embodiment, an example in which the present invention is applied to an electric vehicle (EV) is described using FIG. 15.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be a wound structure or a stacked structure.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 15A.

FIG. 15A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, the rectangular secondary batteries 1300 may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 15B is an example of a block diagram of the battery pack 1415 illustrated in FIG. 15A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

As illustrated in FIG. 15C, the first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or an FIGPU.

Next, examples in which the secondary battery of one embodiment of the present invention is mounted on a vehicle, typically a transport vehicle, will be described.

Mounting the secondary battery of one embodiment of the present invention on vehicles can achieve next-generation clean energy vehicles such as hybrid vehicles (HVs), electric vehicles (EVs), and plug-in hybrid vehicles (PHVs). The secondary battery of one embodiment of the present invention can also be mounted on transport vehicles such as agricultural machines, motorized bicycles including motor-assisted bicycles, motorcycles, electric wheelchairs, electric carts, boats and ships, submarines, aircraft such as fixed-wing aircraft or rotary-wing aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

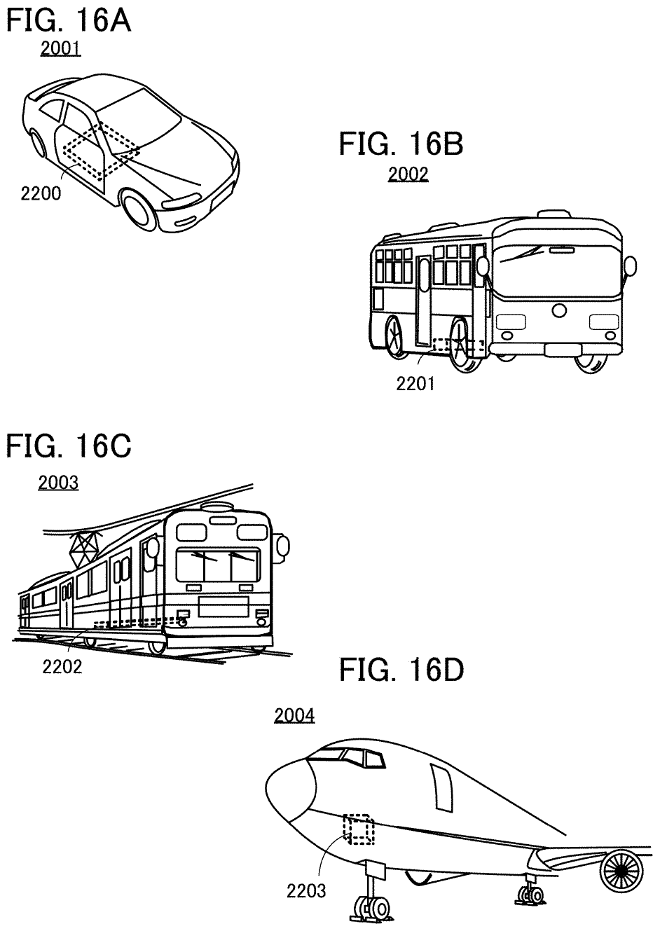

FIG. 16A to FIG. 16D show examples of transport vehicles each using the secondary battery of one embodiment of the present invention. An automobile 2001 illustrated in FIG. 16A is an electric vehicle that runs on an electric motor as a power source. Alternatively, the automobile 2001 is a hybrid electric vehicle that can appropriately select an electric motor or an engine as a driving power source. The automobile 2001 illustrated in FIG. 16A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charging equipment through a plug-in system, a contactless charging system, or the like. In charging, a given method such as CHAdeMO (registered trademark) or Combined Charging System may be employed as a charging method, the standard of a connector, or the like as appropriate. Charging equipment may be a charging station provided in a commerce facility or a household power supply. For example, a plug-in technique enables an exterior power supply to charge the secondary battery incorporated in the automobile 2001. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 16B shows a large transporter 2002 having a motor controlled by electric power, as an example of a transport vehicle. The secondary battery module of the transporter 2002 has a cell unit of four secondary batteries with a voltage of 3.5 V or higher and 4.7 V or lower, and 48 cells are connected in series to have 170 V as the maximum voltage, for example. A battery pack 2201 has a function similar to that in FIG. 16A except that the number of secondary batteries forming the secondary battery module of the battery pack 2201 or the like is different; thus the description is omitted.

FIG. 16C shows a large transport vehicle 2003 having a motor controlled by electricity as an example. The secondary battery module of the transport vehicle 2003 has more than 100 secondary batteries with a voltage of 3.5 V or higher and 4.7 V or lower connected in series, and the maximum voltage is 600 V, for example. Thus, the secondary batteries are required to have few variations in the characteristics. With use of a secondary battery using the positive electrode active material of the present invention for a positive electrode, a secondary battery having stable battery characteristics can be manufactured and its volume production at low costs is possible in light of the yield. A battery pack 2202 has a function similar to that in FIG. 16A except that the number of secondary batteries forming the secondary battery module of the battery pack 2202 or the like is different; thus the description is omitted.

FIG. 16D shows an aircraft 2004 having a combustion engine as an example. The aircraft 2004 shown in FIG. 16D can be regarded as a portion of a transport vehicle since it is provided with wheels for takeoff and landing. A battery pack 2203 including a secondary battery module, which includes a plurality of connected secondary batteries, and a charging control device are included.

The secondary battery module of the aircraft 2004 has eight 4 V secondary batteries connected in series, which has the maximum voltage of 32 V, for example. The battery pack 2203 has a function similar to that in FIG. 16A except, for example, the number of secondary batteries forming the secondary battery module of the battery pack 2203; thus the description is omitted.

This embodiment can be implemented in appropriate combination with any of the other embodiments.

### Embodiment 6

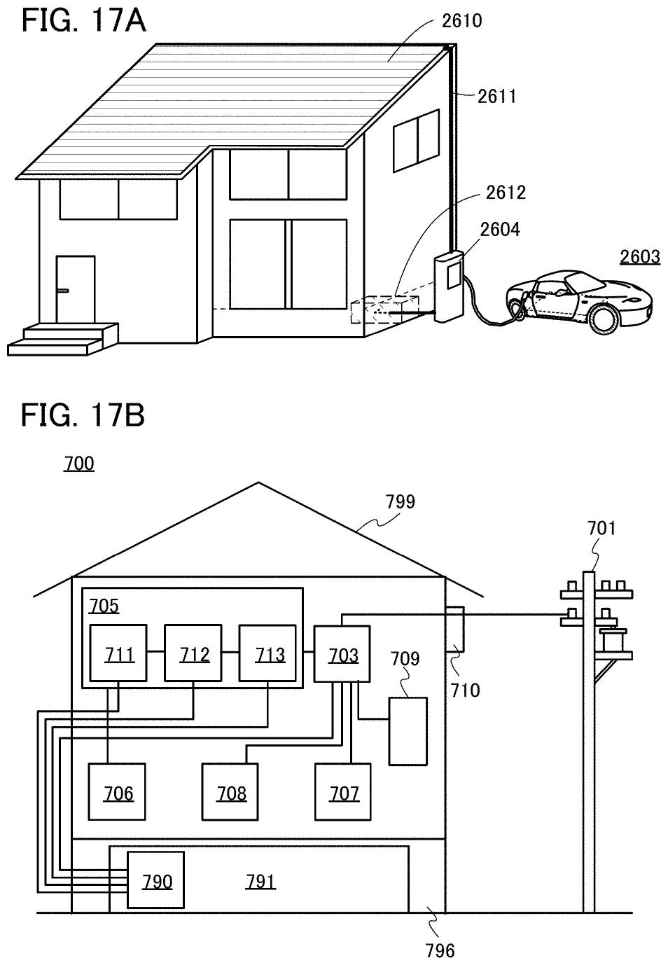

In this embodiment, examples in which the secondary battery of one embodiment of the present invention is mounted on a building will be described with reference to FIG. 17A and FIG. 17B.

A house illustrated in FIG. 17A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. The secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 17B shows an example of a power storage device of one embodiment of the present invention. As illustrated in FIG. 17B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

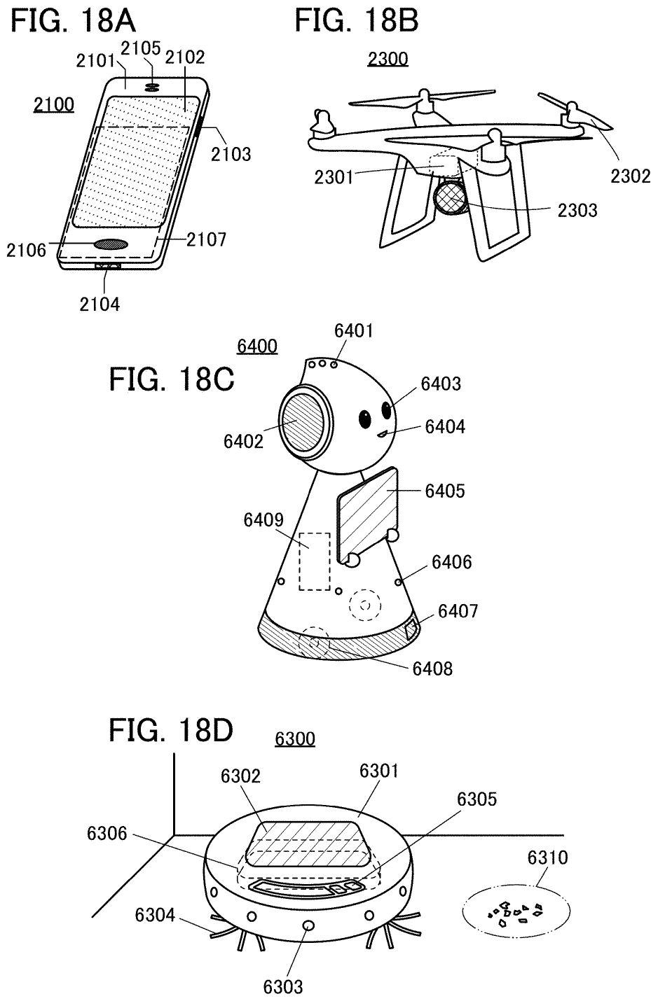

FIG. 18A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 using the positive electrode active material of the present invention for a positive electrode achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 18B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery using the positive electrode active material of the present invention for a positive electrode has high energy density and a high degree of safety, and thus can be used safely for a long time over a long period of time and is preferable as the secondary battery included in the unmanned aircraft 2300.

FIG. 18C shows an example of a robot. A robot 6400 illustrated in FIG. 18C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component. A secondary battery using the positive electrode active material of the present invention for a positive electrode has high energy density and a high degree of safety, and thus can be used safely for a long time over a long period of time and is preferable as the secondary battery 6409 included in the robot 6400.

FIG. 18D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery using the positive electrode active material of the present invention for a positive electrode has high energy density and a high degree of safety, and thus can be used safely for a long time over a long period of time and is preferable as the secondary battery 6306 included in the cleaning robot 6300.

This embodiment can be implemented in appropriate combination with the other embodiments.

### Example 1

In this example, Sample 1 was fabricated by adding a Hf source, Sample 2 was fabricated by adding a V source, Sample 3 was fabricated by adding a Nb source, and Samples 4a to 4c were fabricated by adding a Hf source and a Zr source at different addition amounts; each source was added as a Y source, which is an additive element source for lithium cobalt oxide. Furthermore, a Mg source and a F source are added to each sample as an X source 1, and each sample includes a Ni source and an Al source as an X2 source. The following table lists the conditions of the samples.

TABLE 1

| | Material of | Additive | Additive | Additive | |
|---|---|---|---|---|---|
| | positive | element | element | element | |
| Sample | electrode | source | source | source | |
| name | active material | (X1 source) | (X2 source) | (Y source) | Notes |
| Sample 1 | LCO | Mg source, | Ni source, | Hf source | |
| | | F source | Al source | | |
| Sample 2 | LCO | Mg source, | Ni source, | V source | |
| | | F source | Al source | | |
| Sample 3 | LCO | Mg source, | Ni source, | Nb source | |
| | | F source | Al source | | |
| Sample 4a | LCO | Mg source, | Ni source, | Zr source, | Zr source at 0.25 mol % and |
| | | F source | Al source | Hf source | Hf source at 0.25 mol % |
| | | | | | with respect to LCO |
| Sample 4b | LCO | Mg source, | Ni source, | Zr source, | Zr source at 0.05 mol % and |
| | | F source | Al source | Hf source | Hf source at 0.05 mol % |
| | | | | | with respect to LCO |
| Sample 4c | LCO | Mg source, | Ni source, | Zr source, | Zr source at 0.25 mol % and |
| | | F source | Al source | Hf source | Hf source at 0.05 mol % |
| | | | | | with respect to LCO |

Fabrication process of each sample will be described below.

### <Sample 1>

The fabrication process of Sample 1 is described with reference to the process flow in FIG. 10B. For Sample 1, lithium cobalt oxide (product name: CELLSEED C-10N) manufactured by NIPPON CHEMICAL INDUSTRIAL CO., LTD. was used as a lithium composite oxide and was used as lithium cobalt oxide of Step S15. CELLSEED C-10N is lithium cobalt oxide in which the median diameter (D50) is greater than or equal to 10 μm and less than or equal to 15 μm, and in the elementary analysis by GD-MS, the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

As lithium cobalt oxide of Step S15, a lithium cobalt oxide particle (product name: CELLSEED C-5H) manufactured by NIPPON CHEMICAL INDUSTRIAL CO., LTD. can also be used. CELLSEED C-5H is lithium cobalt oxide in which the median diameter (D50) is greater than or equal to 5 μm and less than or equal to 10 μm, and the concentrations of elements other than lithium, cobalt, and oxygen are approximately equal to or less than those of C-10N in the elementary analysis by GD-MS.

Since CELLSEED C-10N was used as described above, Step S11 to Step S14 in FIG. 10B were omitted.

Next, the step included in Step S21 in FIG. 10B was performed. Addition of the additive element X is divided into two steps, so that an X1 source was prepared first. For the X1 source for Sample 1, MgF₂ was prepared as a Mg source and LiF was prepared as a F source. Then, weighing was performed so that LiF was 0.33 mol % and MgF₂ was 0.1 mol % with respect to the lithium cobalt oxide.

Next, in accordance with the step included in Step S22 in FIG. 10B, LiF and MgF₂ were mixed by a wet method. The mixing was performed using super-dehydrated acetone as a solvent and a ball mill at a rotation speed of 400 rpm for 12 hours. Under those conditions, a mixture is ground during the mixing. After the mixing, the mixture was made to pass through a sieve with an aperture diameter of 300 μm, whereby the mixture 902 was obtained in Step S23.

Next, the X2 source was prepared. For the X2 source, a Ni source and an Al source were prepared. Ni(OH)₂ was prepared as the Ni source, Al(OH)₃ was prepared as the Al source, and weighing was performed so that Ni(OH)₂ and Al(OH)₃ were each 0.5 mol % with respect to the lithium cobalt oxide. Ni(OH)₂ and Al(OH)₃ were each ground using a ball mill at a rotation speed of 400 rpm for 12 hours and then made to pass through a sieve with an aperture diameter of 300 μm, whereby the X2 source was obtained.

In Step S42 in FIG. 10B, the X1 source and the X2 source were added to the lithium cobalt oxide of Step S14 and mixing was performed by a dry method at a rotation speed of 150 rpm for 1 hour. In Step S42, the rotation speed was lower than that in Step S22 and the rotation time was shorter than that in Step S22. Since the purpose of Step S42 is mixing, a dry method was employed unlike in Step S22. If the mixing in Step S42 is performed under the same conditions as those in Step S22, it is considered that the lithium cobalt oxide is pulverized and cycle performance deteriorates. Lastly, the mixture was made to pass through a sieve with an aperture diameter of 300 μm, whereby the mixture 903 was obtained.

In Step S44 in FIG. 10B, the mixture 903 was subjected to heating.

Step S44 is heating subsequent to Step S14 and is sometimes referred to as second heating with the use of an ordinal number, but Step S14 for Sample 1 is omitted.

In Step S44, the mixture 903 was put in a sagger made from alumina and a lid was put, the sagger was placed in a muffle furnace which is a heat treatment furnace, heating was performed at 850° C. for 60 hours, and then the mixture was made to pass through a sieve with an aperture diameter of 53 μm. The muffle furnace contained an oxygen atmosphere, into which oxygen was made to flow at a flow rate of 10 L/min. Flowing oxygen is called oxygen flow.

Next, a Hf source was prepared as the Y source of Step S51 in FIG. 10B. As the Hf source, hafnium ethoxide was prepared. Weighing was performed so that hafnium ethoxide was 0.25 mol % with respect to the lithium cobalt oxide. As alcohol, 2-propanol was also prepared. One Y source was used, so that Step S52 and Step S53 were omitted.

The mixture 903 subjected to the heating and the Y source were mixed to obtain a mixed solution, and mixing was performed in Step S62 in FIG. 10B at a rotation speed of 300 rpm at room temperature. In order to promote hydrolysis, a lid was not put on a bottle containing the mixed solution 904. A sol-gel reaction such as hydrolysis is preferable for forming a covering film containing Hf.

In Step S63 in FIG. 10B, precipitate was collected after the processing in Step S62, whereby the mixture 905 was obtained. After that, heating was performed in Step S64 and then the mixture was made to pass through a sieve with an aperture diameter of 53 μm. Step S64 is heating subsequent to Step S44 and is referred to as third heating in some cases. In Step S64, the mixture 905 was put in a sagger made from alumina and a lid was put, the sagger was placed in a muffle furnace, and heating was performed at 850° C. for 2 hours. The muffle furnace contained an oxygen atmosphere, and oxygen was made to flow into the furnace at a flow rate of 10 L/min. The heating time in Step S64 was shorter than the heating time in Step S44. In order to suppress diffusion of the Y source into the inner portion of the positive electrode active material, the heating temperature or the heating time as the heating condition in Step S64 is preferably lower/shorter than that in Step S44.

In such a manner, the positive electrode active material 100 was obtained as shown in Step S66 in FIG. 10B.

### <SEM Observation>

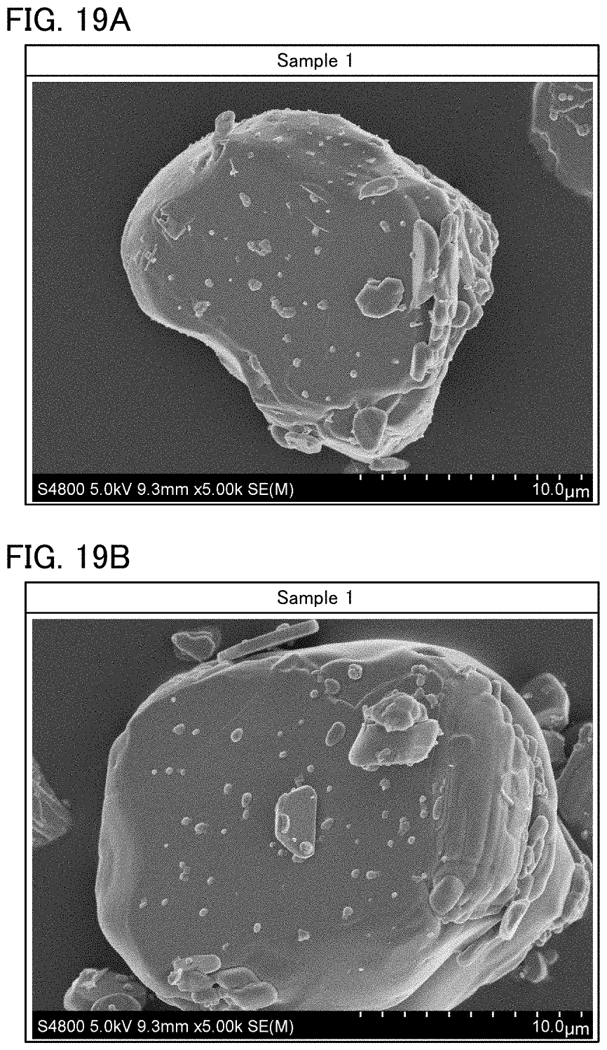

Sample 1 was subjected to SEM observation. For the SEM observation, S4800 which is a SEM manufactured by Hitachi High-Tech Corporation was used. The accelerating voltage was 5 kV. FIG. 19A and FIG. 19B show SEM images of the positive electrode active materials of Sample 1. Although the positive electrode active materials of Sample 1 were fabricated under the same conditions, an external shape of the lithium cobalt oxide is different between FIG. 19A and FIG. 19B. In both FIG. 19A and FIG. 19B, a projection is observed on a surface of the lithium cobalt oxide. Thus, Sample 1 is found to be lithium cobalt oxide having a projection on its surface.

In FIG. 19A and FIG. 19B, a plurality of projections are observed. As the plurality of projections, at least a first projection with a first size and a second projection with a size smaller than the first size can be observed, and the number of observed second projections is larger than that of observed first projections. In addition, as can be seen from FIG. 19A and FIG. 19B, no crack was observed in Sample 1.

The projection of Sample 1 contains at least Hf. In some cases, Hf is unevenly distributed in the projection due to the third heating in Step S64. As elements existing in the projection, one or two or more selected from Mg, F, Ni, and Al are considered besides Hf.

Sample 1 may contain magnesium at a lithium site and may have an O3′ type crystal structure in charging.

### <Sample 2>

Next, description is made on Sample 2 fabricated using a V source as the Y source in addition to a Mg source, a F source, a Ni source, and an Al source; each source was an additive element source for lithium cobalt oxide.

The fabrication process of Sample 2 is different from the fabrication process of Sample 1 in Step S44 and Step S51. Step S44 includes conditions relating to the second heating, which were 900° C. and 20 hours for Sample 2. Furthermore, for Sample 2, Ni(OH)₂ was added as the X2 source after Step S44. Furthermore, for Sample 2, aluminium isopropoxide was prepared as the Al source and weighing was performed so that aluminium isopropoxide was 0.5 mol % with respect to the lithium cobalt oxide. For Sample 2, triisopropoxy vanadium (V) oxide was prepared as the V source of Step S51 and weighing was performed so that triisopropoxy vanadium (V) oxide was 0.25 mol % with respect to the lithium cobalt oxide. For Sample 2, aluminium isopropoxide and triisopropoxy vanadium (V) oxide of Step S51 were mixed in accordance with Step S52, whereby the mixed solution 904 of Step S53 was obtained. The mixing of the metal alkoxides is preferably performed in accordance with Step S52. Then, the mixed solution 904 and the lithium cobalt oxide to which the Ni source was added were mixed.

The heating temperature or the heating time as the heating condition in Step S64 was lower/shorter than that in Step S44 in order to suppress diffusion of the Y source into the inner portion of the positive electrode active material.

In such a manner, the positive electrode active material 100 was obtained as shown in Step S66 in FIG. 10.

### <SEM Observation>

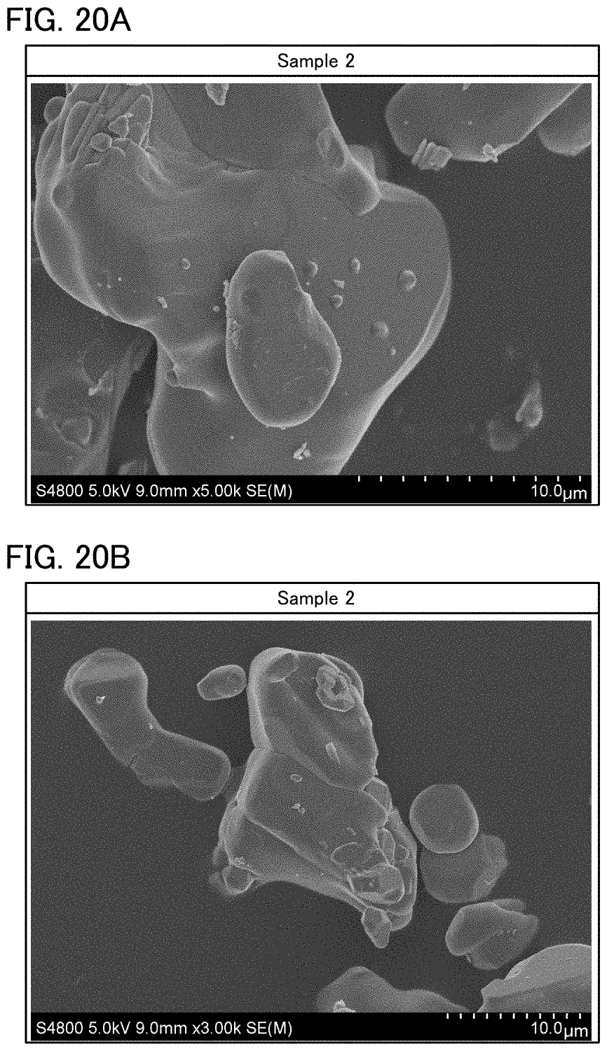

Sample 2 was subjected to SEM observation. For the SEM observation, S4800 which is a SEM manufactured by Hitachi High-Tech Corporation was used. The accelerating voltage was 5 kV. FIG. 20A and FIG. 20B show SEM images of the positive electrode active materials of Sample 2. Although the positive electrode active materials of Sample 2 were fabricated under the same conditions, an external shape of the lithium cobalt oxide is different between FIG. 20A and FIG. 20B. In FIG. 20A and FIG. 20B, a grain boundary was observed. In both FIG. 20A and FIG. 20B, a projection is observed on a surface of the lithium cobalt oxide. Thus, Sample 2 is found to be lithium cobalt oxide having a projection on its surface.

In FIG. 20A and FIG. 20B, a plurality of projections are observed. Comparison with FIG. 19A and FIG. 19B, which are the SEM images of the positive electrode active materials of Sample 1, revealed that Sample 2 had a smaller number of projections. In addition, as can be seen from FIG. 20A and FIG. 20B, no crack was observed in Sample 2.

The projection of Sample 2 contains at least V. In some cases, V is unevenly distributed in the projection due to the third heating in Step S64. As elements existing in the projection, one or two or more selected from Mg, F, Ni, and Al are considered besides V.

Sample 2 may contain magnesium at a lithium site and may have an O3′ type crystal structure in charging.

### <Sample 3>

The fabrication process of Sample 3 is different from the fabrication process of Sample 2 in Step S44 and Step S51. Step S44 includes conditions relating to the second heating, which were 850° C. and 60 hours. For Sample 3, pentaisobutoxy niobium was prepared as the Nb source of Step S51 and weighing was performed so that pentaisobutoxy niobium was 0.25 mol % with respect to the lithium cobalt oxide. Aluminium isopropoxide and pentaisobutoxy niobium were mixed in accordance with Step S52, whereby the mixed solution 904 of Step S53 was obtained.

The heating temperature or the heating time as the heating condition in Step S64 was lower/shorter than that in Step S44 in order to suppress diffusion of the Y source into the inner portion of the positive electrode active material.

In such a manner, the positive electrode active material 100 was obtained as shown in Step S66 in FIG. 10.

### <SEM Observation>

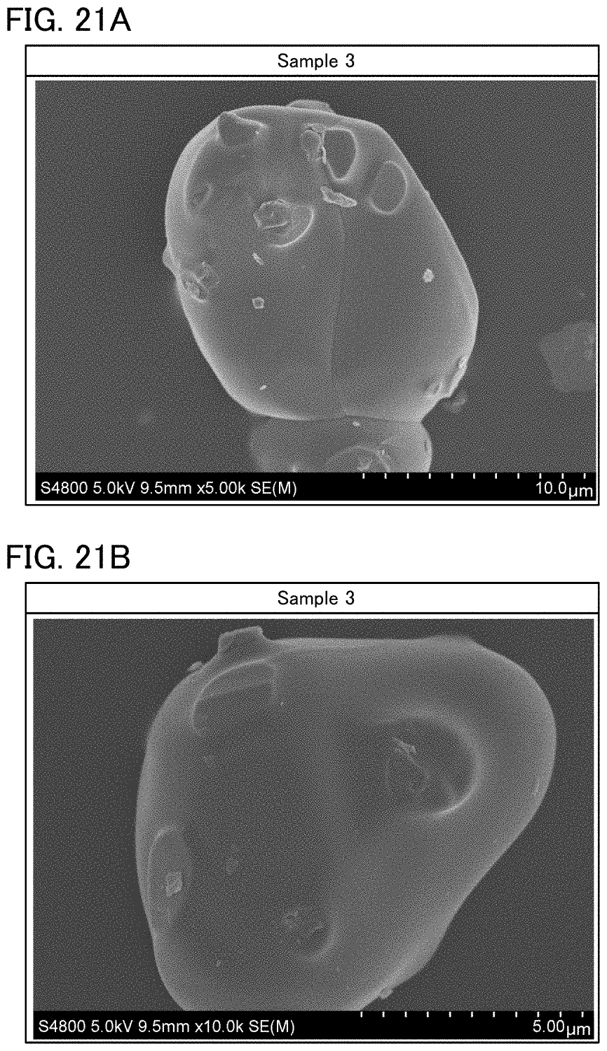

Sample 3 was subjected to SEM observation. For the SEM observation, S4800 which is a SEM manufactured by Hitachi High-Tech Corporation was used. The accelerating voltage was 5 kV. FIG. 21A and FIG. 21B show SEM images of the positive electrode active materials of Sample 3. Although the positive electrode active materials of Sample 3 were fabricated under the same conditions, an external shape of the lithium cobalt oxide is different between FIG. 21A and FIG. 21B. In FIG. 21A, a grain boundary was observed. In both FIG. 21A and FIG. 21B, a projection is observed on a surface of the lithium cobalt oxide. Thus, Sample 3 is found to be lithium cobalt oxide having a projection on its surface.

In FIG. 21A and FIG. 21B, a plurality of projections are observed. Comparison with FIG. 19A and FIG. 19B, which are the SEM images of the positive electrode active materials of Sample 1, revealed that Sample 3 had a smaller number of projections. In addition, as can be seen from FIG. 21A and FIG. 21B, no crack was observed in Sample 3.

The projection of Sample 3 contains at least Nb. In some cases, Nb is unevenly distributed in the projection due to the third heating in Step S64. As elements existing in the projection, one or two or more selected from Mg, F, Ni, and Al are considered besides Nb.

Sample 3 may contain magnesium at a lithium site and may have an O3′ type crystal structure.

### <STEM Analysis and EDX Analysis>

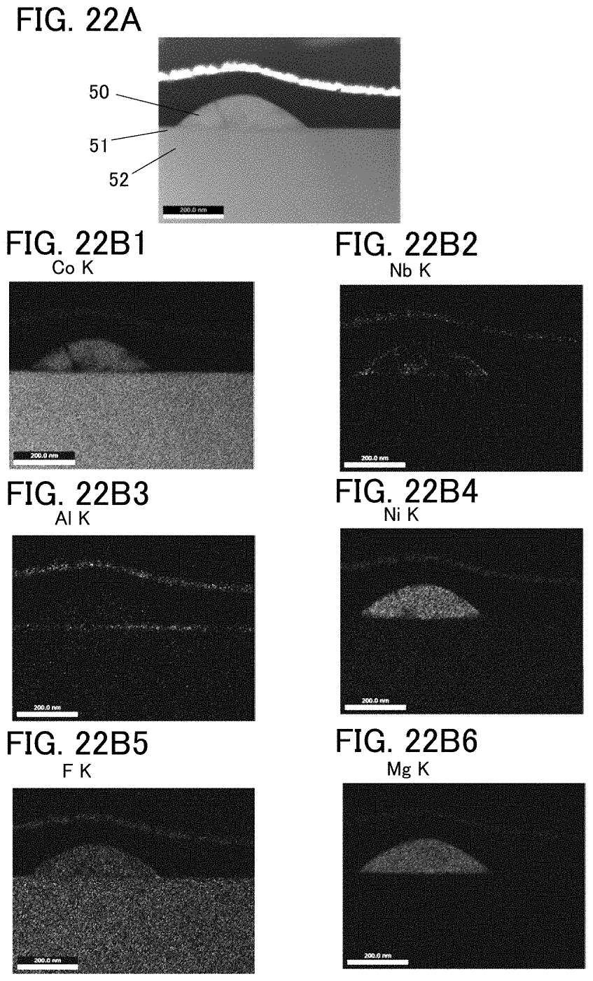

FIG. 22A shows a high-angle annular dark-field scanning transmission microscope (HAADF-STEM) image of one cross section of Sample 3. The HAADF-STEM image was taken under the following conditions.

Pretreatment of sample: Slicing by an FIB method (p-sampling method)
Transmission electron microscope: JEM-ARM200F manufactured by JEOL Ltd.
Observation condition, acceleration voltage: 200 kV
Magnification accuracy: ±3%

In FIG. 22A, a projection 50 can be observed at the center of the image, and the projection 50 and a surface portion 51 can be distinguished on the basis of a difference in contrast. For observation, a resin layer, a carbon coat layer, and a Pt layer are provided above the projection 50.

The projection 50 and the surface portion 51 are positioned in the vicinity of the surface of the lithium cobalt oxide. The inside of the lithium cobalt oxide particle is an inner portion 52. The surface portion 51 includes the boundary between the inner portion 52 and the projection 50. By distinguishing the projection 50, the surface portion 51, and the inner portion 52, the existence of an additive element or the like can be examined.

FIG. 22B1 to FIG. 22B6 show element mapping images with EDX plane analysis of Sample 3. In the element mapping images, a region where the count is less than or equal to the lower detection limit is denoted in black, and as the count is increased, luminance becomes high.

FIG. 22B1 is a mapping image of cobalt, FIG. 22B2 is a mapping image of niobium, FIG. 22B3 is a mapping image of aluminum, FIG. 22B4 is a mapping image of nickel, FIG. 22B5 is a mapping image of fluorine, and FIG. 22B6 is a mapping image of magnesium.

It is found from FIG. 22A and FIG. 22B1 that cobalt exists in the entire positive electrode active material. Cobalt exists in the inner portion 52 and the projection 50. Furthermore, comparison between the projection 50 and the inner portion 52 indicates that a large amount of cobalt exists in the inner portion 52.

It is found from FIG. 22A and FIG. 22B2 that niobium exists in the projection 50. Niobium was hardly observed in the inner portion 52. That is, a larger amount of niobium exists in the projection 50 than in the inner portion 52. This state is sometimes described as “niobium is unevenly distributed in the projection 50”.

It is found from FIG. 22A and FIG. 22B3 that although aluminum can be observed in the projection 50 and the inner portion 52, a large amount of aluminum exists in the surface portion 51 including the boundary between the projection 50 and the inner portion 52. This state is sometimes described as “aluminum is unevenly distributed in the surface portion 51, specifically in the above-described boundary”. Aluminum may be in a similar state also in the case where the additive element Y is an element other than Nb.

It is found from FIG. 22A and FIG. 22B4 that a larger amount of nickel exists in the projection 50 than in the inner portion 52. This state is sometimes described as “nickel is unevenly distributed in the projection 50”. Nickel may be in a similar state also in the case where the additive element Y is an element other than Nb.

It is found from FIG. 22A and FIG. 22B5 that fluorine exists in the entire positive electrode active material. Fluorine may be in a similar state also in the case where the additive element Y is an element other than Nb.

It is found from FIG. 22A and FIG. 22B6 that magnesium exists in the projection 50. Magnesium was hardly observed in the inner portion 52. That is, a larger amount of magnesium is distributed in the projection 50 than in the inner portion 52. This state is sometimes described as “magnesium is unevenly distributed in the projection 50”. Magnesium may be in a similar state also in the case where the additive element Y is an element other than Nb.

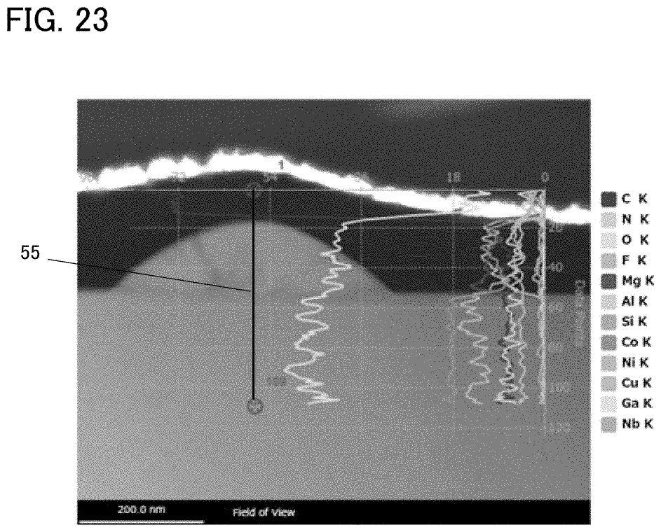

FIG. 23 shows results of EDX line analysis along a center line 55 of the projection of Sample 3. It is found that as in FIG. 22A and FIG. 22B1 to FIG. 22B6, niobium, nickel, magnesium, and the like exist in the projection, a large amount of cobalt and the like exists in the inner portion, and fluorine and the like exist in the projection and the inner portion. It is found that in the projection, the amount of niobium is smaller than those of nickel and magnesium. It is found that cobalt exists also in the projection.

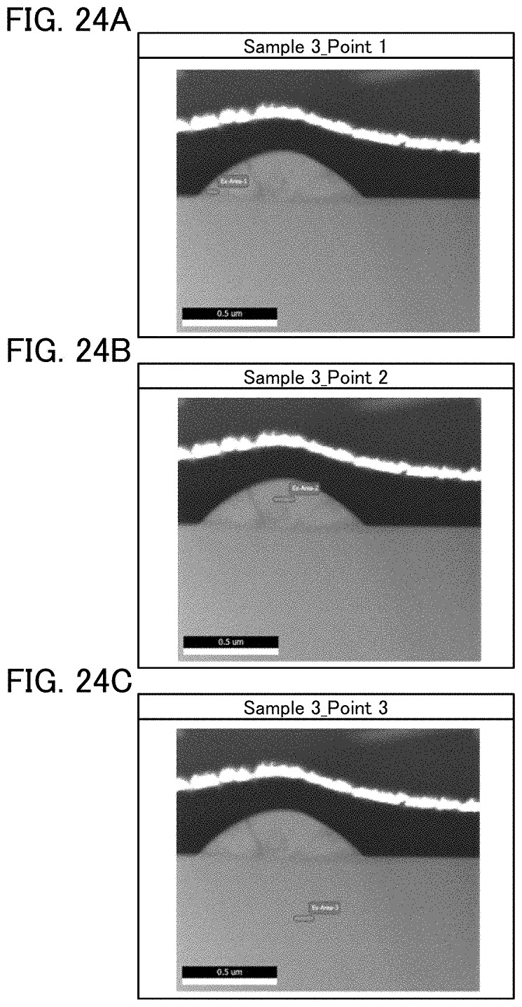

FIG. 24A shows results of EDX point analysis of the projection and the like of Sample 3. In FIG. 24A, a point analysis target position is surrounded and denoted by Point 1. Point 1 is positioned in a lower end portion of the projection. In FIG. 24B, a point analysis target position is surrounded and denoted by Point 2. Point 2 is positioned in the center portion of the projection. In FIG. 24C, a point analysis target position is surrounded and denoted by Point 3. Point 3 is positioned in the inner portion. The following table lists the results of the EDX point analysis of Point 1 to Point 3. Note that the lower detection limit is approximately 1 atomic %. Some of elements whose amount is less than or equal to the lower detection limit are not shown, so that the total is not 100%.

TABLE 2

| | Point 1 | Point 2 | Point 3 |
|---|---|---|---|
| | Concentration | Concentration | Concentration |
| Element | (at %) | (at %) | (at %) |
| O | 49.3 | 47.7 | 56.0 |
| Co | 5.0 | 12.8 | 20.0 |
| Nb | 4.7 | 1.5 | 0.6 |
| Mg | 10.7 | 10.3 | 0.2 |
| Al | 0.2 | 0.4 | 0.3 |
| Ni | 4.1 | 5.7 | 0.3 |

The EDX point analysis and the like revealed that Nb, Ni, and Mg exist in the projection and the like.

In consideration of the results in FIG. 24A to FIG. 24C, a larger amount of niobium exists in the projection than in the inner portion. This is a tendency similar to that in the result shown in FIG. 22B2. According to FIG. 24A, FIG. 24B, and Table 2, the concentration of niobium in the projection is considered to be within at least the range from 1.5 at % to 4.7 at %. Moreover, according to FIG. 24C and Table 2, the concentration of niobium in the inner portion is 0.6 at %, which is lower than or equal to the lower detection limit and is lower than that in the projection.

In consideration of the results in FIG. 24A to FIG. 24C, a larger amount of magnesium exists in the projection than in the inner portion. This is a tendency similar to that in the result shown in FIG. 22B6. According to FIG. 24A, FIG. 24B, and Table 2, the concentration of magnesium in the projection is considered to be within at least the range from 10.3 at % to 10.7 at %. Moreover, according to FIG. 24C and Table 2, the concentration of magnesium in the inner portion is 0.2 at %, which is lower than or equal to the lower detection limit and is lower than that in the projection.

In consideration of the results in FIG. 24A to FIG. 24C, a larger amount of nickel exists in the projection than in the inner portion. This is a tendency similar to that in the result shown in FIG. 22B4. According to FIG. 24A, FIG. 24B, and Table 2, the concentration of nickel in the projection is considered to be within at least the range from 4.1 at % to 5.7 at %. Moreover, according to FIG. 24C and Table 2, the concentration of nickel in the inner portion is 0.3 at %, which is lower than or equal to the lower detection limit and is lower than that in the projection.

The concentration of aluminum was lower than or equal to the lower detection limit.

### <Sample 4>

The fabrication process of Sample 4 is different from the fabrication process of Sample 3 in Step S51. Tetraisopropoxy zirconium and tetraisopropoxy hafnium were prepared in Step S51 for Sample 4, and Samples 4a, 4b, and 4c with different concentrations of Zr and Hf with respect to the lithium cobalt oxide were prepared. Aluminium isopropoxide, tetraisopropoxy zirconium, and tetraisopropoxy hafnium were mixed in accordance with Step S52, whereby the mixed solution 904 of Step S53 was obtained.

Note that in Sample 4a, tetraisopropoxy zirconium and tetraisopropoxy hafnium were respectively 0.25 mol % and 0.25 mol % with respect to the lithium cobalt oxide. In Sample 4b, tetraisopropoxy zirconium and tetraisopropoxy hafnium were respectively 0.05 mol % and 0.05 mol % with respect to the lithium cobalt oxide. In Sample 4b, tetraisopropoxy zirconium and tetraisopropoxy hafnium were respectively 0.25 mol % and 0.05 mol % with respect to the lithium cobalt oxide.

In such a manner, the positive electrode active material 100 was obtained as shown in Step S66 in FIG. 10.

Each of Samples 4a to 4c may contain magnesium at a lithium site and may have an O3′ type crystal structure.

### <Cycle Test>

Half-cell-type coin cells were fabricated using Sample 1 to Sample 3 and Sample 4a to Sample 4c and subjected to cycle tests.

First, Sample 1 to Sample 3 and Sample 4a to Sample 4c were prepared as positive electrode active materials, acetylene black (AB) was prepared as a conductive additive, and polyvinylidene fluoride (PVDF) was prepared as a binding agent. Slurry was formed by mixing them at the positive electrode active material: AB:PVDF=95:3:2 (weight ratio), and the slurry was applied to an aluminum current collector. As a solvent of the slurry, NMP was used.

After the slurry was applied onto the current collector, a solvent was volatilized. The conditions of pressing were that application of pressure at 210 kN/m was performed and then application of pressure at 1467 kN/m was performed. Through the above process, a positive electrode was obtained. The carried amount of the positive electrode was approximately 7 mg/cm², and the electrode density was approximately 4 g/cm³.

The above-described positive electrode and a lithium metal of a counter electrode were assembled into a half cell, and performance of each coin-cell-type battery (referred to as test battery in some cases) was measured.

As an electrolyte solution of the test battery, a solution which is obtained by adding vinylene carbonate (VC) at 2 wt % as an additive to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. As a separator of the test battery, 25-μm-thick polypropylene was used.

First, a discharge rate and a charge rate as cycle test conditions are described. The discharge rate refers to the relative ratio of current at the time of discharging to battery capacity and is expressed in a unit C. A current corresponding to 1 C in a battery with a rated capacity X (Ah) is X(A). The case where discharging is performed at a current of 2X(A) is rephrased as to perform discharging at 2 C, and the case where discharging is performed at a current of X/5 (A) is rephrased as to perform discharging at 0.2 C. The same applies to the charge rate; the case where charging is performed at a current of 2X (A) is rephrased as to perform charging at 2 C, and the case where charging is performed at a current of X/5 (A) is rephrased as to perform charging at 0.2 C.

In measurement for charging and discharging in the cycle test, a battery voltage and a current flowing in a battery are preferably measured by a four-terminal method. In charging, electrons flow from a positive electrode terminal to a negative electrode terminal through a charge-discharge measuring instrument and thus, a charge current flows from the negative electrode terminal to the positive electrode terminal through the charge-discharge measuring instrument. In discharging, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and discharge current are measured with an ammeter of the charge-discharge measuring instrument, the total amount of the electric power flowing during one cycle of charging and the total amount of the electric power flowing during one cycle of discharging are respectively charge capacity and discharge capacity. For example, the total amount of the electric power flowing during the discharging in the first cycle can be regarded as the discharge capacity in the first cycle, and the total amount of the electric power flowing during the discharging in the 50th cycle can be regarded as the discharge capacity in the 50th cycle.

Battery characteristics obtained from cycle test results are sometimes referred to as cycle performance, and the cycle performance includes discharge capacity, charge and discharge curves, a discharge capacity retention rate (capacity retention), or the like.

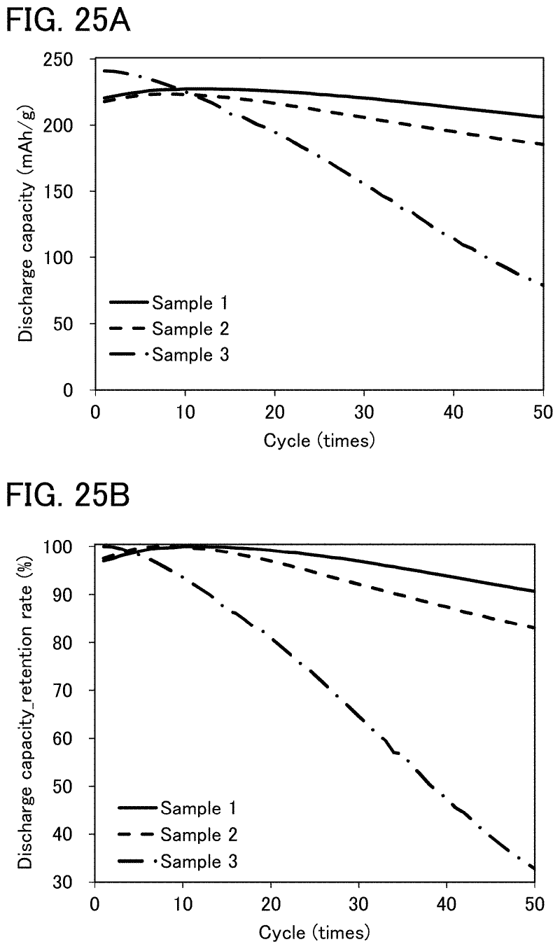

The cycle performance relating to each of Sample 1 to Sample 3 is shown in FIG. 25 to FIG. 28.

In FIG. 25A, measurement was performed at a charge rate and a discharge rate of 0.5 C (1 C=200 mA/g), a charge voltage of 4.65 V, and a temperature of 25° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 25A, the vertical axis represents discharge capacity (mAh/g) and the horizontal axis represents the number of cycles (times). Note that the charge voltage that is higher than 4.6 V is focused on.

The discharge capacity retention rates obtained from FIG. 25A are shown in FIG. 25B, in which the maximum discharge capacity is 100%. In FIG. 25B, the vertical axis represents the discharge capacity retention rate (%) and the horizontal axis represents the number of cycles (times).

In FIG. 25A and FIG. 25B, the solid line denotes the results of Sample 1, the dashed line denotes the results of Sample 2, and the dashed-dotted line denotes the results of Sample 3.

As shown in FIG. 25B, in the measurement at 25° C., the discharge capacity retention rate of each of Sample 1 and Sample 2 is maintained higher than or equal to 80% and lower than or equal to 95%. It is further preferable that the discharge capacity retention rate of Sample 1 be maintained higher than or equal to 90% and lower than or equal to 95%.

According to this example, the positive electrode active material of one embodiment of the present invention has a high charge voltage. Moreover, according to this example, the positive electrode active material of one embodiment of the present invention has high capacity and excellent cycle performance.

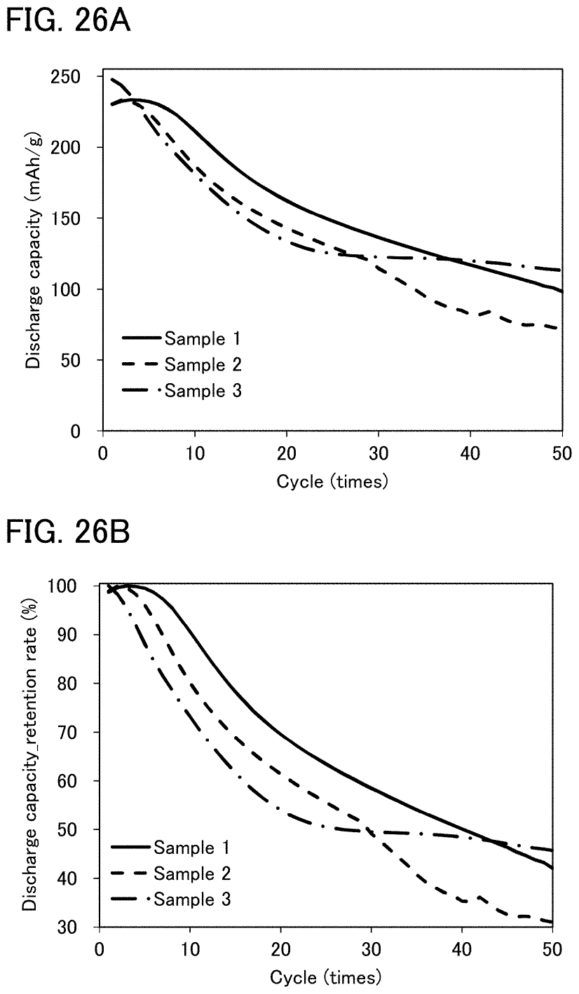

In FIG. 26A, measurement was performed at a charge rate and a discharge rate of 0.5 C (1 C=200 mA/g), a charge voltage of 4.65 V, and a temperature of 45° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 26A, the vertical axis represents discharge capacity (mAh/g) and the horizontal axis represents the number of cycles (times). Note that the charge voltage that is higher than 4.6 V and the temperature of 45° C. that is higher than 25° C. are focused on.

The discharge capacity retention rates obtained from FIG. 26A are shown in FIG. 26B, in which the maximum discharge capacity is 100%. In FIG. 26B, the vertical axis represents the discharge capacity retention rate (%) and the horizontal axis represents the number of cycles (times).

In FIG. 26A and FIG. 26B, the solid line denotes the results of Sample 1, the dashed line denotes the results of Sample 2, and the dashed-dotted line denotes the results of Sample 3.

As shown in FIG. 26B, in the measurement at 45° C., the discharge capacity retention rate of each of Sample 1 and Sample 2 is maintained higher than or equal to 40% and lower than or equal to 60%.

According to this example, the positive electrode active material of one embodiment of the present invention has a high charge voltage. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

Comparison between FIG. 25A and FIG. 26A indicates that the cycle performance measured at 45° C. of each of Sample 1 and Sample 2 has higher discharge capacity than the cycle performance measured at 25° C. Comparison between FIG. 25B and FIG. 26B indicates that the discharge capacity retention rate measured at 25° C. is higher than that measured at 45° C.

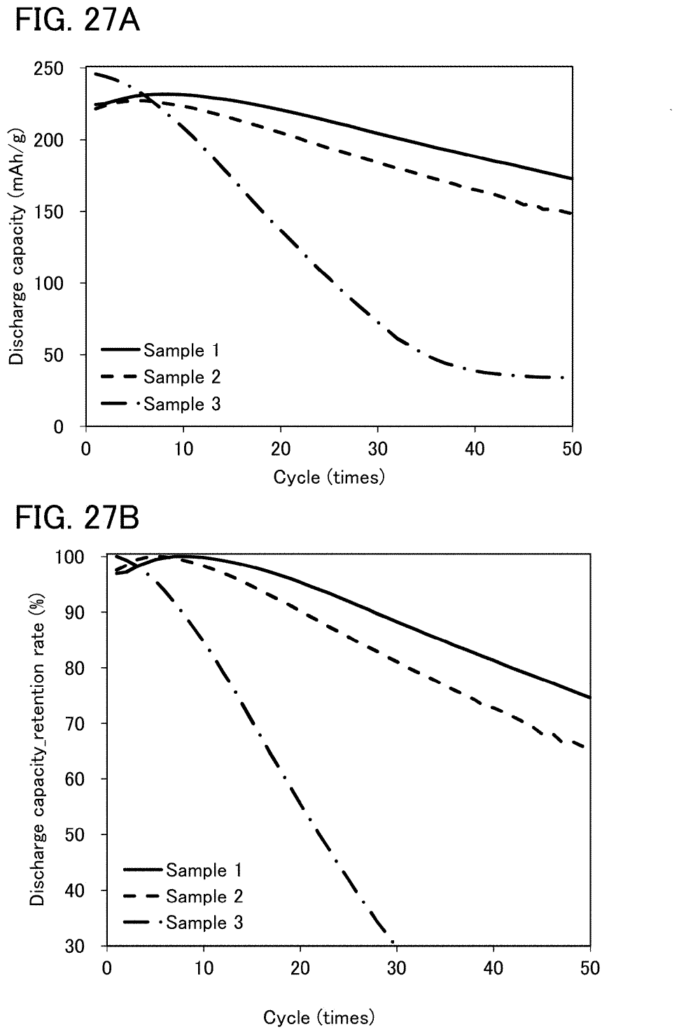

In FIG. 27A, measurement was performed at a charge rate and a discharge rate of 0.5 C (1 C=200 mA/g), a charge voltage of 4.7 V, and a temperature of 25° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 27A, the vertical axis represents discharge capacity (mAh/g) and the horizontal axis represents the number of cycles (times). Note that the charge voltage that is higher than 4.6 V is focused on.

The discharge capacity retention rates obtained from FIG. 27A are shown in FIG. 27B, in which the maximum discharge capacity is 100%. The vertical axis represents the discharge capacity retention rate (%) and the horizontal axis represents the number of cycles (times).

In FIG. 27A and FIG. 27B, the solid line denotes the results of Sample 1, the dashed line denotes the results of Sample 2, and the dashed-dotted line denotes the results of Sample 3.

As shown in FIG. 27B, in the measurement at 25° C., the discharge capacity retention rate of each of Sample 1 and Sample 2 is maintained higher than or equal to 65% and lower than or equal to 80%. It is further preferable that the discharge capacity retention rate of Sample 1 be maintained higher than or equal to 70% and lower than or equal to 85%.

According to this example, the positive electrode active material of one embodiment of the present invention has a high charge voltage. Moreover, according to this example, the positive electrode active material of one embodiment of the present invention has high capacity and excellent cycle performance.

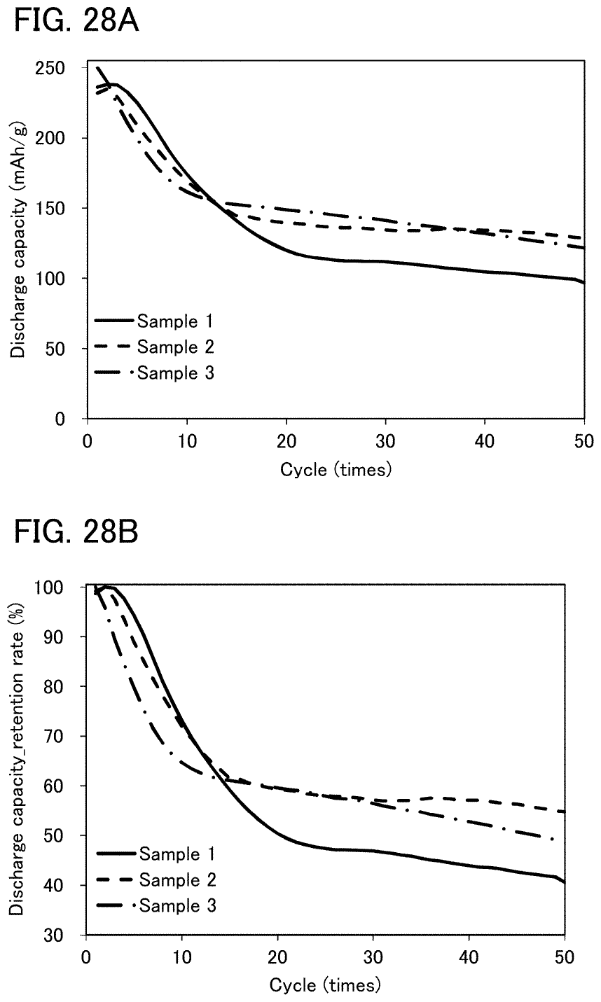

In FIG. 28A, measurement was performed at a charge rate and a discharge rate of 0.5 C (1 C=200 mA/g), a charge voltage of 4.7 V, and a temperature of 45° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 28A, the vertical axis represents discharge capacity (mAh/g) and the horizontal axis represents the number of cycles (times). Note that the charge voltage that is higher than 4.6 V is focused on.

The discharge capacity retention rates obtained from FIG. 28A are shown in FIG. 28B, in which the maximum discharge capacity is 100%. The vertical axis represents the discharge capacity retention rate (%) and the horizontal axis represents, as in FIG. 28A, the number of cycles (times).

In FIG. 28A and FIG. 28B, the solid line denotes the results of Sample 1, the dashed line denotes the results of Sample 2, and the dashed-dotted line denotes the results of Sample 3.

As shown in FIG. 28B, in the measurement at 45° C., the discharge capacity retention rate of each of Sample 1 and Sample 2 is maintained higher than or equal to 35% and lower than or equal to 65%.

According to this example, the positive electrode active material of one embodiment of the present invention has a high charge voltage. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

Comparison between FIG. 27A and FIG. 28A indicates that the cycle performance measured at 45° C. of each of Sample 1 and Sample 2 has higher discharge capacity than the cycle performance measured at 25° C. Comparison between FIG. 27B and FIG. 28B indicates that the discharge capacity retention rate measured at 25° C. is higher than that measured at 45° C.

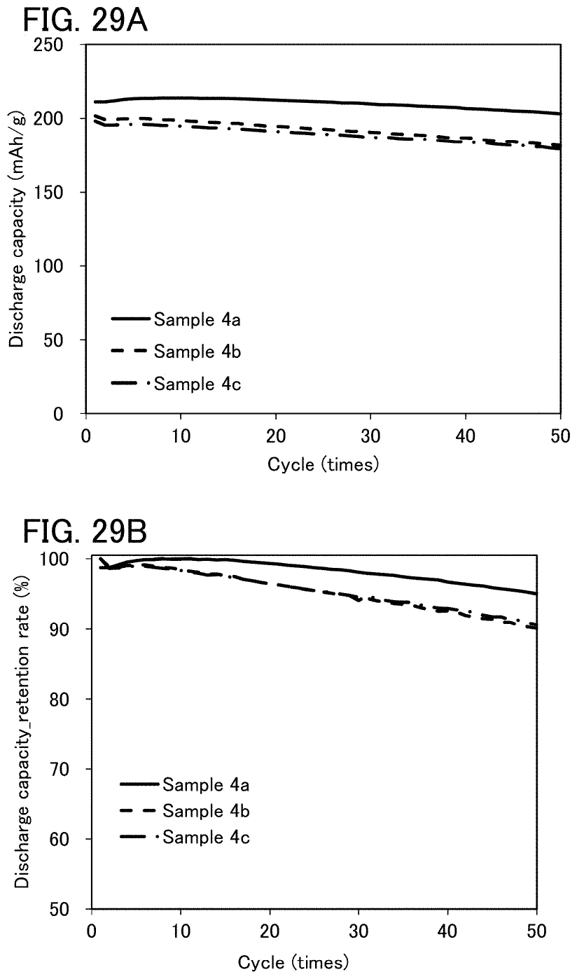

The cycle performance relating to each of Sample 4a to Sample 4c is shown in FIG. 29 to FIG. 32. In FIG. 29 to FIG. 32, the solid line denotes the results of Sample 4a, the dashed line denotes the results of Sample 4b, and the dashed-dotted line denotes the results of Sample 4c. For easy comparison between cycle test conditions, the conditions in FIG. 29 to FIG. 32 are the same as those in FIG. 25 to FIG. 28, respectively.

FIG. 29A and FIG. 29B show results obtained under the test conditions where the temperature was 25° C. and the charge voltage was 4.65 V. FIG. 29A and FIG. 29B indicate that Sample 4a to Sample 4c to each of which Hf and Zn were added are positive electrode active materials having more excellent cycle performance than Sample 1 to which only Hf was added. The performance of Sample 4a was particularly preferable.

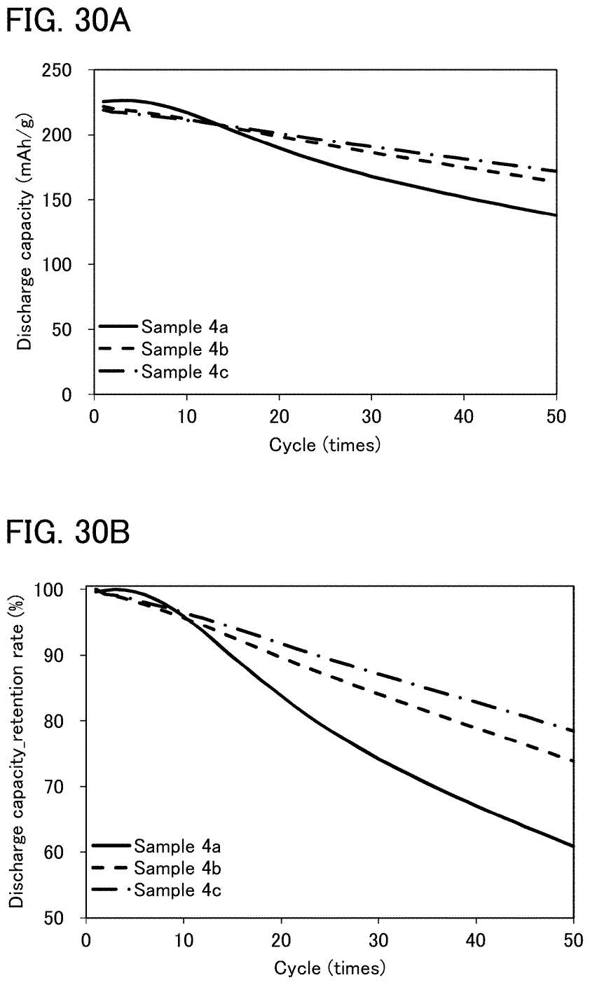

FIG. 30A and FIG. 30B show results obtained under the test conditions where the temperature was 45° C. and the charge voltage was 4.65 V. FIG. 30A and FIG. 30B indicate that Sample 4a to Sample 4c to each of which Hf and Zn were added are positive electrode active materials having more excellent cycle performance than Sample 1 to which only Hf was added. The performance of Sample 4c was particularly preferable.

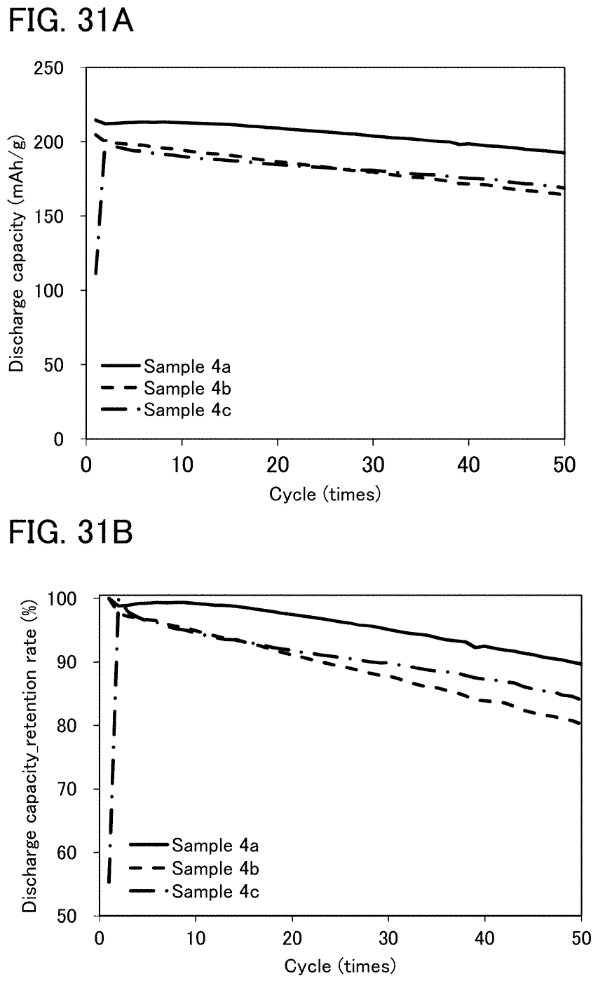

FIG. 31A and FIG. 31B show results obtained under the test conditions where the temperature was 25° C. and the charge voltage was 4.7 V. FIG. 31A and FIG. 31B indicate that Sample 4a to Sample 4c to each of which Hf and Zn were added are positive electrode active materials having more excellent cycle performance than Sample 1 to which only Hf was added. The performance of Sample 4a was particularly preferable.

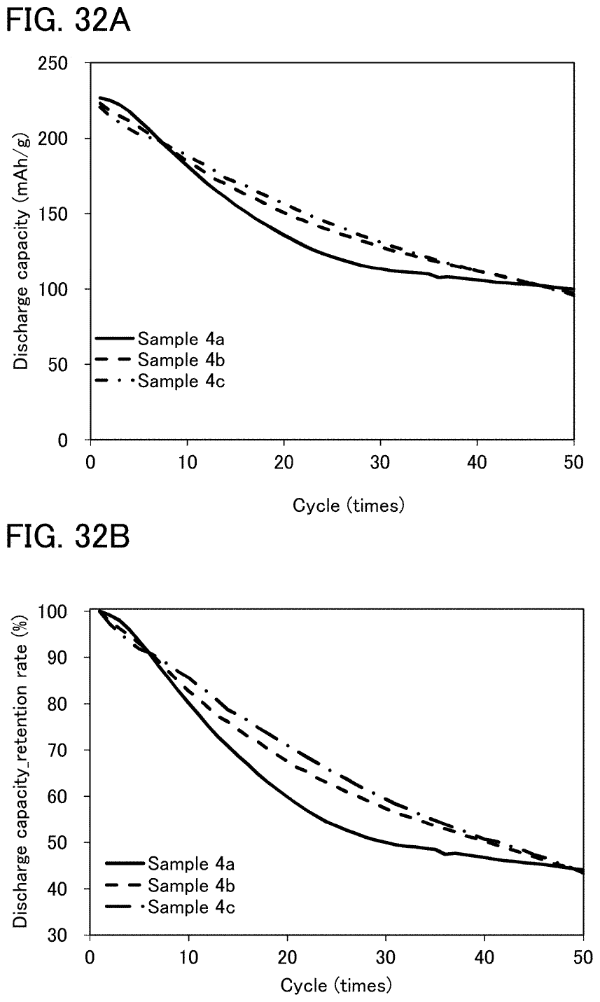

FIG. 32A and FIG. 32B show results obtained under the test conditions where the temperature was 45° C. and the charge voltage was 4.7 V. FIG. 32A and FIG. 32B indicate that Sample 4a to Sample 4c to each of which Hf and Zn were added are positive electrode active materials having more excellent cycle performance than Sample 1 to which only Hf was added. The performance of each of Sample 4b and Sample 4c was particularly preferable.

This example shows the cycle performance of the half cells with a charge voltage of 4.65 V and 4.7 V. According to this example, the upper limit of the charge voltage in the cycle test of the positive electrode active material of one embodiment of the present invention can be higher than or equal to 4.6 V, and a secondary battery with a high charge voltage can be provided. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

In this specification and the like, a voltage is a voltage in the case of using a lithium counter electrode, unless otherwise specified. Even when the same positive electrode is used, a voltage varies depending on the material used for the negative electrode. For example, the charge voltage in the case of using the positive electrode of the present invention and a graphite negative electrode are lower than the charge voltage in the case of using a lithium counter electrode by approximately 0.1 V.

### Example 2

In this example, Sample 5 and Sample 6 to which a Ce source and a Sm source were added respectively were fabricated; the Ce source and the Sm source were each added as a Y source, which is an additive element source for lithium cobalt oxide. Furthermore, a Mg source and a F source are added to each sample as an X source 1, and each sample includes a Ni source and an Al source as an X2 source. The following table lists the conditions of the samples.

TABLE 3

| | Material of | Additive element | Additive element | Additive element |
|---|---|---|---|---|
| Sample | positive electrode | source | source | source |
| name | active material | (X1 source) | (X2 source) | (Y source) |
| Sample 5 | LCO | Mg source, F source | Ni source, Al source | Ce source |
| Sample 6 | LCO | Mg source, F source | Ni source, Al source | Sm source |

Fabrication process of each sample will be described below.

### <Sample 5>

The fabrication process of Sample 5 is different from the fabrication process of Sample 4 in Step S51. For Sample 5, the Ce source was prepared as the Y source. Triisopropoxy cerium(III) was prepared as the Ce source, and weighing was performed so that triisopropoxy cerium(III) was 0.25 mol % with respect to the lithium cobalt oxide. As alcohol, 2-propanol was prepared. Aluminium isopropoxide and triisopropoxy cerium(III) were mixed in accordance with Step S52, whereby the mixed solution 904 of Step S53 was obtained.

In such a manner, the positive electrode active material 100 was obtained as shown in Step S66 in FIG. 10.

### <SEM Observation>

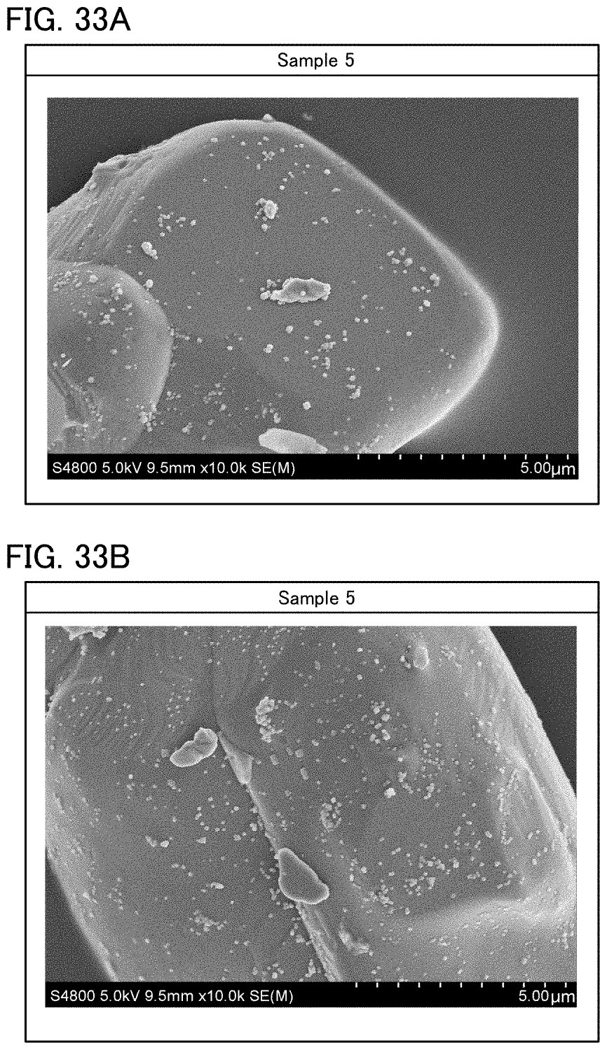

Sample 5 was subjected to SEM observation. For EDX measurement, SU8030 which is a SEM manufactured by Hitachi High-Tech Corporation was used. The accelerating voltage was 5 kV. FIG. 33A and FIG. 33B show SEM images of the positive electrode active materials of Sample 5. Although the positive electrode active materials of Sample 5 were fabricated under the same conditions, an external shape of the lithium cobalt oxide is different between FIG. 33A and FIG. 33B. In FIG. 33B, a grain boundary was observed. In both FIG. 33A and FIG. 33B, a projection is observed on a surface of the lithium cobalt oxide. Thus, Sample 5 is found to be lithium cobalt oxide having a projection on its surface.

In FIG. 33A and FIG. 33B, a plurality of projections are observed. As the plurality of projections, at least a first projection with a first size and a second projection with a size smaller than the first size can be observed, and the number of observed second projections is larger than that of observed first projections. In addition, as can be seen from FIG. 33A and FIG. 33B, no crack was observed in Sample 5.

The projection of Sample 5 contains at least Ce. In some cases, Ce is unevenly distributed in the projection due to the third heating in Step S64. As elements existing in the projection, one or two or more selected from Mg, F, Ni, and Al are considered besides Ce.

Sample 5 may contain magnesium at a lithium site and may have an O3′ type crystal structure.

### <Sample 6>

The fabrication process of Sample 6 is different from the fabrication process of Sample 5 in Step S51. For Sample 6, triisopropoxy samarium(III) was prepared in Step S51.

In such a manner, the positive electrode active material 100 was obtained as shown in Step S66 in FIG. 10.

### <SEM Observation>

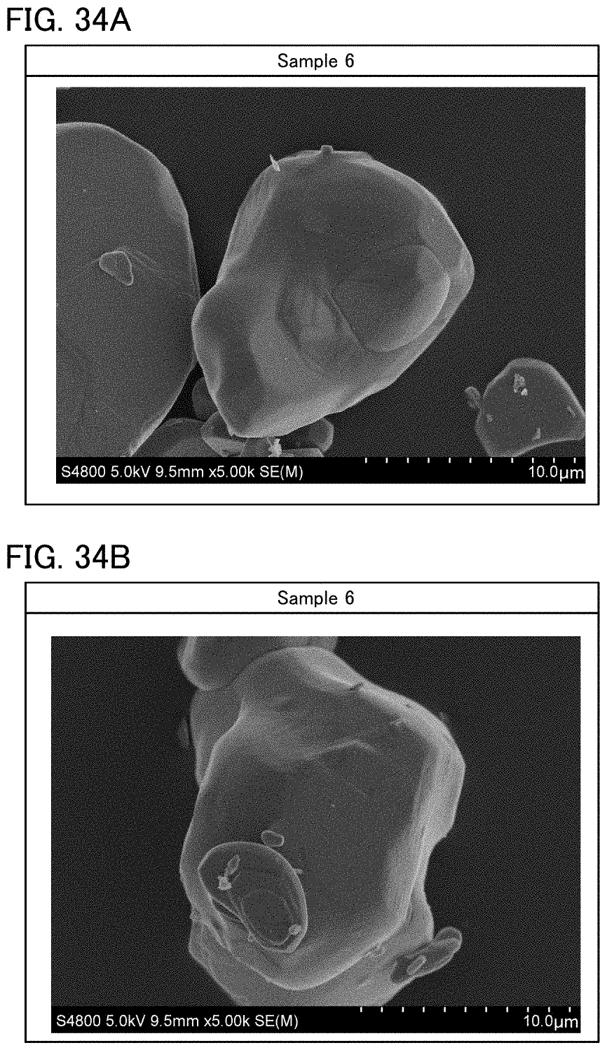

Sample 6 was subjected to SEM observation. For the SEM observation, S4800 which is a SEM manufactured by Hitachi High-Tech Corporation was used. The accelerating voltage was 5 kV. FIG. 34A and FIG. 34B show SEM images of the positive electrode active materials of Sample 6. Although the positive electrode active materials of Sample 6 were fabricated under the same conditions, an external shape of the lithium cobalt oxide is different between FIG. 34A and FIG. 34B. In FIG. 34A and FIG. 34B, a grain boundary was not observed. In both FIG. 34A and FIG. 34B, a projection is observed on a surface of the lithium cobalt oxide. Thus, Sample 6 is found to be lithium cobalt oxide having a projection on its surface.

In FIG. 34A and FIG. 34B, a plurality of projections are observed. Comparison with FIG. 33A and FIG. 33B, which are the SEM images of the positive electrode active materials of Sample 5, revealed that the number and the size of projections of Sample 6 were smaller and larger, respectively. In Sample 6, a small projection like that in Sample 5 (the second projection of Sample 5) was not observed. In addition, as can be seen from FIG. 34A and FIG. 34B, no crack was observed in Sample 6.

The projection of Sample 6 contains at least Sm. In some cases, Sm is unevenly distributed in the projection due to the third heating in Step S64. As elements existing in the projection, one or two or more selected from Mg, F, Ni, and Al are considered besides Sm.

Sample 6 may contain magnesium at a lithium site and may have an O3′ type crystal structure.

### <SEM-EDX Analysis>

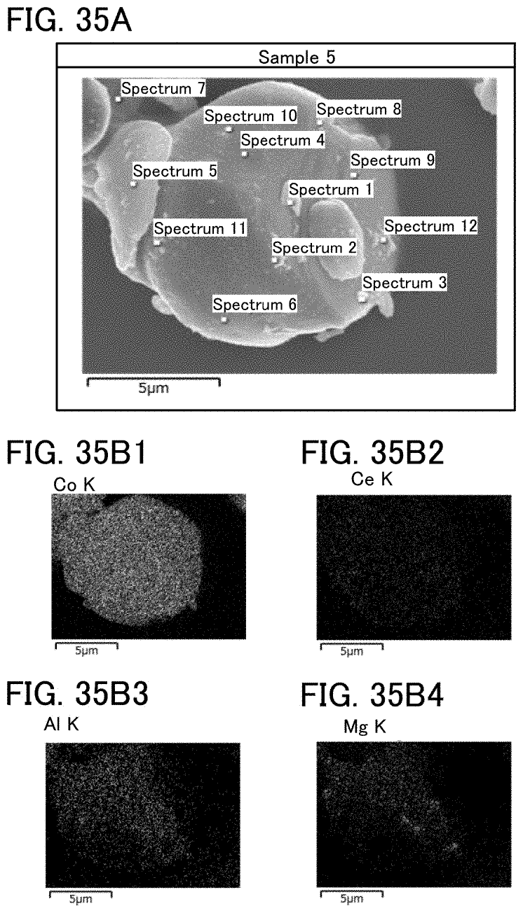

Sample 5 was subjected to SEM-EDX analysis. For the EDX measurement, an apparatus in which an EDX unit EX-350X-MaX80 manufactured by HORIBA, Ltd. was provided in a SEM, SU8030 manufactured by Hitachi High-Tech Corporation. The accelerating voltage in the EDX measurement was 15 kV. FIG. 35A shows a SEM image of Sample 5, which is an EDX measurement target.

FIG. 35B1 to FIG. 35B4 show element mapping images with EDX plane analysis. In the element mapping images, a region where the count is less than or equal to the lower detection limit is denoted in black, and as the count is increased, luminance becomes high.

FIG. 35B1 is a mapping image of cobalt, FIG. 35B2 is a mapping image of cerium, FIG. 35B3 is a mapping image of aluminum, and FIG. 35B4 is a mapping image of magnesium.

It is found from FIG. 35A and FIG. 35B1 that cobalt exists in the entire surface of the positive electrode active material.

It is found from FIG. 35A and FIG. 35B2 that the amount of cerium is smaller than that of cobalt.

It is found from FIG. 35A and FIG. 35B3 that aluminum exists in the entire surface of the positive electrode active material.

It is found from FIG. 35A and FIG. 35B4 that magnesium exists in the entire surface of the positive electrode active material.

FIG. 35A shows the positive electrode active material with Spectrum 1 to Spectrum 12, which represent measurement regions subjected to EDX point analysis. It can be observed in FIG. 35A that some of the measurement regions overlap with the projections. The following table lists the results of the EDX point analysis of the points. Note that the lower detection limit is approximately 1 atomic %. Some of elements whose amount is less than or equal to the lower detection limit are not shown, so that the total is not 100%.

TABLE 4

| | Spectrum 1 | Spectrum 2 | Spectrum 3 | Spectrum 4 | Spectrum 5 | Spectrum 6 |
|---|---|---|---|---|---|---|
| | Concentration | Concentration | Concentration | Concentration | Concentration | Concentration |
| Element | (at %) | (at %) | (at %) | (at %) | (at %) | (at %) |
| O | 40.9 | 36.0 | 28.2 | 45.9 | 40.2 | 8.6 |
| Co | 40.1 | 42.3 | 39.5 | 35.3 | 41.6 | 99.4 |
| Ce | 0.4 | 1.2 | 1.8 | 0.3 | 0.6 | 0.3 |
| Mg | — | 0.2 | 1.7 | 0.1 | — | 0.1 |
| Al | 0.4 | 0.6 | 0.4 | 0.2 | 0.3 | 0.3 |
| | Spectrum 7 | Spectrum 8 | Spectrum 9 | Spectrum 10 | Spectrum 11 | Spectrum 12 |
| | Concentration | Concentration | Concentration | Concentration | Concentration | Concentration |
| Element | (at %) | (at %) | (at %) | (at %) | (at %) | (at %) |
| O | 13.1 | 22.3 | 7.1 | 46.3 | 23.2 | 14.0 |
| Co | 83.7 | 58.7 | 99.3 | 33.1 | 64.2 | 75.2 |
| Ce | 0.6 | 1.0 | 3.3 | 0.3 | 1.3 | 2.8 |
| Mg | 0.1 | 1.6 | — | — | 0.1 | 1.2 |
| Al | 0.2 | 0.3 | 0.3 | 0.2 | 0.7 | 0.3 |

In consideration of the results in FIG. 35A, FIG. 35B1 to FIG. 35B4, and Table 4, cerium is found to exist at least on the surface. The amount of cerium may be smaller than those of cobalt, aluminum, and magnesium. Sample 5 is considered to be an active material in which cerium exists on its surface and the concentration of cerium obtained by the EDX analysis is at least higher than or equal to the lower detection limit and lower than or equal to 3.3 at %. The range of the concentration of cerium on the surface of the projection can be obtained from FIG. 35A to FIG. 35B2 and Table 4.

The concentration of aluminum on the surface was at the lower detection limit.

In consideration of the results in FIG. 35A to FIG. 35B4 and Table 4, magnesium is found to exist at least on the surface. Sample 5 is considered to be an active material in which magnesium exists on its surface and the concentration of magnesium obtained by the EDX analysis is at least higher than or equal to the lower detection limit and lower than or equal to 1.7 at %. The range of the concentration of magnesium on the surface of the projection can be obtained from FIG. 35A to FIG. 35B4 and Table 4.

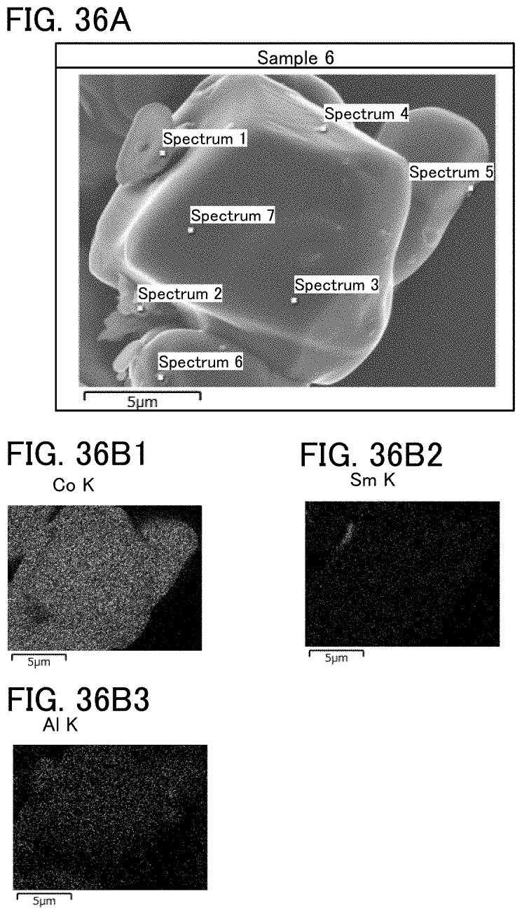

Like Sample 5, Sample 6 was subjected to SEM-EDX analysis. FIG. 36A shows a SEM image of Sample 6, which is an EDX measurement target.

FIG. 36B1 to FIG. 36B3 show element mapping images with EDX plane analysis. In the element mapping images, a region where the count is less than or equal to the lower detection limit is denoted in black, and as the count is increased, luminance becomes high.

FIG. 36B1 is a mapping image of cobalt, FIG. 36B2 is a mapping image of samarium, and FIG. 36B3 is a mapping image of aluminum.

It is found from FIG. 36A and FIG. 36B1 that cobalt exists in the entire surface of the positive electrode active material.

It is found from FIG. 36A and FIG. 36B2 that the amount of samarium is smaller than that of cobalt.

It is found from FIG. 36A and FIG. 36B3 that aluminum exists in the entire surface of the positive electrode active material.

FIG. 36A shows the positive electrode active material with Spectrum 1 to Spectrum 7, which represent measurement regions subjected to EDX point analysis. It can be observed in FIG. 36A that some of the measurement regions overlap with the projections. The following table lists the concentrations of Sm and the like obtained by the EDX point analysis of the points. Note that the lower detection limit is approximately 1 atomic %. Some of elements whose amount is less than or equal to the lower detection limit are not shown, so that the total is not 100%.

TABLE 5

| | Spectrum 1 | Spectrum 2 | Spectrum 3 | Spectrum 4 |
|---|---|---|---|---|
| | Concentration | Concentration | Concentration | Concentration |
| Element | (at %) | (at %) | (at %) | (at %) |
| O | 17.5 | 19.9 | 27.7 | 44.6 |
| Co | 30.9 | 62.0 | 63.0 | 30.8 |
| Sm | 35.1 | 3.2 | — | 0.1 |
| Mg | 0.1 | — | — | 0.2 |
| Al | 0.1 | 0.3 | 0.2 | — |

| | Spectrum 5 | Spectrum 6 | Spectrum 7 |
|---|---|---|---|
| | Concentration | Concentration | Concentration |
| Element | (at %) | (at %) | (at %) |
| O | 3.4 | 34.2 | 43.1 |
| Co | 14.3 | 55.3 | 41.5 |
| Sm | 0.2 | — | — |
| Mg | — | 0.2 | 0.1 |
| Al | 0.2 | 0.2 | 0.2 |

In consideration of the results in FIG. 36A and FIG. 36B1 to FIG. 36B3, samarium is found to exist at least on the surface. The amount of samarium may be smaller than those of cobalt and aluminum. According to Table 5, the concentration of samarium on the surface is considered to be at least higher than or equal to the lower detection limit and lower than or equal to 35.1 at %.

The concentration of aluminum on the surface was lower than or equal to the lower detection limit.

The concentration of magnesium on the surface was lower than or equal to the lower detection limit.

### <Cycle Test>

Half-cell-type coin cells were fabricated using Sample 5 and Sample 6 and subjected to cycle tests. The fabrication method of the half-cell-type coin cells was similar to that in Example 1.

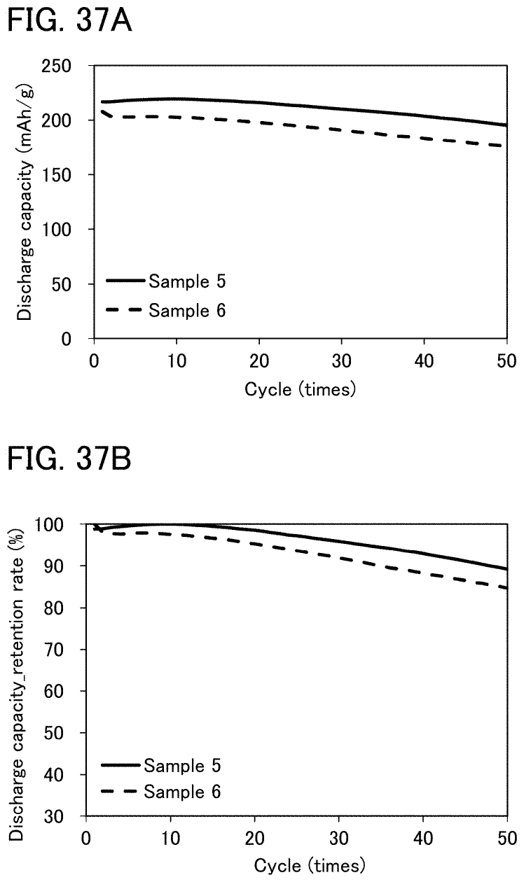

The cycle performance relating to each of Sample 5 and Sample 6 is shown in FIG. 37 to FIG. 40.

In FIG. 37A, measurement was performed at a charge rate and a discharge rate of 0.5 C (1 C=200 mA/g), a charge voltage of 4.65 V, and a temperature of 25° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 37A, the vertical axis represents discharge capacity (mAh/g) and the horizontal axis represents the number of cycles (times). Note that the charge voltage that is higher than 4.6 V is focused on.

The discharge capacity retention rates obtained from FIG. 37A are shown in FIG. 37B, in which the maximum discharge capacity is 100%. In FIG. 37B, the vertical axis represents the discharge capacity retention rate (%) and the horizontal axis represents the number of cycles (times).

In FIG. 37A and FIG. 37B, the solid line denotes the results of Sample 5 and the dashed line denotes the results of Sample 6.

As shown in FIG. 37B, in the measurement at 25° C., the discharge capacity retention rate of each of Sample 5 and Sample 6 was higher than or equal to 80% and lower than or equal to 95%. The discharge capacity retention rate of Sample 5 was higher than or equal to 90% and lower than or equal to 95%, which is further preferable.

According to this example, the positive electrode active material of one embodiment of the present invention has a high charge voltage. Moreover, according to this example, the positive electrode active material of one embodiment of the present invention has high capacity and excellent cycle performance.

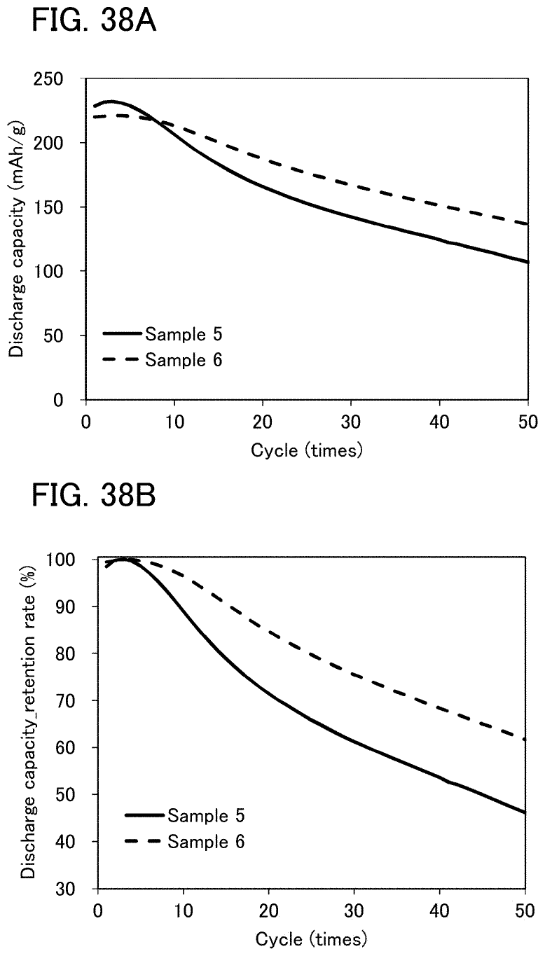

In FIG. 38A, measurement was performed at a charge rate and a discharge rate of 0.5 C (1 C=200 mA/g), a charge voltage of 4.65 V, and a temperature of 45° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 38A, the vertical axis represents discharge capacity (mAh/g) and the horizontal axis represents the number of cycles (times). Note that the charge voltage that is higher than 4.6 V and the temperature of 45° C. that is higher than 25° C. are focused on.

The discharge capacity retention rates obtained from FIG. 38A are shown in FIG. 38B, in which the maximum discharge capacity is 100%. In FIG. 38B, the vertical axis represents the discharge capacity retention rate (%) and the horizontal axis represents the number of cycles (times).

In FIG. 38A and FIG. 38B, the solid line denotes the results of Sample 5 and the dashed line denotes the results of Sample 6.

As shown in FIG. 38B, in the measurement at 45° C., the discharge capacity retention rate of each of Sample 5 and Sample 6 was higher than or equal to 60% and lower than or equal to 80%.

According to this example, the positive electrode active material of one embodiment of the present invention has a high charge voltage. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

Comparison between FIG. 37A and FIG. 38A indicates that the cycle performance measured at 25° C. of each of Sample 5 and Sample 6 has higher discharge capacity than the cycle performance measured at 45° C. Comparison between FIG. 37B and FIG. 38B indicates that the discharge capacity retention rate measured at 25° C. is higher than that measured at 45° C.

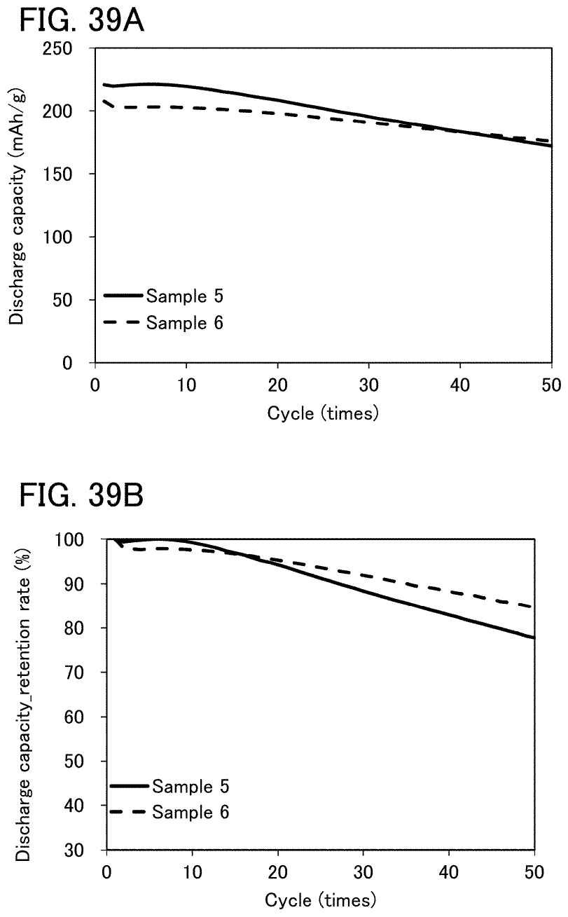

In FIG. 39A, measurement was performed at a charge rate and a discharge rate of 0.5 C (1 C=200 mA/g), a charge voltage of 4.7 V, and a temperature of 25° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 39A, the vertical axis represents discharge capacity (mAh/g) and the horizontal axis represents the number of cycles (times). Note that the charge voltage that is higher than 4.6 V is focused on.

The discharge capacity retention rates obtained from FIG. 39A are shown in FIG. 39B, in which the maximum discharge capacity is 100%. The vertical axis of FIG. 39B represents the discharge capacity retention rate (%) and the horizontal axis represents the number of cycles (times).

In FIG. 39A and FIG. 39B, the solid line denotes the results of Sample 5 and the dashed line denotes the results of Sample 6.

As shown in FIG. 39B, in the measurement at 25° C., the discharge capacity retention rate of each of Sample 5 and Sample 6 was higher than or equal to 75% and lower than or equal to 90%. The discharge capacity retention rate of Sample 6 was higher than or equal to 85% and lower than or equal to 90%, which is further preferable.

According to this example, the positive electrode active material of one embodiment of the present invention has a high charge voltage. Moreover, according to this example, the positive electrode active material of one embodiment of the present invention has high capacity and excellent cycle performance.

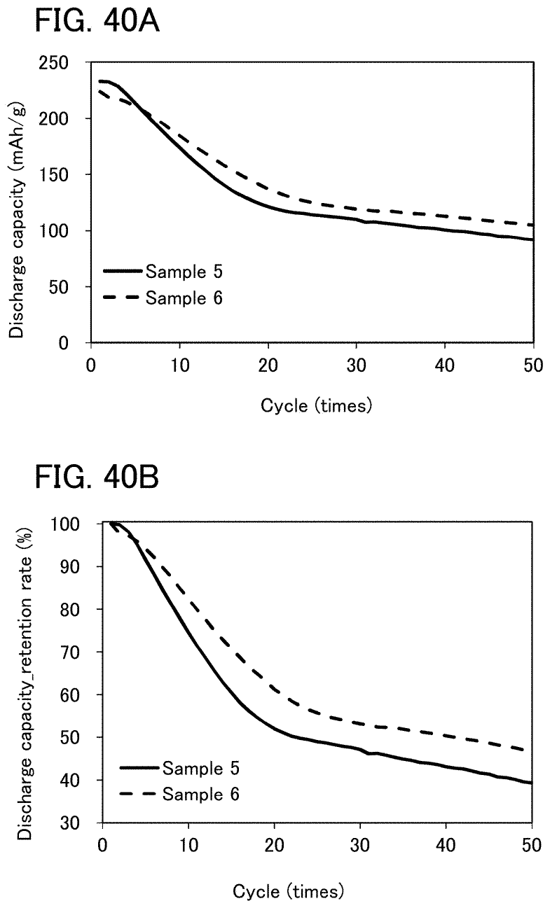

In FIG. 40A, measurement was performed at a charge rate and a discharge rate of 0.5 C (1 C=200 mA/g), a charge voltage of 4.7 V, and a temperature of 45° C. Note that charging was terminated when the current reached 0.05 C. Discharging was terminated when the voltage reached 2.5 V. Break periods were set between the end of charging and the start of discharging and between the end of discharging and the start of charging. The break periods were each 10 minutes.

Discharge capacity (mAh/g) in this cycle test is shown as a function of the number of cycles. In FIG. 40A, the vertical axis represents discharge capacity (mAh/g) and the horizontal axis represents the number of cycles (times). Note that the charge voltage that is higher than 4.6 V is focused on.

The discharge capacity retention rates obtained from FIG. 40A are shown in FIG. 40B, in which the maximum discharge capacity is 100%. The vertical axis of FIG. 40B represents the discharge capacity retention rate (%) and the horizontal axis represents the number of cycles (times).

In FIG. 40A and FIG. 40B, the solid line denotes the results of Sample 5 and the dashed line denotes the results of Sample 6.

As shown in FIG. 40B, in the measurement at 45° C., the discharge capacity retention rate of each of Sample 5 and Sample 6 was higher than or equal to 40% and lower than or equal to 55%.

According to this example, the positive electrode active material of one embodiment of the present invention has a high charge voltage. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

Comparison between FIG. 39A and FIG. 40A indicates that the cycle performance measured at 25° C. of each of Sample 5 and Sample 6 has higher discharge capacity than the cycle performance measured at 45° C. Comparison between FIG. 39B and FIG. 40B indicates that the discharge capacity retention rate measured at 25° C. is higher than that measured at 45° C.

This example shows the cycle performance in the case of using the half cells with a charge voltage of 4.65 V and 4.7 V. According to this example, the upper limit of the charge voltage in the cycle test of the positive electrode active material of one embodiment of the present invention can be higher than or equal to 4.6 V, and a secondary battery with a high charge voltage can be provided. Moreover, according to this example, the positive electrode active material of one embodiment of the present invention has high capacity and excellent cycle performance. Furthermore, according to this example, the positive electrode active material of one embodiment of the present invention has excellent high-temperature characteristics.

In this specification and the like, a voltage is a voltage in the case of using a lithium counter electrode, unless otherwise specified. Even when the same positive electrode is used, a voltage varies depending on the material used for the negative electrode. For example, the voltage in the case of using the positive electrode of the present invention and a graphite negative electrode are lower than the voltage in the case of using a lithium counter electrode by approximately 0.1 V.

### REFERENCE NUMERALS

100: positive electrode active material, 101: first particle, 102: projection, 103: projection, 104: projection, 105: grain boundary, 106: surface portion

1. A secondary battery comprising a positive electrode,
wherein the positive electrode comprises lithium cobalt oxide, and
wherein the lithium cobalt oxide comprises a projection comprising at least one selected from Hf, V, Nb, Zr, Ce, and Sm.

2. A secondary battery comprising a positive electrode,
wherein the positive electrode comprises lithium cobalt oxide,
wherein the lithium cobalt oxide comprises a projection comprising at least one selected from Hf, V, Nb, Zr, Ce, and Sm, and
wherein the projection further comprises Mg.

3. A secondary battery comprising a positive electrode,
wherein the positive electrode comprises lithium cobalt oxide,
wherein the lithium cobalt oxide comprises a projection comprising at least one selected from Hf, V, Nb, Zr, Ce, and Sm, and
wherein the projection further comprises Mg and F.

4. A secondary battery comprising a positive electrode,
wherein the positive electrode comprises lithium cobalt oxide,
wherein the lithium cobalt oxide comprises a projection comprising at least one selected from Hf, V, Nb, Zr, Ce, and Sm, and
wherein the projection further comprises Mg, F, and Ni.

5. A secondary battery comprising a positive electrode,
wherein the positive electrode comprises lithium cobalt oxide,
wherein the lithium cobalt oxide comprises a projection comprising at least one selected from Hf, V, Nb, Zr, Ce, and Sm,
wherein the projection further comprises Mg and F, and
wherein Al exists at an interface between the projection and an inner portion of the lithium cobalt oxide.

6. The secondary battery according to claim 1,
wherein the at least one selected from Hf, V, Nb, Zr, Ce, and Sm is unevenly distributed in the projection.

7. A vehicle comprising the secondary battery according to claim 1.

8. A method for manufacturing a secondary battery, comprising the steps of:
forming a mixed solution by mixing lithium cobalt oxide and a metal alkoxide comprising at least one selected from Hf, V, Nb, Zr, Ce, and Sm;
forming a mixture by stirring the mixed solution; and
heating the mixture.

9. A method for manufacturing a secondary battery, comprising the steps of:
forming a first mixture by mixing lithium cobalt oxide and a magnesium source;
heating the first mixture;
forming a mixed solution by mixing the heated first mixture and a metal alkoxide comprising at least one selected from Hf, V, Nb, Zr, Ce, and Sm;
forming a second mixture by stirring the mixed solution; and
heating the second mixture.

10. A method for manufacturing a secondary battery, comprising the steps of:
forming a first mixture by mixing lithium cobalt oxide, a magnesium source, and a fluorine source;
heating the first mixture;
forming a mixed solution by mixing the heated first mixture and a metal alkoxide comprising at least one selected from Hf, V, Nb, Zr, Ce, and Sm;
forming a second mixture by stirring the mixed solution; and
heating the second mixture.

11. The method for manufacturing a secondary battery, according to claim 9, wherein the heating the second mixture is performed in a shorter time than the heating the first mixture.

12. The method for manufacturing a secondary battery, according to claim 9, wherein the heating the second mixture is performed at a lower temperature than the heating the first mixture.

13. The secondary battery according to claim 2,
wherein the at least one selected from Hf, V, Nb, Zr, Ce, and Sm is unevenly distributed in the projection.

14. A vehicle comprising the secondary battery according to claim 2.

15. The secondary battery according to claim 3,
wherein the at least one selected from Hf, V, Nb, Zr, Ce, and Sm is unevenly distributed in the projection.

16. A vehicle comprising the secondary battery according to claim 3.

17. The secondary battery according to claim 4,
wherein the at least one selected from Hf, V, Nb, Zr, Ce, and Sm is unevenly distributed in the projection.

18. A vehicle comprising the secondary battery according to claim 4.

19. The secondary battery according to claim 5,
wherein the at least one selected from Hf, V, Nb, Zr, Ce, and Sm is unevenly distributed in the projection.

20. A vehicle comprising the secondary battery according to claim 5.
